(19) United States
(12) Patent Application Publication
(10) Pub. No.: US 2011/0195795 A1
(43) Pub. Date: Aug. 11, 2011

(54) DRIVING FORCE TRANSMISSION APPARATUS

(75) Inventors: Kiyohito Murata, Susono-shi (JP); Takuya Okada, Susono-shi (JP)

(73) Assignee: TOYOTA JIDOSHA KABUSHIKI KAISHA, Aichi-ken (JP)

(21) Appl. No.: 13/121,503

(22) PCT Filed: Sep. 29, 2009
(86) PCT No.: PCT/IB09/06980

§ 371 Date: Mar. 29, 2011

(30) Foreign Application Priority Data
Sep. 30, 2008 (JP) 2008-254996

(51) Int. Cl. F16F 15/129; F16D 3/06; F16H 45/02; F16H 41/24

(52) U.S. Cl. 464/67.1

(57) ABSTRACT

A driving force transmission apparatus includes a damper device that includes: a plurality of elastic bodies provided between a first member, to which driving force is transmitted from a driving source, and a second member transmitting the driving force to a fluid transmission device; an outer coupling portion integrally rotatably coupled to a radially outer portion of the first member; and an inner coupling portion integrally rotatably coupled to a radially inner portion of the second member. The damper device transmits driving force, transmitted to the first member, from the outer coupling portion to the inner coupling portion via the plurality of elastic bodies and then to the second member. One of the outer coupling portion and the inner coupling portion of the damper device is fixedly coupled via a highly rigid portion and the other one is axially movable along a rotation axis.

The disclosure of Japanese Patent Application No. 2008-254996 filed on Sep. 30, 2008, including the specification, drawings and abstract is incorporated herein by reference in its entirety.

### BACKGROUND OF THE INVENTION

1. Field of the Invention

The invention relates to a driving force transmission apparatus and, more particularly, to a driving force transmission apparatus equipped with a damper device.

2. Description of the Related Art

For example, a fluid transmission device described in Japanese Patent Application Publication No. 2007-16833 (JP-A-2007-16833) is an existing driving force transmission apparatus. The fluid transmission device includes a torus portion, a turbine hub, and a lock-up device. The torus portion has a pump impeller and a turbine runner. The turbine hub is engaged with an input shaft of a transmission and holds the turbine runner. The lock-up device serves as lock-up means that is engageably arranged and that mechanically transmits the rotation, transmitted from a driving source, to the turbine hub. Then, in the fluid transmission device described in JP-A-2007-16833, the torus portion and the lock-up device are arranged so as to overlap in the axial direction. By so doing, the axial size of the fluid transmission device is reduced to reduce the overall size of the fluid transmission device.

In addition, the fluid transmission device described in JP-A-2007-16833 includes compression coil spring dampers as elastic bodies. The compression coil spring dampers constitute a damper device as damper means and are located between a front cover and the lock-up device. The driving force of an engine, which serves as a driving source, is transmitted to the front cover. When the lock-up device is engaged, the driving force from the driving source is transmitted to the lock-up device via the compression coil spring dampers of the damper device. Thus, vibrations due to transmission of the driving force may be reduced by the damper device. Note that the damper device of the fluid transmission device described in JP-A-2007-16833 is fixed to the front cover at a radially outer side thereof, while being fixed to a clutch hub of the lock-up device at a radially inner side thereof. The damper device transmits the driving force, transmitted from the driving source to the front cover, to the clutch hub via the radially outer side compression coil spring dampers and the radially inner side compression coil spring dampers.

Incidentally, in the fluid transmission device described in JP-A-2007-16833, even when engine efficiency is improved, for example, by a supercharging-downsized engine, muffled sound increases in the fluid transmission device because of an increase in explosive power due to a reduction in the number of engine cylinders and/or supercharging, and the rotational speed at which the lock-up clutch may be engaged increases. Eventually, the supercharging-downsized engine may not lead to improvement in fuel economy. For this reason, in the fluid transmission device described in JP-A-2007-16833, a further reduction in vibrations is desired in order to further improve fuel economy, for example, by extending a rotational speed range, in which the lock-up clutch may be engaged, by suppressing vibrations, such as muffled sound.

### SUMMARY OF THE INVENTION

The invention provides a driving force transmission apparatus that is able to improve vibration reduction capability while suppressing an increase in size.

A first aspect of the invention provides a driving force transmission apparatus. The driving force transmission apparatus includes a damper device that includes: a plurality of elastic bodies provided between a first member, to which driving force is transmitted from a driving source, and a second member that transmits the driving force to a fluid transmission device; an outer coupling portion that is integrally rotatably coupled to a radially outer portion of the first member; and an inner coupling portion that is integrally rotatably coupled to a radially inner portion of the second member. The damper device transmits the driving force, transmitted to the first member, from the outer coupling portion to the inner coupling portion via the plurality of elastic bodies and then to the second member. One of the outer coupling portion and the inner coupling portion of the damper device is fixedly coupled via a highly rigid portion, and the other one of the outer coupling portion and the inner coupling portion is coupled axially movably along a rotation axis.

In addition, in the driving force transmission apparatus, the inner coupling portion of the damper device may be fixedly coupled via the highly rigid portion, and the outer coupling portion of the damper device may be coupled axially movably along the rotation axis.

In addition, in the driving force transmission apparatus, the plurality of elastic bodies may include a plurality of outer elastic bodies and a plurality of inner elastic bodies that are provided on a radially inner side of the plurality of outer elastic bodies and that are coupled to the outer elastic bodies via a transmitting member, wherein the plurality of outer elastic bodies may constitute an outer damper and the plurality of inner elastic bodies may constitute an inner damper, and the damper device may transmit the driving force, transmitted to the first member, from the outer coupling portion of the outer damper to the plurality of outer elastic bodies, may transmit the driving force, transmitted to the plurality of outer elastic bodies, to the plurality of inner elastic bodies via the transmitting member and may transmit the driving force, transmitted to the plurality of inner elastic bodies, to the inner coupling portion of the inner damper and then to the second member.

A second aspect of the invention provides a driving force transmission apparatus. The driving force transmission apparatus includes: a first member to which driving force is transmitted from a driving source; a damper device that includes an outer damper that has a plurality of outer elastic bodies and a radially outer side outer coupling portion coupled to a radially outer portion of the first member, an inner damper that has a plurality of inner elastic bodies provided on a radially inner side of the plurality of outer elastic bodies, and a transmitting member that couples the outer elastic bodies to the inner elastic bodies; a second member that has a radially inner portion coupled to an inner coupling portion provided at a radially inner side of the inner damper and that transmits the driving force to the fluid transmission device; a first coupling portion that couples the radially outer portion of the first member to the outer coupling portion of the outer damper so that the radially outer portion of the first member and the outer coupling portion of the outer damper are integrally rotatable and axially movable with respect to each other along a rotation axis; and a second coupling portion that fixedly couples the radially inner portion of the second member to the inner coupling portion of the inner damper via a highly rigid portion so that the radially inner portion of the second member and the inner coupling portion of the inner damper are integrally rotatable.

A third aspect of the invention provides a driving force transmission apparatus. The driving force transmission apparatus includes: a damper device that transmits driving force, transmitted to an outer coupling portion of an outer damper provided at a radially outer side, to a plurality of outer elastic bodies of the outer damper, that transmits the driving force, transmitted to the plurality of outer elastic bodies, to a plurality of inner elastic bodies of an inner damper provided on a radially inner side of the outer elastic bodies via a transmitting member and that transmits the driving force, transmitted to the plurality of inner elastic bodies, to an inner coupling portion of the inner damper; a first coupling portion that couples a radially outer portion of a first member, to which the driving force is transmitted from a driving source, to the outer coupling portion of the outer damper so that the radially outer portion of the first member and the outer coupling portion of the outer damper are able to transmit the driving force therebetween and are axially movable with respect to each other along a rotation axis; and a second coupling portion that fixedly couples a radially inner portion of a second member, which transmits the driving force to a fluid transmission device, to the inner coupling portion of the inner damper via a highly rigid portion so that the radially inner portion of the second member and the inner coupling portion of the inner damper are able to transmit the driving force therebetween.

In addition, in the driving force transmission apparatus, the transmitting member may have an application point adjacent portion that is formed in a radial direction, and, when the transmitting member transmits the driving force, each of the outer elastic bodies may contact one circumferential end of the application point adjacent portion and each of the inner elastic bodies may contact the other circumferential end of the application point adjacent portion.

In addition, in the driving force transmission apparatus, the damper device may include an outer center support member that supports the outer elastic bodies so as to be able to transmit driving force and that has the outer coupling portion at a radially outer end thereof, the transmitting member that supports the outer elastic bodies on an axially lateral side of the outer center support member so as to be able to transmit driving force and that supports the inner elastic bodies so as to be able to transmit driving force, and an inner lateral support member that supports the inner elastic bodies on an axially lateral side of the transmitting member so as to be able to transmit driving force and that has the inner coupling portion at a radially inner end thereof.

In addition, in the driving force transmission apparatus, the damper device may include the transmitting member that supports the outer elastic bodies and the inner elastic bodies so as to be able to transmit driving force, an outer lateral support member that supports the outer elastic bodies on an axially lateral side of the transmitting member so as to be able to transmit driving force and that has the outer coupling portion at a radially outer end thereof, and an inner lateral support member that supports the inner elastic bodies on an axially lateral side of the transmitting member so as to be able to transmit driving force and that has the inner coupling portion at a radially inner end thereof.

In addition, in the driving force transmission apparatus, the transmitting member may include an outer ring that couples at least two outer elastic bodies via an outer elastic body coupling portion so that the at least two outer elastic bodies are able to transmit driving force to each other, an inner ring that is provided on a radially inner side of the outer ring and that couples at least two inner elastic bodies via an inner elastic body coupling portion so that the at least two inner elastic bodies are able to transmit driving force to each other, a center ring that is radially provided between the outer ring and the inner ring so as to be rotatable with respect to the outer ring and the inner ring and that couples the outer elastic bodies to the inner elastic bodies via a driving force transmitting portion so that the outer elastic bodies and the inner elastic bodies are able to transmit driving force to each other.

In addition, in the driving force transmission apparatus, the center ring may have an outer lip portion, which receives radial force component applied from a corresponding one of the outer elastic bodies, at a radially outer end of the driving force transmitting portion, the outer ring may couple the outer elastic bodies so that an angle made at a radially inner side by intersection of center lines of the outer elastic bodies that are adjacent in a circumferential direction via the driving force transmitting portion is larger than an angle made at a radially inner side by intersection of center lines of the outer elastic bodies that are adjacent in the circumferential direction via the outer elastic body coupling portion, and the inner ring may have an inner lip portion, which receives radial force component applied from a corresponding one of the inner elastic bodies, at a radially outer end of the inner elastic body coupling portion, and may couple the inner elastic bodies so that an angle made at a radially inner side by intersection of center lines of the inner elastic bodies that are adjacent in the circumferential direction via the inner elastic body coupling portion is larger than an angle made at a radially inner side by intersection of center lines of the inner elastic bodies that are adjacent in the circumferential direction via the driving force transmitting portion.

In addition, in the driving force transmission apparatus, the first member may be provided with an outer damper positioning portion fixed to a driving source output shaft that outputs the driving force from the driving source and that radially positions the outer damper, and the second member may be provided with an inner damper positioning portion that is rotatably supported by the driving source output shaft via a bearing so as to be coaxial with the driving source output shaft and that radially positions the inner damper.

In addition, the fluid transmission device is able to transmit the driving force, transmitted to the second member, to an output shaft via hydraulic fluid and the driving force transmission apparatus may further include a lock-up device that includes; an engagement member that is provided on the fluid transmission device side of the second member so as to be axially movable with respect to the second member; a frictional engagement surface that allows a radially outer end of the engagement member to frictionally engage the second member; a hydraulic fluid channel that is axially formed between the engagement member and the second member in the axial direction so as to be communicable with an inside of the fluid transmission device at a side adjacent to the frictional engagement surface, wherein the lock-up device may be able to transmit driving force, transmitted to the second member, to the output shaft via the engagement member in such a manner that the engagement member approaches the second member and is frictionally engaged with the second member via the frictional engagement surface as the hydraulic fluid flows from an inner side of the fluid transmission device to the hydraulic fluid channel, and the hydraulic fluid channel may be formed so that, when the hydraulic fluid flows from the inner side of the fluid transmission device, flow of the hydraulic fluid downstream of the frictional engagement surface in the axial direction forms one-way flow that distances from the fluid transmission device side of the second member.

In addition, the hydraulic fluid channel may be formed so that, when the hydraulic fluid flows from the inner side of the fluid transmission device, a channel cross-sectional area downstream of the frictional engagement surface may gradually increase toward a downstream side in a stepped manner.

With the above driving force transmission apparatus, one of the outer coupling portion and the inner coupling portion of the damper device is fixedly coupled via a highly rigid portion and the other one of the outer coupling portion and the inner coupling portion is coupled axially movably along a rotation axis. Thus, it is possible to reduce deformation that deteriorates damper performance, and it is possible to improve vibration reduction capability while suppressing an increase in size.

In addition, the above driving force transmission apparatus includes the first coupling portion that couples the radially outer portion of the first member to the outer coupling portion of the outer damper so that the radially outer portion of the first member and the outer coupling portion of the outer damper are integrally rotatable and axially movable with respect to the rotation axis, and the second coupling portion that fixedly couples the radially inner portion of the second member to the inner coupling portion of the inner damper via the highly rigid portion so that the radially inner portion of the second member and the inner coupling portion of the inner damper are integrally rotatable. Thus, the outer damper and the inner damper are serially coupled with respect to a direction in which driving force is transmitted and then deformation that deteriorates damper performance may be reduced. Hence, it is possible to improve vibration reduction capability while suppressing an increase in size.

In addition, the above driving force transmission apparatus includes the first coupling portion that couples the radially outer portion of the first member, to which driving force is transmitted from the driving source, to the outer coupling portion of the outer damper so that the radially outer portion of the first member and the outer coupling portion of the outer damper are able to transmit driving force to each other and are axially movable with respect to each other along the rotation axis, and the second coupling portion that fixedly couples the radially inner portion of the second member, which transmits the driving force to the fluid transmission device, to the inner coupling portion of the inner damper via the highly rigid portion so that the radially inner portion of the second member and the inner coupling portion of the inner damper are able to transmit driving force to each other. Thus, the outer damper and the inner damper are serially coupled with respect to a direction in which driving force is transmitted and then deformation that deteriorates damper performance may be reduced. Hence, it is possible to improve vibration reduction capability while suppressing an increase in size.

In addition, with the above driving force transmission apparatus, the hydraulic fluid channel is formed so that, when hydraulic fluid flows from the inner side of the fluid transmission device, flow of the hydraulic fluid downstream of the frictional engagement surface in the axial direction forms one-way flow that distances from the fluid transmission device side of the second member. Thus, it is possible to stabilize flow of hydraulic fluid downstream of the frictional engagement surface in the hydraulic fluid channel. In addition, for example, slip control may be accurately executed, so it is possible to improve vibration reduction capability while suppressing an increase in size.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a cross-sectional view of a relevant portion of a torque converter according to a first embodiment of the invention;

FIG. 2 is a plan view of a fastening plate of the torque converter according to the first embodiment of the invention;

FIG. 3 is a plan view of a second coupling portion of the torque converter according to the first embodiment of the invention;

FIG. 4 is a cross-sectional view of a relevant portion of a torque converter according to a second embodiment of the invention;

FIG. 5 is a cross-sectional view of a relevant portion of a torque converter according to a third embodiment of the invention;

FIG. 6 is a cross-sectional view of a relevant portion of a torque converter according to a first modified example of the third embodiment;

FIG. 7 is a cross-sectional view of a relevant portion of a torque converter according to a second modified example of the third embodiment;

FIG. 8 is a cross-sectional view of a relevant portion of a torque converter according to a fourth embodiment of the invention; and

FIG. 9 is a partial plan view of a center support plate assembly of the torque converter according to the fourth embodiment of the invention.

### DETAILED DESCRIPTION OF EMBODIMENTS

Hereinafter, embodiments of a driving force transmission apparatus according to the invention will be described in detail with reference to the accompanying drawings. Note that the embodiments are not intended to limit the scope of the invention. In addition, components in the embodiments encompass the ones that are easily replaceable with the components by a person skilled in the art or the ones substantially equivalent to the components. In addition, in the following embodiments, an engine, such as a gasoline engine, a diesel engine and an LPG engine, is used as a driving source that generates driving force transmitted to the driving force transmission apparatus; however, the driving source is not limited to the engine. An electric motor, such as a motor, may be used as the driving source instead, or an electric motor, such as a motor, may be used in addition to the engine.

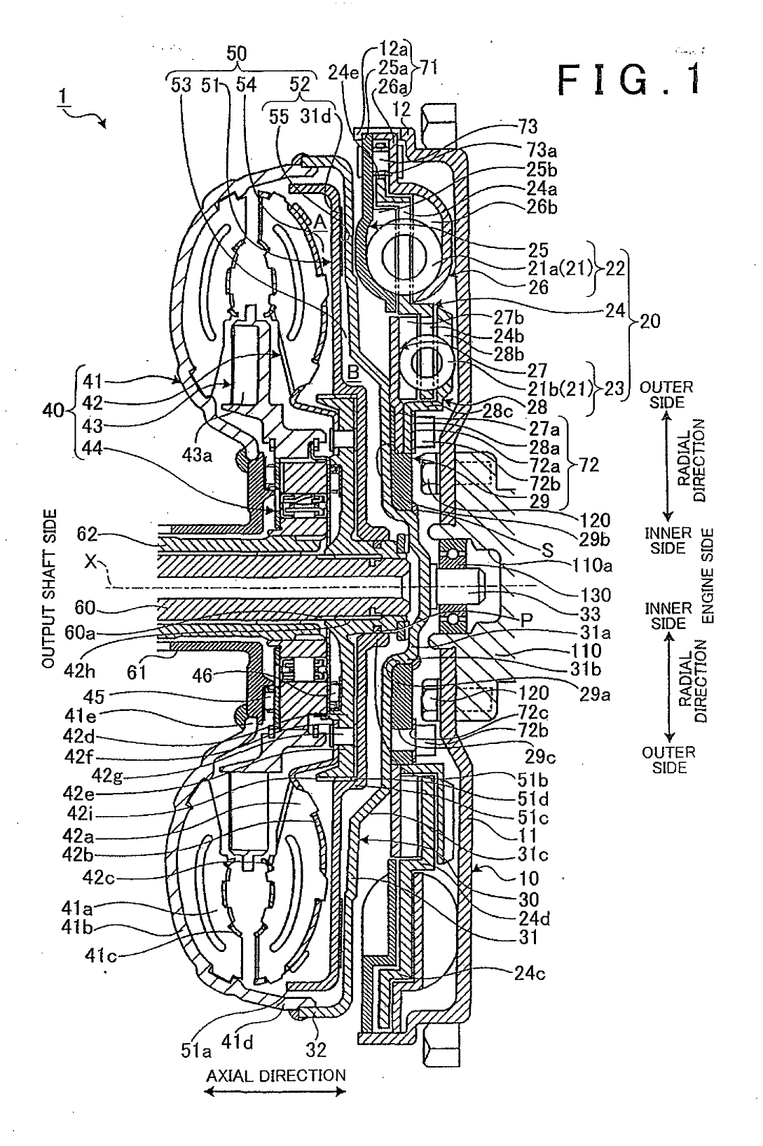

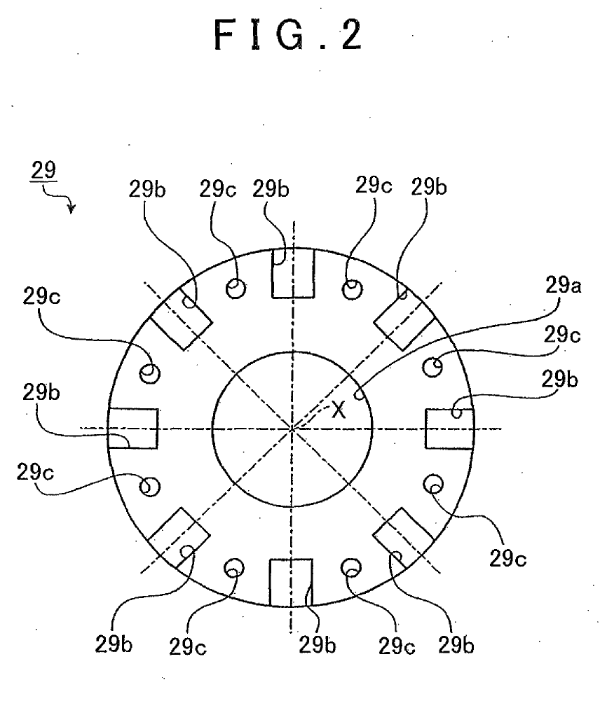

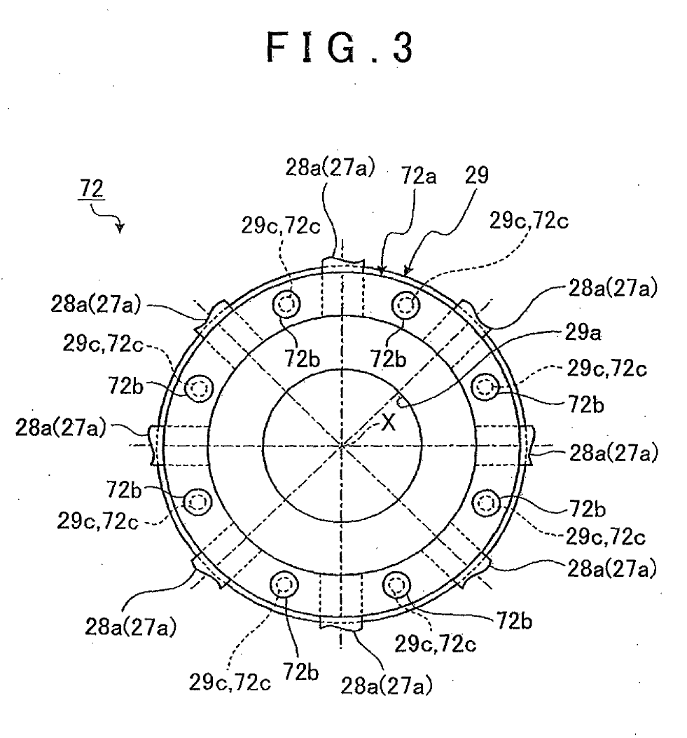

FIG. 1 is a cross-sectional view of a relevant portion of a torque converter according to a first embodiment of the invention. FIG. 2 is a plan view of a fastening plate of the torque converter according to the first embodiment of the invention. FIG. 3 is a plan view of a second coupling portion of the torque converter according to the first embodiment of the invention. Note that, in the following description, unless otherwise specified, a direction along a rotation axis X of an output shaft 60 is referred to as an axial direction, a direction perpendicular to the rotation axis X, that is, a direction perpendicular to the axial direction, is referred to as a radial direction, and a direction around the rotation axis X is referred to as a circumferential direction. In addition, in the radial direction, a side adjacent to the rotation axis X is referred to as a radially inner side, and the opposite side is referred to as a radially outer side. In addition, in the axial direction, a side at which the driving source is provided (side at which driving force is input from the driving source) is referred to as an engine side, and the opposite side, that is, a side at which a transmission is provided (side from which driving force is output to the transmission) is referred to as an output shaft side.

As shown in FIG. 1, a torque converter 1, which serves as the driving force transmission apparatus according to the first embodiment, includes a drive plate 10, a damper mechanism 20, a front cover 30, a fluid transmission mechanism 40, a lock-up clutch mechanism 50 and an output shaft 60. The drive plate 10 serves as a first member. The damper mechanism 20 serves as a damper device. The front cover 30 serves as a second member. The fluid transmission mechanism 40 serves as a fluid transmission device. The lock-up clutch mechanism 50 serves as a lock-up device. The torque converter 1 transmits driving force, transmitted from the driving source to the drive plate 10, to the front cover 30 via the damper mechanism 20, and then transmits the driving force from the front cover 30 to the fluid transmission mechanism 40 or the lock-up clutch mechanism 50.

That is, the torque converter 1 according to the present embodiment is a so-called pre-damper-type torque converter in which the damper mechanism 20 is axially provided between the drive plate 10, to which driving force is transmitted from the driving source, and the front cover 30 that transmits driving force to the fluid transmission mechanism 40. That is, the damper mechanism 20 couples the drive plate 10 to the front cover 30 via a plurality of damper springs 21, which serve as a plurality of elastic bodies.

In the torque converter 1, the damper mechanism 20 is arranged downstream of the drive plate 10 and upstream of the front cover 30 with respect to a direction in which driving force is transmitted from the driving source. Thus, the torque converter 1 is able to optimize the balance between the inertial mass of a driving side (engine side) upstream of the damper springs 21 of the damper mechanism 20 and the inertial mass of a driven side (output shaft side (transmission side)) downstream of the damper springs 21. That is, in the existing torque converter, the inertial mass of the driving side tends to be larger than the inertial mass of the driven side. On the other hand, the torque converter 1 is able to optimize the balance between the inertial mass of the driving side and the inertial mass of the driven side, so the resonance point between the driving side and the driven side may be decreased to effectively suppress resonance. Thus, it is possible to improve damper performance, such as prevention of muffled sound of the damper mechanism 20. That is, because the vibration reduction capability may be improved, it is possible to suppress occurrence of muffled sound, or the like. In addition, it is possible to extend the rotational speed range in which the lock-up clutch mechanism 50 may be engaged, so the lock-up clutch mechanism 50 may be engaged in a relatively low rotational speed range. Thus, it is possible to improve fuel economy. In addition, the torque converter 1 includes the damper mechanism 20 that is provided at a side opposite to the fluid transmission mechanism 40, filled with hydraulic fluid, with respect to the front cover 30 in the axial direction. Thus, a relatively wide region may be ensured to arrange the damper springs 21. As a result, it is possible to provide a relatively large damper spring 21 or a relatively large number of damper springs 21. In other words, the design of the damper mechanism 20 becomes easy.

Then, the torque converter 1 according to the present embodiment further improves vibration reduction capability while suppressing an increase in size in such a manner that, in the pre-damper-type torque converter, any one of a coupling portion of the damper mechanism 20 to the drive plate 10 or a coupling portion of the damper mechanism 20 to the front cover 30 is fixedly coupled via a highly rigid portion and the other one of the coupling portions is coupled axially movably. That is, the torque converter 1 reduces size and achieves high performance in the pre-damper-type torque converter. Hereinafter, the components of the torque converter 1 will be specifically described.

As shown in FIG. 1, in the torque converter 1, the drive plate 10, the damper mechanism 20, the front cover 30, the lock-up clutch mechanism 50 and the fluid transmission mechanism 40 are axially arranged from the engine side toward the output shaft side in the stated order.

The drive plate 10 is the first member. The driving force of the engine (not shown) is transmitted to the drive plate 10. The engine serves as the driving source. The drive plate 10 includes a drive plate body 11 and a drive plate flange 12.

The drive plate body 11 is formed in an annular plate-like shape that is coaxial with the rotation axis X, which is the central axis of the output shaft 60. The drive plate body 11 is fastened to a crankshaft 110 by coupling members 120 (for example, bolts) at a radially inner end thereof. The crankshaft 110 is a driving source output shaft of the engine (not shown). The crankshaft 110 is rotatable relative to the output shaft 60 about the rotation axis X of the output shaft 60. That is, the drive plate 10 is fixed to the crankshaft 110, and is integrally rotatable with the crankshaft 10 about the rotation axis X. Thus, the driving force of the engine is transmitted from the crankshaft 110 to the drive plate body 11 of the drive plate 10 via the coupling member 120.

The drive plate flange 12 is formed to extend from the radially outer end of the drive plate body 11 toward the output shaft side. The drive plate flange 12 is formed in a cylindrical shape that is coaxial with the rotation axis X.

In addition, the drive plate 10 has a plurality of coupling cutouts 12a. The coupling cutouts 12a constitute part of first coupling portion 71. Each of the coupling cutouts 12a is formed at a portion of the drive plate 10 that radially faces a corresponding one of pairs of outer coupling protrusions 25a and 26a, that is, each of the coupling cutouts 12a is formed in the drive plate flange 12. The outer coupling protrusions 25a and 26a serve as outer coupling portions, and are provided at the radially outer end of the damper mechanism 20, which will be described later.

Each coupling cutout 12a is formed so that an output shaft-side end of the drive plate flange 12 is axially cut out toward the engine side. Each coupling cutout 12a is formed to radially extend through the drive plate flange 12 from the outer peripheral surface of the drive plate flange 12 to the inner peripheral surface thereof. The coupling cutouts 12a are formed at equiangular positions in the circumferential direction of the drive plate flange 12.

The damper mechanism 20 is a damper device, and couples the drive plate 10 to the front cover 30 via the plurality of damper springs 21. More specifically, the damper mechanism 20 couples the drive plate 10 to the front cover 30 via the plurality of damper springs 21 so that the drive plate 10 and the front cover 30 are rotatable relative to each other.

The damper mechanism 20 includes the plurality of damper springs 21, the outer coupling protrusions 25a and 26a, and inner coupling protrusions 27a and 28a. The plurality of damper springs 21 serve as the plurality of elastic bodies. The outer coupling protrusions 25a and 26a serve as the outer coupling portions. The inner coupling protrusions 27a and 28a serve as inner coupling portions. The damper mechanism 20 transmits the driving force, transmitted to the drive plate 10, from the outer coupling protrusions 25a and 26a to the inner coupling protrusions 27a and 28a via the plurality of damper springs 21 and then to the front cover 30.

More specifically, the damper mechanism 20 includes an outer damper 22, an inner damper 23, and a center support plate 24. The center support plate 24 serves as a transmitting member. The outer damper 22 is arranged at a radially outer side and is provided with the outer coupling protrusions 25a and 26a. On the other hand, the inner damper 23 is arranged at a radially inner side and is provided with the inner coupling protrusions 27a and 28a. The outer damper 22 is coupled to the inner damper 23 by the center support plate 24. In addition, the outer coupling protrusions 25a and 26a are provided at the radially outer end of the outer damper 22, while the inner coupling protrusions 27a and 28a are provided at the radially inner end of the inner damper 23. That is, the damper mechanism 20 includes the outer coupling protrusions 25a and 26a at the radially outer end thereof and includes the inner coupling protrusions 27a and 28a at the radially inner end thereof.

Then, in the damper mechanism 20, the outer coupling protrusions 25a and 26a are coupled to the radially outer portion of the drive plate 10 at the first coupling portion 71 so as to be integrally rotatable and axially movable, and the inner coupling protrusions 27a and 28a are fixedly coupled to the radially inner portion of the front cover 30 via a fastening plate 29, which serves as a highly rigid portion, by a second coupling portion 72 so as to be integrally rotatable.

The plurality of damper springs 21 are, for example, a plurality of coil springs, and are axially provided between the drive plate 10 and the front cover 30. The plurality of damper springs 21 include outer damper springs 21a and inner damper springs 21b. The outer damper springs 21a serve as a plurality of outer elastic bodies and constitute part of the outer damper 22. The inner damper springs 21b serve as a plurality of inner elastic bodies and constitute part of the inner damper 23. The outer damper springs 21a are arranged on a radially outer side. The inner damper springs 21b are arranged on a radially inner side of the outer damper springs 21a.

The outer damper springs 21a and the inner damper springs 21b both are supported by the center support plate 24, that is, coupled via the center support plate 24. Here, the damper mechanism 20 transmits the driving force, transmitted to the drive plate 10, from the outer coupling protrusions 25a and 26a of the outer damper 22 to the plurality of outer damper springs 21a. Then, the damper mechanism 20 transmits the driving force, transmitted to the plurality of outer damper springs 21a, to the plurality of inner damper springs 21b via the center support plate 24. The damper mechanism 20 further transmits the driving force, transmitted to the plurality of inner damper springs 21b, to the inner coupling protrusions 27a and 28a of the inner damper 23. Thus, the damper mechanism 20 transmits the driving force to the front cover 30. That is, the damper mechanism 20 is formed so that the outer damper springs 21a of the outer damper 22 and the inner damper springs 21b of the inner damper 23 are serially arranged with respect to a transmission path of the driving force.

The outer damper 22 includes an outer rear support plate 25, an outer front support plate 26, and the above described plurality of outer damper springs 21a. The outer rear support plate 25 and the outer front support plate 26 serve as an outer lateral support member.

The inner damper 23 includes an inner rear support plate 27, an inner front support plate 28 and the above described inner damper springs 21b. The inner rear support plate 27 and the inner front support plate 28 serve as an inner lateral support member.

Here, as described above, the center support plate 24 supports the plurality of outer damper springs 21a and the plurality of inner damper springs 21b so as to be able to transmit driving force. That is, the center support plate 24 according to the present embodiment functions as a member that supports the outer damper springs 21a of the outer damper 22 and also functions as a member that supports the inner damper springs 21b of the inner damper 23. The center support plate 24 is formed in an annular plate-like shape that is coaxial with the rotation axis X. The center support plate 24 has outer center support portions 24a and inner center support portions 24b.

The center support plate 24 has a step 24c and a step 24d that are formed to extend toward the drive plate 10 side, that is, the engine side, in a stepped manner from the radially outer side of the center support plate 24 toward the radially inner side thereof. The step 24c is formed near the radially outer end of the center support plate 24 and is formed in an annular shape that is coaxial with the rotation axis X. The step 24d is formed near a radially intermediate portion between the step 24c and the radially inner end of the center support plate 24 and is formed in an annular shape that is coaxial with the rotation axis X. The center support plate 24 has the outer center support portions 24a that are radially provided between the step 24c and the step 24d. The center support plate 24 also has the inner center support portions 24b that are radially provided between the step 24d and the radially inner end of the center support plate 24. That is, the outer center support portions 24a are provided at a radially outer side of the center support plate 24, while the inner center support portions 24b are provided at a radially inner side of the center support plate 24.

The outer damper springs 21a are inserted in the outer center support portions 24a. The outer center support portions 24a support the outer damper springs 21a. The inner damper springs 21b are inserted in the inner center support portions 24b. The inner center support portions 21b support the inner damper springs 21b. The outer center support portions 24a are formed of slits that are formed in a circular arc shape between the step 24c and step 24d of the center support plate 24. The outer damper springs 21a are inserted in the outer center support portions 24a. The outer center support portions 24a support the outer damper springs 21a. The inner center support portions 24b are formed of slits that are formed in a circular arc shape between the step 24d and radially inner end of the center support plate 24. The inner damper springs 21b are inserted in the inner center support portions 24b. The inner center support portions 24b support the inner damper springs 21b. The plurality of outer center support portions 24a are formed at equiangular positions in the circumferential direction with respect to the center support plate 24. The plurality of inner center support portions 24b are formed at equiangular positions in the circumferential direction with respect to the center support plate 24.

Each outer center support portion 24a has a circumferential length so that a corresponding one of the outer damper springs 21a may be supported in an urged state. Thus, as each outer damper spring 21a is supported by a corresponding one of the outer center support portions 24a, both circumferential ends of each outer center support portion 24a are respectively in contact with both ends of a corresponding one of the outer damper springs 21a. That is, each outer damper spring 21a is in contact with both circumferential ends of a corresponding one of the outer center support portions 24a, and is supported between both circumferential ends in an urged state. Thus, the center support plate 24 is able to transmit driving force to and from the outer damper springs 21a at the contact portions of the circumferential ends at which the outer center support portions 24a are in contact with the outer damper springs 21a. Similarly, each inner center support portion 24b has a circumferential length so that a corresponding one of the inner damper springs 21b may be supported in an urged state. Thus, as each inner damper spring 21b is supported by a corresponding one of the inner center support portions 24b, both circumferential ends of each inner center support portion 24b are respectively in contact with both ends of a corresponding one of the inner damper springs 21b. That is, each inner damper spring 21b is in contact with both circumferential ends of a corresponding one of the inner center support portions 24b, and is supported between both circumferential ends in an urged state. The center support plate 24 is able to transmit driving force to and from the inner damper springs 21b at the contact portions of the circumferential ends at which the inner center support portions 24b are in contact with the inner damper springs 21b.

Then, the outer rear support plate 25 and outer front support plate 26 of the outer damper 22 support part of the plurality of outer damper springs 21a at axially lateral sides, here, both axially lateral sides, of the center support plate 24 so as to be able to transmit driving force.

The outer rear support plate 25 and the outer front support plate 26 are formed in an annular plate-like shape that is coaxial with the rotation axis X, and is axially arranged between the drive plate 10 and the front cover 30. The outer rear support plate 25 and the outer front support plate 26 are arranged at a radially outer side portion in a space between the drive plate 10 and the front cover 30. Here, the outer rear support plate 25 is arranged adjacent to the front cover 30 (output shaft side), and the outer front support plate 26 is arranged adjacent to the drive plate 10 (engine side).

The plurality of outer damper springs 21a and the center support plate 24 are arranged in the axial space between the outer rear support plate 25 and the outer front support plate 26. The outer rear support plate 25 and the outer front support plate 26 hold the center support plate 24 and the plurality of outer damper springs 21a in between to support them. The outer rear support plate 25 and the outer front support plate 26 hold both axially lateral sides of the center support plate 24 to rotatably support the center support plate 24.

That is, in the outer damper 22, the outer front support plate 26, the center support plate 24, the plurality of outer damper springs 21a and the outer rear support plate 25 are axially arranged from the engine side toward the output shaft side in the stated order.

The outer rear support plate 25 has the above described outer coupling protrusions 25a and outer rear support portions 25b. The outer front support plate 26 has the above described outer coupling protrusions 26a and outer front support portions 26b.

The outer rear support portions 25b and the outer front support portions 26b accommodate and support part of the outer damper springs 21a of which the center portions in the axial direction are supported by the center support plate 24.

The outer rear support portions 25b are provided on an engine-side wall surface (wall surface adjacent to the outer front support plate 26) of the outer rear support plate 25, that is, on a wall surface facing the center support plate 24. The outer rear support portions 25b are formed so that the wall surface of the outer rear support plate 25 facing the center support plate 24 is recessed toward the output shaft side (side opposite to the center support plate 24 side). The outer rear support portions 25b are formed in a circular arc shape in the circumferential direction of the outer rear support plate 25. The plurality of outer rear support portions 25b are formed at equiangular positions in the circumferential direction of the outer rear support plate 25.

The outer front support portions 26b are provided on an output shaft-side wall surface (wall surface adjacent to the outer rear support plate 25) of the outer front support plate 26, that is, a wall surface facing the center support plate 24. The outer front support portions 26b are formed so that the wall surface of the outer front support plate 26 facing the center support plate 24 is recessed toward the engine side (side opposite to the center support plate 24 side). The outer front support portions 26b are formed in a circular arc shape in the circumferential direction of the outer front support plate 26. The plurality of outer front support portions 26b are formed at equiangular positions in the circumferential direction of the outer front support plate 26.

Then, each outer rear support portion 25b is formed at a position that axially faces a corresponding one of the outer center support portions 24a of the center support plate 24. Similarly, each outer front support portion 26b is formed at a position that axially faces a corresponding one of the outer center support portions 24a of the center support plate 24.

Thus, in the outer damper 22, each outer center support portion 24a of the center support plate 24 supports the center portion (center portion in the axial direction) of a corresponding one of the outer damper springs 21a, and each outer rear support portion 25b of the outer rear support plate 25 accommodates and supports part of a corresponding one of the outer damper springs 21a supported by the outer center support portion 24a, which is closer to the output shaft than the outer center support portion 24a, while each outer front support portion 26b of the outer front support plate 26 accommodates and supports part of a corresponding one of the outer damper springs 21a, which is closer to the engine than the outer center support portion 24a.

Then, both circumferential ends of each outer rear support portion 25b and both circumferential ends of each outer front support portion 26b face both ends of a corresponding one of the outer damper springs 21a in the circumferential direction and are contactable with both ends of the outer damper springs 21a in a state where each outer damper spring 21a is supported by a corresponding one of the outer center support portions 24a. As a result, the outer rear support plate 25 and the outer front support plate 26 are able to transmit driving force to and from the outer damper springs 21a at the contact portions of the circumferential ends at which the outer rear support portions 25b and the outer front support portions 26b are in contact with the outer damper springs 21a.

That is, each outer damper spring 21a is supported by the outer center support portion 24a of the center support plate 24, the outer rear support portion 25b of the outer rear support plate 25 and the outer front support portion 26b of the outer front support plate 26. Then, driving force is transmittable between the outer rear support plate 25 and the center support plate 24 and between the outer front support plate 26 and the center support plate 24.

Here, in the outer damper 22, the outer rear support plate 25 and the outer front support plate 26 are integrated by coupling devices, such as rivets 73. Sleeves 73a are provided between the outer rear support plate 25 and the outer front support plate 26. The outer rear support plate 25 and the outer front support plate 26 are integrated by the rivets 73. Each sleeve 73a has a cylindrical shape. Each rivet 73 is inserted inside a corresponding one of the sleeves 73a. The sleeves 73a function as a spacer in the axial direction between the outer rear support plate 25 and the outer front support plate 26, that is, fix the relative positional relationship in the axial direction between the outer rear support plate 25 and the outer front support plate 26. By so doing, it is possible to reliably ensure a space between the outer rear support plate 25 and the outer front support plate 26 in order to provide the center support plate 24 and the plurality of outer damper springs 21a. As a result, when the outer rear support plate 25 and the outer front support plate 26 rotate relative to the center support plate 24 via the plurality of outer damper springs 21a, the sleeves 73a are interposed between the outer rear support plate 25 and the outer front support plate 26 to ensure appropriate clearance between the outer rear support plate 25 and the center support plate 24 and between the outer front support plate 26 and the center support plate 24. Thus, the relative rotation is smoothly performed.

Note that the rivets 73 and the sleeves 73a extend through the center support plate 24. However, the center support plate 24 has slide portions 24e provided at portions corresponding to the rivets 73 and the sleeves 73a. The slide portions 24e are provided for the center support plate 24 that is axially provided between the outer rear support plate 25 and the outer front support plate 26. The slide portions 24e are formed to extend through the center support plate 24 as circular arc slits at portions corresponding to the rivets 73 and the sleeves 73a in the center support plate 24. Each slide portion 24e is provided in a circular arc shape at a position at which the rivet 73 and the sleeve 73a are axially insertable inside the slide portion 24e. That is, the slide portions 24e allow movement of the rivets 73 and sleeves 73a in accordance with relative rotation between the outer rear support plate 25 and outer front support plate 26 and the center support plate 24 until the outer rear support plate 25 and the outer front support plate 26 make a predetermined torsional angle with the center support plate 24. That is, the slide portions 24e allow the rivets 73 and the sleeves 73a to slide in the circumferential direction with respect to the center support plate 24. In addition, the slide portions 24e are able to prevent impairment of relative rotation between the outer rear support plate 25 and outer front support plate 26 and the center support plate 24. Note that the torsional angle between the outer rear support plate 25 and outer front support plate 26 and the center support plate 24 is a relative rotation angle between the outer rear support plate 25 and outer front support plate 26 and the center support plate 24, and the torsional angle becomes zero degree when no driving force, or the like, is transmitted to the outer rear support plate 25, the outer front support plate 26 or the center support plate 24.

Then, the outer rear support plate 25 has the outer coupling protrusions 25a at the radially outer end (that is, end adjacent to the outer peripheral surface), while the outer front support plate 26 has the outer coupling protrusions 26a at the radially outer end (that is, end adjacent to the outer peripheral surface).

The outer coupling protrusions 25a and 26a are coupled to the radially outer portion of the drive plate 10 so as to be integrally rotatable and axially movable. The outer coupling protrusions 25a and 26a constitute the first coupling portion 71 together with the above described coupling cutouts 12a of the drive plate 10. The plurality of outer coupling protrusions 25a are formed at equiangular positions in the circumferential direction with respect to the outer rear support plate 25, and the plurality of outer coupling protrusions 26a are formed at equiangular positions in the circumferential direction with respect to the outer front support plate 26.

The outer coupling protrusions 25a and 26a are respectively formed to protrude from the radially outer end of the outer rear support plate 25 and the outer end of the outer front support plate 26 toward the radially outer side so as to radially face the coupling cutouts 12a of the drive plate 10 in a state where the outer rear support plate 25 and the outer front support plate 26 are inserted in the drive plate 10. The amount of protrusion of each of the outer coupling protrusions 25a and 26a is set so that the outer coupling protrusions 25a and 26a are inserted in the coupling cutouts 12a in a state where the outer rear support plate 25 and the outer front support plate 26 are inserted inside the drive plate 10.

The outer coupling protrusions 25a and 26a that constitute the first coupling portion 71 are inserted in and engaged with the coupling cutouts 12a in a state where the outer rear support plate 25 and the outer front support plate 26 are inserted inside the drive plate 10. Thus, the outer rear support plate 25 and the outer front support plate 26 are restricted from rotating relative to the drive plate 10 and are axially movable relative to the drive plate 10. In other words, the first coupling portion 71 is a portion at which the coupling cutouts 12a and the outer coupling protrusions 25a and 26a of the outer damper 22 are coupled to each other so as to be integrally rotatable and axially movable. The coupling cutouts 12a are provided for the drive plate flange 12 that is the radially outer portion of the drive plate 10. That is, the outer rear support plate 25 and the outer front support plate 26 are coupled to the drive plate 10 at the first coupling portion 71, formed of the outer coupling protrusions 25a and 26a and the coupling cutouts 12a, so as to be integrally rotatable with the drive plate 10 and are axially movable with respect to the drive plate 10. In addition, the outer rear support plate 25 and the outer front support plate 26 are coupled to the drive plate 10 so as to be able to transmit driving force. Thus, the driving force, transmitted from the engine to the drive plate 10, is transmitted to the outer coupling protrusions 25a and 26a of the outer damper 22 of the damper mechanism 20 at the first coupling portion 71. Note that the distal ends of the outer coupling protrusions 26a are folded back toward the outer coupling protrusions 25a and are in contact with the outer coupling protrusions 25a.

On the other hand, the inner rear support plate 27 and inner front support plate 28 of the inner damper 23 support part of the plurality of inner damper springs 21b at axially lateral sides, here, both lateral sides, of the center support plate 24 so as to be able to transmit driving force.

The inner rear support plate 27 and the inner front support plate 28 are formed in an annular plate-like shape that is coaxial with the rotation axis X, and is axially arranged between the drive plate 10 and the front cover 30. The inner rear support plate 27 and the inner front support plate 28 are arranged at a radially inner side portion in a space between the drive plate 10 and the front cover 30. Here, the inner rear support plate 27 is arranged adjacent to the front cover 30 (output shaft side), and the inner front support plate 28 is arranged adjacent to the drive plate 10 (engine side). That is, the inner rear support plate 27 is located on the radially inner side of the outer rear support plate 25 and radially faces the outer rear support plate 25. The inner front support plate 28 is located on the radially inner side of the outer front support plate 26 and radially faces the outer front support plate 26.

The center support plate 24 together with the plurality of inner damper springs 21b are arranged in an axial space between the inner rear support plate 27 and the inner front support plate 28. The inner rear support plate 27 and the inner front support plate 28 hold the center support plate 24 and the plurality of inner damper springs 21b in between to support them. The inner rear support plate 27 and the inner front support plate 28 hold both axially lateral sides of the center support plate 24 in between to support the center support plate 24 so that the center support plate 24 is rotatable relative to the inner rear support plate 27 and the inner front support plate 28.

That is, in the inner damper 23, the inner front support plate 28, the center support plate 24, the plurality of inner damper springs 21b and the inner rear support plate 27 are axially arranged from the engine side toward the output shaft side in the stated order.

Then, the inner rear support plate 27 has the above described inner coupling protrusions 27a and inner rear support portions 27b. The inner front support plate 28 has the above described inner coupling protrusions 28a and inner front support portions 28b.

The inner rear support portions 27b and the inner front support portions 28b accommodate and hold part of the inner damper springs 21b of which the center portions in the axial direction are supported by the center support plate 24.

The inner rear support portions 27b are provided on an engine-side wall surface (wall surface adjacent to the inner front support plate 28) of the inner rear support plate 27, that is, on a wall surface facing the center support plate 24. The inner rear support portions 27b are formed so that the wall surface of the inner rear support plate 27 facing the center support plate 24 is recessed toward the output shaft side (side opposite to the center support plate 24 side). The inner rear support portions 27b are formed in a circular arc shape in the circumferential direction of the inner rear support plate 27. The plurality of inner rear support portions 27b are formed at equiangular positions in the circumferential direction of the inner rear support plate 27.

The inner front support portions 28b are provided on an output shaft-side wall surface (wall surface adjacent to the inner rear support plate 27) of the inner front support plate 28, that is, a wall surface facing the center support plate 24. The inner front support portions 28b are formed so that the wall surface of the inner front support plate 28 facing the center support plate 24 is recessed toward the engine side (side opposite to the center support plate 24 side). The inner front support portions 28b are formed in a circular arc shape in the circumferential direction of the inner front support plate 28. The plurality of inner front support portions 28b are formed at equiangular positions in the circumferential direction of the inner front support plate 28.

Then, each inner rear support portion 27b is formed at a position that axially faces a corresponding one of the inner center support portions 24b of the center support plate 24. Similarly, each inner front support portion 28b is formed at a position that axially faces a corresponding one of the inner center support portions 24b of the center support plate 24.

Thus, in the inner damper 23, each inner center support portion 24b of the center support plate 24 supports a center portion (center portion in the axial direction) of a corresponding one of the inner damper springs 21b, and each inner rear support portion 27b of the inner rear support plate 27 accommodates and supports part of a corresponding one of the inner damper springs 21b supported by the inner center support portion 24b, which is closer to the output shaft than the inner center support portion 24b, while each inner front support portion 28b of the inner front support plate 28 accommodates and supports part of a corresponding one of the inner damper springs 21b, which is closer to the engine than the inner center support portion 24b.

Then, both circumferential ends of each inner rear support portion 27b and both circumferential ends of each inner front support portion 28b face both ends of a corresponding one of the inner damper springs 21b in the circumferential direction and are contactable with both ends of the inner damper spring 21b in a state where each inner damper spring 21b is supported by a corresponding one of the inner center support portions 24b. As a result, the inner rear support plate 27 and the inner front support plate 28 are able to transmit driving force to and from the inner damper springs 21b at the contact portions of the circumferential ends at which the inner rear support portions 27b and the inner front support portions 28b are in contact with the inner damper springs 21b.

That is, each inner damper spring 21b is supported by the inner center support portion 24b of the center support plate 24, the inner rear support portion 27b of the inner rear support plate 27 and the inner front support portion 28b of the inner front support plate 28. Then, driving force is transmittable between the center support plate 24 and the inner rear support plate 27 and between the center support plate 24 and the inner front support plate 28.

Here, the inner front support plate 28 of the inner damper 23 has a step 28c so that the radially inner end of the inner front support plate 28 extends toward the front cover 30 side, that is, toward the output shaft side. The step 28c is formed in a cylindrical shape that is coaxial with the rotation axis X. The inner front support plate 28 has the above described inner front support portions 28b that are radially provided between the step 28c and the radially outer end of the inner front support plate 28. Then, the radially inner end of the inner front support plate 28 is formed so as to extend toward the output shaft side via the step 28c, and the radially inner end axially faces the radially inner end of the inner rear support plate 27 and is in contact with the radially inner end.

Note that, as in the case of the sleeves 73a of the outer damper 22, the step 28c of the inner front support plate 28 functions as a spacer in the axial direction between the inner rear support plate 27 and the inner front support plate 28. That is, when the center support plate 24 rotates relative to the inner rear support plate 27 and the inner front support plate 28 via the plurality of inner damper springs 21b, the step 28c is interposed between portions at which the inner rear support portions 27b of the inner rear support plate 27 are provided and portions at which the inner front support portions 28b of the inner front support plate 28 are provided to ensure appropriate clearance between the center support plate 24 and the inner rear support plate 27 and between the center support plate 24 and the inner front support plate 28. Thus, the relative rotation is smoothly performed.

Then, the inner rear support plate 27 has the inner coupling protrusions 27a at the radially inner end (that is, end adjacent to the inner peripheral surface), while the inner front support plate 28 has the inner coupling protrusions 28a at the radially inner end (that is, end adjacent to the inner peripheral surface). The inner coupling protrusions 27a and the inner coupling protrusions 28a axially face each other and are in contact with each other.

The inner coupling protrusions 27a and 28a are integrally rotatably fixed to the radially inner portion of the front cover 30 via the fastening plate 29, that is, the inner coupling protrusions 27a and 28a are coupled to the radially inner portion of the front cover 30 so that the inner coupling protrusions 27a and 28a are axially immovable with respect to the front cover 30. The inner coupling protrusions 27a and 28a constitute the second coupling portion 72 together with the fastening plate 29.

The inner coupling protrusions 27a are formed so that the radially inner end of the inner rear support plate 27 protrudes toward the radially inner side. The inner coupling protrusions 28a are formed so that the radially inner end of the inner front support plate 28 protrudes toward the radially inner side. The plurality of (eight in this embodiment) inner coupling protrusions 27a are formed at equiangular positions in the circumferential direction with respect to the inner rear support plate 27. The plurality of (eight in this embodiment) inner coupling protrusions 28a are formed at equiangular positions in the circumferential direction with respect to the inner front support plate 28.

The fastening plate 29 is the highly rigid portion. The fastening plate 29 enhances the rigidity of the second coupling portion 72. As shown in FIG. 1 and FIG. 2, the fastening plate 29 is formed in an annular plate-like shape that is coaxial with the rotation axis X. The fastening plate 29 is arranged so that an extended portion 31a provided at a radially center portion of the front cover 30 is inserted in the radially inner end 29a (that is, the inner peripheral surface side) of the fastening plate 29. The extended portion 31a will be described later. In addition, the fastening plate 29 is arranged so as to be inserted in the radially inner sides of the inner rear support plate 27 and inner front support plate 28. That is, in the damper mechanism 20, the outer damper 22, the inner damper 23, the fastening plate 29 and the extended portion 31a of the front cover 30 are radially arranged from the radially outer side toward the radially inner side in the stated order.

One surface of the fastening plate 29 in the axial direction is in contact with the front cover 30, and is fixed at the radially inner end 29a to the extended portion 31a of the front cover 30 by a fixing device or method, such as welding. Thus, the fastening plate 29 is fixedly coupled to the front cover 30 so that the fastening plate 29 and the front cover 30 are integrally rotatable and axially immovable with respect to each other. Then, the fastening plate 29 has coupling recesses 29b and bolt holes 29c.

The coupling recesses 29b are formed at the radially outer end (that is, outer peripheral surface) at which the fastening plate 29 radially faces the inner coupling protrusions 27a of the inner rear support plate 27 and the inner coupling protrusions 28a of the inner front support plate 28 in a state where the fastening plate 29 is inserted in the radially inner sides of the inner rear support plate 27 and inner front support plate 28. The coupling recesses 29b are formed so that the other surface of the fastening plate 29 in the axial direction (that is, surface adjacent to the drive plate 10 and is opposite to the surface that contacts the front cover 30) is recessed toward the front cover 30. That is, the coupling recesses 29b have a shape such that the radially cross-sectional shape is recessed from the outer peripheral surface of the fastening plate 29 toward the radially inner side and is recessed from the surface adjacent to the drive plate 10 toward the surface adjacent to the front cover 30. The plurality of (eight in this embodiment) coupling recesses 29b are formed at equiangular positions in the circumferential direction with respect to the fastening plate 29.

Then, in a state where the fastening plate 29 is inserted in the radially inner sides of the inner rear support plate 27 and inner front support plate 28, the above described inner coupling protrusions 27a and 28a are formed to protrude from the radially inner ends of the inner rear support plate 27 and inner front support plate 28 toward the radially inner side so as to be inserted in the coupling recesses 29b of the fastening plate 29.

The bolt holes 29c are formed so as to extend through the fastening plate 29 from the surface adjacent to the drive plate 10 to the surface adjacent to the front cover 30. Each bolt hole 29c is formed in the fastening plate 29 between the coupling recesses 29b that are located adjacent to each other in the circumferential direction. The plurality of (eight in this embodiment) bolt holes 29c are formed at equiangular positions in the circumferential direction with respect to the fastening plate 29.

That is, as shown in FIG. 2, the fastening plate 29 has the plurality of coupling recesses 29b and the plurality of bolt holes 29c that are alternately formed in the circumferential direction.

Here, the second coupling portion 72 further includes a cover plate 72a and bolts 72b. The cover plate 72a is formed in an annular plate-like shape that is coaxial with the rotation axis X. The cover plate 72a is arranged so as to be in contact with the surfaces, adjacent to the drive plate 10, of the inner coupling protrusions 28a. In addition, the cover plate 72a has bolt holes 72c at positions substantially corresponding to the bolt holes 29c of the fastening plate 29. The bolts 72b are screwed into the bolt holes 29c and the bolt holes 72c.

Then, as shown in FIG. 1 and FIG. 3, the inner coupling protrusions 27a and 28a that constitute the second coupling portion 72 are inserted in and engaged with the coupling recesses 29b in a state where the fastening plate 29 is inserted in the radially inner sides of the inner rear support plate 27 and inner front support plate 28. Thus, the inner rear support plate 27 and the inner front support plate 28 are restricted from rotating relative to the fastening plate 29, which serves as the highly rigid portion, and are coupled to the fastening plate 29. Furthermore, the cover plate 72a is in contact with the surface, adjacent to the drive plate 10, of the inner coupling protrusions 28a in a state where the inner coupling protrusions 27a and 28a that constitute the second coupling portion 72 are inserted in and engaged with the coupling recesses 29b. Then, the bolts 72b are inserted and screwed in the bolt holes 72c and the bolt holes 29c of the fastening plate 29 to fixedly fasten the cover plate 72a to the fastening plate 29. By so doing, in a state where the inner coupling protrusions 27a and 28a are inserted in the coupling recesses 29b, the inner coupling protrusions 27a and 28a are pressed by the cover plate 72a from the drive plate 10 side. This restricts axial movement of the inner rear support plate 27 and the inner front support plate 28.

In other words, the second coupling portion 72 is a portion at which the radially outer portion of the front cover 30 is fixedly coupled to the inner coupling protrusions 27a and 28a of the inner damper 23 so as to be integrally rotatable and axially immovable via the fastening plate 29. That is, as described above, the fastening plate 29 is fixedly coupled to the radially inner portion of the front cover 30 so as to be integrally rotatable and axially immovable with respect to each other, so the inner coupling protrusions 27a and 28a are fixedly coupled to the radially inner end portion of the front cover 30 via the fastening plate 29 by the second coupling portion 72 so as to be integrally rotatable and axially immovable relative to the front cover 30. Thus, the inner rear support plate 27 and the inner front support plate 28 are coupled to the front cover 30 so as to be able to transmit driving force. Therefore, the driving force transmitted to the inner damper 23, more specifically, the driving force transmitted from the engine and further transmitted from the center support plate 24 to the inner rear support plate 27 and the inner front support plate 28 via the inner damper springs 21b, is transmitted by the second coupling portion 72 from the inner coupling protrusions 27a and 28a of the inner damper 23 of the damper mechanism 20 to the radially inner portion of the front cover 30 via the fastening plate 29.

Then, in the second coupling portion 72, the inner coupling protrusions 27a of the inner rear support plate 27 and the inner coupling protrusions 28a of the inner front support plate 28 are coupled to the radially inner portion of the front cover 30 via the fastening plate 29, which serves as the highly rigid portion. Thus, sufficient rigidity may be ensured at the coupled portions between the inner coupling protrusions 27a and 28a of the inner rear support plate 27 and inner front support plate 28 and the radially inner portion of the front cover 30. That is, the second coupling portion 72 is able to fasten the inner coupling protrusions 27a and 28a of the inner rear support plate 27 and inner front support plate 28 to the radially inner portion of the front cover 30 via the fastening plate 29, which serves as the highly rigid portion, so as to be able to transmit power with high rigidity. Thus, even when various loads are applied to the inner rear support plate 27 or the inner front support plate 28, the second coupling portion 72 is able to suppress deformation of the inner coupling protrusions 27a and 28a of the inner rear support plate 27 and inner front support plate 28.

Note that, in the second coupling portion 72, the inner coupling protrusions 27a of the inner rear support plate 27 and the inner coupling protrusions 28a of the inner front support plate 28 are integrally fixed to the fastening plate 29, and the step 28c functions as a spacer between the inner rear support plate 27 and the inner front support plate 28. Therefore, for example, it is not necessary to provide a rivet or a sleeve in order to integrate the inner rear support plate 27 with the inner front support plate 28, so the damper mechanism 20 may be reduced in size and may also be reduced in weight and cost.

The thus configured damper mechanism 20 transmits the driving force, transmitted from the engine to the drive plate 10, from the radially outer portion of the drive plate 10 to the outer coupling protrusions 25a and 26a of the outer damper 22 at the first coupling portion 71, thus transmitting the driving force to the outer rear support plate 25 and the outer front support plate 26. Then, the damper mechanism 20 transmits the driving force, transmitted to the outer rear support plate 25 and outer front support plate 26 of the outer damper 22, from the circumferential ends of the outer rear support portions 25b and the circumferential ends of the outer front support portions 26b to the outer damper springs 21a via the one circumferential ends of the outer damper springs 21a of the outer damper 22. The damper mechanism 20 transmits the driving force, transmitted to the outer damper springs 21a, from the other circumferential ends of the outer damper springs 21a to the center support plate 24 via the circumferential ends of the outer center support portions 24a.

Then, the damper mechanism 20 transmits the driving force, transmitted to the center support plate 24 via the outer damper springs 21a of the outer damper 22, from the circumferential ends of the inner center support portions 24b to the inner damper springs 21b via the one circumferential ends of the inner damper springs 21b of the inner damper 23. The damper mechanism 20 transmits the driving force, transmitted to the inner damper springs 21b, from the other circumferential ends of the inner damper springs 21b to the inner rear support plate 27 and inner front support plate 28 of the inner damper 23 via the circumferential ends of the inner rear support portions 27b and the circumferential ends of the inner front support portions 28b. Then, the damper mechanism 20 transmits the driving force, transmitted to the inner rear support plate 27 and the inner front support plate 28, from the inner coupling protrusions 27a and 28a to the fastening plate 29 and then to the radially inner portion of the front cover 30 by the second coupling portion 72.

In this way, when the damper mechanism 20 transmits the driving force, transmitted from the engine and further from the radially outer portion of the drive plate 10 to the outer rear support plate 25 and the outer front support plate 26, to the radially inner portion of the front cover 30 via the center support plate 24, the inner rear support plate 27 and the inner front support plate 28, the one ends of the outer damper springs 21a are in contact with the outer rear support plate 25 and the outer front support plate 26 at the ends of the outer rear support portions 25b and outer front support portions 26b, and the other ends of the outer damper springs 21a are in contact with the center support plate 24 at the ends of the outer center support portions 24a. In addition, at this time, the one ends of the inner damper springs 21b are in contact with the center support plate 24 at the ends of the inner center support portions 24b, and the other ends of the inner damper springs 21b are in contact with the inner rear support plate 27 and the inner front support plate 28 at the ends of the inner rear support portions 27b and the ends of the inner front support portions 28b.

Then, when the outer damper springs 21a transmit the driving force, transmitted from the engine to the drive plate 10, from the outer rear support plate 25 and the outer front support plate 26 to the center support plate 24, the outer damper springs 21a contact the outer rear support plate 25, the outer front support plate 26 and the center support plate 24 to elastically deform in accordance with the driving force while being supported by them. When the inner damper springs 21b transmit the driving force, transmitted from the engine to the center support plate 24 via the outer damper springs 21a, from the center support plate 24 to the inner rear support plate 27 and the inner front support plate 28, the inner damper springs 21b contact the center support plate 24, the inner rear support plate 27 and the inner front support plate 28 to elastically deform in accordance with the driving force while being supported by them. Thus, the driving force transmitted from the engine to the drive plate 10 is transmitted by the damper mechanism 20 via the outer damper springs 21a of the outer damper 22 and the inner damper springs 21b of the inner damper 23 in the stated order, and the front cover 30 rotates in the same direction as the drive plate 10. That is, when the damper mechanism 20 transmits the driving force from the radially outer portion of the drive plate 10 to the radially inner portion of the front cover 30, the damper mechanism 20 serially transmits the driving force via the outer damper springs 21a of the outer damper 22 and the inner damper springs 21b of the inner damper 23 with respect to the transmission path of the driving force.

As shown in FIG. 1, the front cover 30 is the second member. The front cover 30 receives driving force from the damper mechanism 20, and transmits the driving force, transmitted from the damper mechanism 20, to the fluid transmission mechanism 40. The front cover 30 has a front cover body 31, a front cover flange 32 and a front cover boss 33.

The front cover body 31 is formed in a disc shape that is coaxial with the rotation axis X. The front cover body 31 has the above described extended portion 31 a. The extended portion 31a is formed so that the radially inner center portion and its surroundings of the front cover body 31 extend toward the drive plate 10 side, that is, toward the engine side. The extended portion 31a is formed in a disc shape that is coaxial with the rotation axis X.

The front cover flange 32 is formed so as to extend from the radially outer end of the front cover body 31 toward the output shaft side. The front cover flange 32 is formed in a cylindrical shape that is coaxial with the rotation axis X.

Then, the front cover body 31 has a step 31b and a step 31c that extend toward the engine side in a stepped manner from the front cover flange 32 toward the extended portion 31a. The step 31b is formed in a cylindrical shape that is coaxial with the rotation axis X at the radially outer end of the extended portion 31a, that is, the outer peripheral end of the extended portion 31a. The step 31c is formed in a cylindrical shape that is coaxial with the rotation axis X near the middle portion in the radial direction between the front cover flange 32 and the step 31b. The step 31c is formed in a cylindrical shape (truncated cone shape) such that the diameter gradually reduces from the front cover flange 32 side toward the step 31b side.

Then, the above described fastening plate 29 is arranged so that the extended portion 31a is inserted in the radially inner end 29a (that is, inner peripheral surface side), and is fixed to the extended portion 31a at the radially inner end 29a by welding S, or the like. At this time, the fastening plate 29 is arranged so that the radially inner end 29a radially faces and contacts the step 31b.

The front cover boss 33 is provided at the extended portion 31a of the front cover body 31 so as to extend toward the drive plate 10 side, that is, toward the engine side. The front cover boss 33 is formed in a cylindrical column shape that is coaxial with the rotation axis X. The front cover boss 33 is inserted in a fitting portion 110a of the crankshaft 110, and is rotatably supported by a bearing 130 with respect to the fitting portion 110a.

That is, the front cover boss 33 is rotatably supported via the bearing 130 with respect to the crankshaft 110, so the front cover 30 is rotatably supported with respect to the crankshaft 110 about the rotation axis X.

The fluid transmission mechanism 40 is the fluid transmission device, and transmits driving force, transmitted to the front cover 30, to the output shaft 60 via hydraulic fluid (hydraulic oil). As shown in FIG. 1, the fluid transmission mechanism 40 includes a pump impeller 41, a turbine liner 42, a stator 43, a one-way clutch 44, and hydraulic oil (hydraulic fluid) filled between the pump impeller 41 and the turbine liner 42.

The pump impeller 41 receives driving force transmitted from the engine to the front cover 30, and transmits the received driving force to the turbine liner 42 via the hydraulic oil. The pump impeller 41 has a plurality of pump blades 41a, a pump shell 41b and an inner core 41c. The pump blades 41a are blades, and are provided at equiangular positions in the circumferential direction of the torque converter 1. The inner core 41 c is connected to the inner peripheries of the pump blades 41a. The pump shell 41b has a ring shape that is coaxial with the rotation axis X and is bowed toward the output shaft side. The pump blades 41a are connected to the inner surface of the bowed pump shell 41b. The pump shell 41b is fixed to the front cover 30 in such a manner that a radially outer end 41d is fixed to the output shaft-side end of the front cover flange 32 of the front cover 30. That is, the pump impeller 41 integrally rotates with the front cover 30, and the driving force transmitted from the engine to the front cover 30 is transmitted to the pump blades 41a via the pump shell 41b. In addition, the radially inner end 41e of the pump shell 41b is fixed to a sleeve 61. The sleeve 61 is coupled to a device that operates by rotational motion, such as an oil pump (not shown).

The turbine liner 42 transmits driving force, transmitted from the engine, from the pump impeller 41 to the output shaft 60 via the hydraulic oil. Here, the output shaft 60 is, for example, an input shaft of the transmission arranged on the output shaft side. The turbine liner 42 has turbine blades 42a, a turbine shell 42b , an inner core 42c and a turbine hub 42d. The turbine blades 42a are blades, and are provided at equiangular positions in the circumferential direction of the torque converter 1. The inner core 42c is connected to the inner peripheries of the turbine blades 42a. The turbine shell 42b has a ring shape that is coaxial with the rotation axis X and that is bowed toward the engine side. The turbine blades 42a are connected to the inner surface of the bowed turbine shell 42b. Here, the turbine liner 42 is arranged so as to face the pump impeller 41. The turbine hub 42d is a proximal portion of the turbine liner 42, and is arranged at the radially inner side. The turbine hub 42d is fixed to the turbine shell 42b in such a manner that a radially outer end 42e is fixed to a radially inner end 42f of the turbine shell 42b by, for example, rivets 42g, or the like. In addition, the turbine hub 42d is fixed to the output shaft 60 in such a manner that, for example, a spline 42h axially formed on the inner peripheral surface of the radially inner end of the turbine hub 42d is spline-fitted to a spline 60a axially formed on the outer peripheral surface of the output shaft 60. That is, the turbine shell 42b integrally rotates with the output shaft 60 via the turbine hub 42d, and the turbine liner 42 integrally rotates with the output shaft 60. Thus, the driving force transmitted from the engine via the pump impeller 41, the hydraulic oil and the turbine liner 42 that constitute the fluid transmission mechanism 40 is transmitted to the output shaft 60.

The stator 43 has a plurality of stator blades 43a formed in the circumferential direction, and is arranged between the pump impeller 41 and the turbine liner 42. The stator 43 changes the flow of hydraulic oil that circulates between the pump impeller 41 and the turbine liner 42 to obtain a predetermined torque characteristic on the basis of driving force transmitted from the engine.

The one-way clutch 44 supports the stator 43 so that the stator 43 is rotatable in one direction with respect to the housing 62. The one-way clutch 44 is rotatably supported by bearings 45 and 46 with respect to the sleeve 61 and the turbine hub 42d.

The lock-up clutch mechanism 50 is a lock-up device. The lock-up clutch mechanism 50 transmits the driving force, transmitted to the front cover 30, to the output shaft 60 via a lock-up piston 51. That is, the lock-up clutch mechanism 50 directly transmits the driving force, transmitted from the engine to the front cover 30, to the output shaft 60 without passing through the hydraulic fluid of the fluid transmission mechanism 40.

The lock-up clutch mechanism 50 includes the lock-up piston 51, frictional engagement surfaces 52, a hydraulic fluid channel 53 and a piston hydraulic chamber 54. The lock-up piston 51 serves as an engagement member. In the present embodiment, the frictional engagement surfaces 52 of the lock-up clutch mechanism 50 are formed of a friction material 55 and a front cover inner wall surface 31d of the front cover 30. The friction material 55 is provided for the lock-up piston 51.

In the lock-up clutch mechanism 50, the front cover inner wall surface 31d of the front cover 30, the friction material 55 and the lock-up piston 51 are axially arranged from the engine side toward the output shaft side. The front cover inner wall surface 31d constitutes one of the frictional engagement surfaces 52. The friction material 55 constitutes the other one of the frictional engagement surfaces 52.

The lock-up piston 51 is provided on a fluid transmission mechanism 40 side of the front cover 30. That is, the lock-up piston 51 is provided in a space that is defined by the front cover 30 and the pump shell 41b of the fluid transmission mechanism 40 and that is filled with hydraulic fluid (hydraulic oil). Furthermore, the lock-up piston 51 is provided on a fluid transmission mechanism 40 side of the front cover 30 so as to be axially movable with respect to the front cover 30.

The lock-up piston 51 is formed in an annular plate-like shape that is coaxial with the rotation axis X, and is axially arranged between the front cover 30 and the turbine liner 42. More specifically, the lock-up piston 51 is axially arranged between the front cover body 31 of the front cover 30 and the turbine shell 42b and turbine hub 42d of the turbine liner 42. The lock-up piston 51 has a radially outer extending portion 51a, a radially inner extending portion 51b, a radially intermediate step 51c and a spline 51d.

The radially outer extending portion 51a is formed so that the radially outer end of the lock-up piston 51 bends toward the turbine liner 42. That is, the radially outer extending portion 51a extends toward the turbine liner 42 and is formed in a cylindrical shape that is coaxial with the rotation axis X.

The radially inner extending portion 51b is formed so that the radially inner end of the lock-up piston 51 bends toward the front cover 30. That is, the radially inner extending portion 51b extends toward the front cover 30 and is formed in a cylindrical shape that is coaxial with the rotation axis X.

The radially intermediate step 51c is provided near an intermediate portion between the radially outer extending portion 51a and the radially inner extending portion 51b in the radial direction of the lock-up piston 51. In the lock-up piston 51, the radially intermediate step 51c is formed so that a radially inner portion extends further toward the engine side than a radially outer portion formed on the radially outer side with respect to the radially intermediate step 51c as a boundary. That is, in the lock-up piston 51, the radially intermediate step 51c is formed so that a portion adjacent to the radially inner extending portion 51b extends further toward the front cover 30 than a portion adjacent to the radially outer extending portion 51a with respect to the radially intermediate step 51c as a boundary. Thus, in the lock-up piston 51, the radially intermediate step 51c is formed so as to extend toward the engine side in a stepped manner from the radially outer extending portion 51a toward the radially inner extending portion 51b. The radially intermediate step 51c is formed in a cylindrical shape that is coaxial with the rotation axis X.

The spline 51d is formed on the inner peripheral surface of the radially intermediate step 51c in the axial direction. The spline 51d is spline-fitted to a spline 42i formed on the outer peripheral surface of the radially outer end 42e of the turbine hub 42d in the axial direction. Thus, the lock-up piston 51 is supported so as to be axially movable with respect to the turbine hub 42d and is integrally rotatable with the turbine hub 42d. That is, the lock-up piston 51 is coupled to the turbine hub 42d by the spline 51d and the spline 42i so as to be integrally rotatable with the turbine hub 42d and axially movable with respect to the turbine hub 42d. Thus, the lock-up piston 51 is coupled to the turbine hub 42d so that driving force transmitted to the lock-up piston 51 is transmittable to the turbine hub 42d, and is axially movable with respect to the front cover 30. That is, the lock-up piston 51 is able to approach to or distance from the front cover 30 in the axial direction.

Note that, in a state where the lock-up piston 51 is coupled to the turbine hub 42d via the spline 51d and the spline 42i so as to be integrally rotatable and axially movable, the radially outer extending portion 51a radially faces the front cover flange 32 with a predetermined gap. In addition, in a state where the lock-up piston 51 is coupled to the turbine hub 42d via the spline 51d and the spline 42i so as to be integrally rotatable and axially movable, the radially inner extending portion 51b faces and contacts the outer peripheral surface (surface opposite to the surface on which the spline 42h is formed) of the radially inner end of the turbine hub 42d, and is supported so as to be axially slidable. Furthermore, in a state where the lock-up piston 51 is coupled to the turbine hub 42d via the spline 51d and the spline 42i so as to be integrally rotatable and axially movable, the radially intermediate step 51c radially faces the step 31c of the front cover body 31 with a predetermined gap.

As described above, the frictional engagement surfaces 52 are formed of the friction material 55, provided for the lock-up piston 51, and the front cover inner wall surface 31d of the front cover 30. The front cover inner wall surface 31d of the front cover body 31 of the front cover 30 is a wall surface that axially faces the lock-up piston 51. The friction material 55 is provided at the radially outer end, that is, near the radially outer extending portion 51a, of a wall surface of the lock-up piston 51 axially facing the front cover body 31. That is, the friction material 55 is provided at a position at which the wall surface of the lock-up piston 51 axially facing the front cover body 31 is most adjacent to the fluid transmission mechanism 40 (output shaft side). The frictional engagement surfaces 52 may be frictionally engaged in such a manner that the front cover body 31 and the friction material 55 provided for the lock-up piston 51 face and contact each other, that is, the radially outer end of the lock-up piston 51 and the front cover 30 may be frictionally engaged. The front cover body 31 and the friction material 55 constitute the frictional engagement surfaces 52.

Then, the lock-up piston 51 is able to change a relative distance of the friction material 55 to the front cover body 31 in such a manner that the lock-up piston 51 is axially moved with respect to the turbine hub 42d to approach to or distance from the front cover body 31 of the front cover 30. Then, this axial sliding of the lock-up piston 51 allows the friction material 55 to contact the front cover body 31 for frictional engagement with the front cover body 31, and, in addition, allows the friction material 55 to disengage from the front cover body 31 to release frictional engagement.

Note that a seal member P is arranged between the radially inner extending portion 51b of the lock-up piston 51 and the outer peripheral surface of the radially inner end of the turbine hub 42d. The seal member P suppresses leakage of hydraulic fluid (hydraulic oil) from between the outer peripheral surface of the radially inner end of the turbine hub 42d and the radially inner extending portion 51b that slides on that outer peripheral surface. Thus, the inside of the torque converter 1 defined by the front cover 30 and the pump shell 41b of the fluid transmission mechanism 40 is partitioned by the lock-up piston 51 into a fluid transmission mechanism space A and a clutch space B. The fluid transmission mechanism 40 is located in the fluid transmission mechanism space A. The friction material 55 of the lock-up clutch mechanism 50 is located in the clutch space B. The fluid transmission mechanism space A is a space provided on the output shaft side with respect to the lock-up piston 51 in the axial direction, that is, a space axially defined by the lock-up piston 51 and the pump shell 41b. The clutch space B is a space axially defined by the front cover 30 and the lock-up piston 51. The fluid transmission mechanism space A and the clutch space B are communicable at a side adjacent to the frictional engagement surfaces 52 via a fluid communication passage between the radially outer extending portion 51a and the front cover flange 32.

The hydraulic fluid channel 53 is formed between the lock-up piston 51 and the front cover 30 in the axial direction, and is formed as a space that allows hydraulic fluid (hydraulic oil) to pass therethrough. Here, the clutch space B, in which the friction material 55 is located inside the torque converter 1, functions as the hydraulic fluid channel 53. The frictional engagement surfaces 52 are provided at a radially outer portion in the clutch space B that functions as the hydraulic fluid channel 53. Then, as described above, the hydraulic fluid channel 53 is formed so as to be communicable with the fluid transmission mechanism space A inside the fluid transmission mechanism 40 via the fluid communication passage between the radially outer extending portion 51a and the front cover flange 32 at the side adjacent to the frictional engagement surfaces 52.

Here, as described above, in the front cover 30, the front cover body 31 has the step 31b and the step 31c that extend toward the engine side in a stepped manner from the front cover flange 32 toward the extended portion 31a. On the other hand, in the lock-up piston 51, the radially intermediate step 51c is formed to extend toward the engine side in a stepped manner from the radially outer extending portion 51a toward the radially inner extending portion 51b. Then, in the lock-up piston 51, the radially intermediate step 51c radially faces the step 31c of the front cover body 31 with a predetermined gap. Thus, the hydraulic fluid channel 53 (clutch space B) defined by the front cover body 31 of the front cover 30 and the lock-up piston 51 is formed to extend toward the engine side in a stepped manner from the radially outer side toward the radially inner side.

Thus, the hydraulic fluid channel 53 (clutch space B) is formed so that, when hydraulic fluid flows from the inside of the fluid transmission mechanism 40 (fluid transmission mechanism space A), the flow of hydraulic fluid downstream of the frictional engagement surfaces 52 in the axial direction forms one-way flow that distances from the fluid transmission mechanism 40, that is, toward the engine side. Conversely, the hydraulic fluid channel 53 is formed so that, when hydraulic fluid flows toward the inside of the fluid transmission mechanism 40, the flow of hydraulic fluid upstream of the frictional engagement surfaces 52 in the axial direction forms one-way flow that approaches to the fluid transmission mechanism 40, that is, toward the output shaft side. That is, the hydraulic fluid channel 53 is, for example, formed so that there is no portion that is folded back to axially turns around.

In addition, the hydraulic fluid channel 53 (clutch space B) is formed so that, when hydraulic fluid flows from the inside of the fluid transmission mechanism 40 (fluid transmission mechanism space A), the channel cross-sectional area downstream of the frictional engagement surfaces 52 gradually increases toward the downstream side in a stepped manner. Conversely, the hydraulic fluid channel 53 is formed so that, when hydraulic fluid flows toward the inside of the fluid transmission mechanism 40 (fluid transmission mechanism space A), the channel cross-sectional area upstream of the frictional engagement surfaces 52 gradually increases toward the upstream side in a stepped manner.

The piston hydraulic chamber 54 is used to generate hydraulic pressing force for axially moving the lock-up piston 51. Here, the fluid transmission mechanism space A, in which the fluid transmission mechanism 40 is located inside the torque converter 1, functions as the piston hydraulic chamber 54. As described above, the fluid transmission mechanism space A that functions as the piston hydraulic chamber 54 is formed between the lock-up piston 51 and the pump shell 41b.

In the thus configured lock-up clutch mechanism 50, by the fluid pressure (hydraulic pressure) of hydraulic fluid (hydraulic oil) supplied to the fluid transmission mechanism space A that functions as the piston hydraulic chamber 54, the lock-up piston 51 approaches toward the front cover 30 in the axial direction, and the friction material 55 that constitutes the frictional engagement surfaces 52 of the lock-up clutch mechanism 50 contacts and frictionally engages with the front cover inner wall surface 31d of the front cover body 31. Thus, the lock-up clutch mechanism 50 is engaged. As the lock-up clutch mechanism 50 is engaged, the front cover 30 and the lock-up piston 51 integrally rotate. Then, the lock-up clutch mechanism 50 directly transmits the driving force, transmitted from the engine to the front cover 30, to the turbine hub 42d via the front cover inner wall surface 31d, the friction material 55 and the lock-up piston 51, and then to the output shaft 60.

Here, in the torque converter 1, hydraulic oil, which serves as hydraulic fluid, is supplied from a hydraulic controller (not shown) to one of the fluid transmission mechanism space A and the clutch space B. The fluid transmission mechanism space A is formed between the lock-up piston 51 and the pump shell 41b and functions as the piston hydraulic chamber 54. The clutch space B is formed between the front cover 30 and the lock-up piston 51 and functions as the hydraulic fluid channel 53.

The hydraulic controller is able to control a pressure difference between the hydraulic pressure in the fluid transmission mechanism space A that functions as the piston hydraulic chamber 54 and the hydraulic pressure in the clutch space B that functions as the hydraulic fluid channel 53, that is, a pressing force that axially acts on an output shaft-side surface of the lock-up piston 51 of the lock-up clutch mechanism 50. When the lock-up clutch mechanism 50 is controlled to be engaged, for example, the hydraulic controller supplies hydraulic oil to the fluid transmission mechanism space A that functions as the piston hydraulic chamber 54, flows the hydraulic oil from the fluid transmission mechanism space A, which is the inside of the fluid transmission mechanism 40, to the clutch space B, and then drains the hydraulic fluid from the clutch space B that functions as the hydraulic fluid channel 53 to the outside of the torque converter 1. Thus, the hydraulic controller decreases the hydraulic pressure in the clutch space B that functions as the hydraulic fluid channel 53, and makes the hydraulic pressure in the clutch space B higher than the hydraulic pressure in the fluid transmission mechanism space A that functions as the piston hydraulic chamber 54. By so doing, the lock-up clutch mechanism 50 moves the lock-up piston 51 to approach to the front cover 30 (toward the engine side), brings the friction material 55 into contact with the front cover inner wall surface 31d, and then frictionally engages the front cover 30 with the lock-up piston 51 via the frictional engagement surfaces 52, thus integrally rotating the front cover 30 and the lock-up piston 51.

In addition, when the lock-up clutch mechanism 50 is controlled to be released, for example, the hydraulic controller supplies hydraulic oil to the clutch space B that functions as the hydraulic fluid channel 53, flows the hydraulic oil from the clutch space B to the fluid transmission mechanism space A, and drains the hydraulic oil from the fluid transmission mechanism space A, which functions as the piston hydraulic chamber 54, to the outside of the torque converter 1. Thus, the lock-up clutch mechanism 50 makes the hydraulic pressure in the clutch space B that functions as the hydraulic fluid channel 53 higher than or equal to the hydraulic pressure in the fluid transmission mechanism space A that functions as the piston hydraulic chamber 54. By so doing, the lock-up clutch mechanism 50 moves the lock-up piston 51 to distance from the front cover 30 (toward the output shaft side), and distances the friction material 55, frictionally engaged with the front cover inner wall surface 31 d, from the front cover inner wall surface 31 d to release the frictional engagement, thus releasing the integral rotation between the lock-up piston 51 and the front cover 30.

Next, the operation of the torque converter 1 according to the present embodiment will be described. As the engine generates driving force to rotate the crankshaft 110, the driving force is transmitted from the engine to the damper mechanism 20 via the drive plate 10, and then the driving force, transmitted from the engine to the damper mechanism 20, is transmitted to the front cover 30.

The driving force, transmitted from the engine to the front cover 30 via the damper mechanism 20, is transmitted to the pump shell 41b of the pump impeller 41, which is coupled to the front cover 30, to rotate the pump impeller 41. As the pump impeller 41 rotates, the hydraulic oil in the fluid transmission mechanism space A circulates among the pump blades 41a, the turbine blades 42a and the stator blades 43a of the stator 43 to operate as a fluid coupling. By so doing, the driving force transmitted from the engine to the front cover 30 is transmitted to the turbine liner 42 via the pump impeller 41 and the hydraulic oil, and then the turbine liner 42 rotates in the same direction as the front cover 30. At this time, the stator 43 changes the flow of hydraulic oil that circulates between the pump blades 41a and the turbine blades 42a via the stator blades 43a. Thus, the torque converter 1 is able to obtain a predetermined torque characteristic.

Then, when the lock-up clutch mechanism 50 is released, frictional engagement between the front cover 30 and the friction material 55 provided for the lock-up piston 51 is released. Thus, as described above, the driving force transmitted from the engine to the turbine liner 42 via the hydraulic oil is transmitted to the output shaft 60 via the turbine hub 42d. That is, when the lock-up clutch mechanism 50 is released, the driving force transmitted from the engine to the front cover 30 is transmitted to the output shaft 60 via the fluid transmission mechanism 40.

On the other hand, when the lock-up clutch mechanism 50 is engaged, the front cover 30 is frictionally engaged with the friction material 55 provided for the lock-up piston 51, so the front cover 30 integrally rotates with the lock-up piston 51. Thus, the driving force transmitted to the front cover 20 via the damper mechanism 20 is transmitted to the lock-up piston 51 via the frictional engagement surfaces 52. The driving force transmitted from the engine to the lock-up piston 51 is transmitted to the output shaft 60 via the turbine hub 42d. That is, when the lock-up clutch mechanism 50 is engaged, the driving force transmitted from the engine to the front cover 30 is transmitted to the output shaft 60 via the lock-up clutch mechanism 50.

Then, irrespective of whether the lock-up clutch mechanism 50 is engaged or released, when driving force transmitted to the drive plate 10 is transmitted to the front cover 30 via the damper mechanism 20, the driving force transmitted to the drive plate 10 is transmitted from the radially outer portion of the drive plate 10 to the radially inner portion of the front cover 30 via the outer damper 22 and inner damper 23 of the damper mechanism 20 sequentially.

That is, the driving force transmitted from the engine to the drive plate 10 is transmitted from the drive plate flange 12, which is the radially outer portion of the drive plate 10 at the first coupling portion 71, to the outer coupling protrusions 25a and 26a of the outer damper 22 and is then transmitted to the outer rear support plate 25 and the outer front support plate 26. The driving force transmitted to the outer rear support plate 25 and the outer front support plate 26 is transmitted to the outer damper springs 21a via the outer rear support portions 25b and the outer front support portions 26b. The driving force transmitted to the outer damper springs 21a is transmitted to the center support plate 24 via the outer center support portions 24a. The driving force transmitted to the center support plate 24 via the outer damper springs 21a of the outer damper 22 is transmitted to the inner damper springs 21b of the inner damper 23 via the inner center support portions 24b. The driving force transmitted to the inner damper springs 21b is transmitted to the inner rear support plate 27 and the inner front support plate 28 via the inner rear support portions 27b and the inner front support portions 28b. The driving force transmitted to the inner rear support plate 27 and the inner front support plate 28 is transmitted from the inner coupling protrusions 27a and 28a to the fastening plate 29 at the second coupling portion 72 and is then transmitted to the radially inner portion of the front cover 30.

Then, for example, when the lock-up clutch mechanism 50 is switched from a released state into an engaged state or from an engaged state into a released state, or when the driving force from the engine fluctuates, or when resistance force transmitted from a road surface to the output shaft 60 fluctuates, force transmitted between the drive plate 10 and the front cover 30 (driving force transmitted from the engine and driven force transmitted from a road surface) fluctuates. Therefore, the drive plate 10 and the front cover 30 that are located respectively on a driving side and a driven side with respect to the damper mechanism 20 tends to rotate relative to each other. At this time, as the driving-side drive plate 10 and the driven-side front cover 30 rotate relative to each other, in accordance with fluctuations in force transmitted between the drive plate 10 and the front cover 30, the outer damper springs 21a of the damper mechanism 20 elastically deform between the outer rear support plate 25 and the center support plate 24 and between the outer front support plate 26 and the center support plate 24, and the inner damper springs 21b of the damper mechanism 20 elastically deform between the center support plate 24 and the inner rear support plate 27 and between the center support plate 24 and the inner front support plate 28. By so doing, for example, vibrations due to combustion of the engine are absorbed by the outer damper springs 21a and the inner damper springs 21b, so it is possible to reduce vibrations, such as muffled sound, when driving force is transmitted via the damper mechanism 20.

In the torque converter 1 according to the present embodiment, when driving force is transmitted from the radially outer portion of the drive plate 10 to the radially inner portion of the front cover 30, the driving force transmitted to the drive plate 10 is transmitted to the front cover 30 via the outer damper springs 21a of the outer damper 22 and the inner damper springs 21b of the inner damper 22 serially with respect to the transmission path of the driving force in the stated order. Thus, it is possible to increase the energy that can be stored in the outer damper springs 21a and inner damper springs 21b of the damper mechanism 20, and it is possible to further improve vibration reduction characteristic, such as prevention of muffled sound in the damper mechanism 20, that is, damper performance. That is, because the vibration reduction capability may be improved, it is possible to further suppress occurrence of muffled sound, or the like. In addition, it is possible to extend the rotational speed range in which the lock-up clutch mechanism 50 may be engaged, so the lock-up clutch mechanism 50 may be engaged in a relatively low rotational speed range. Thus, it is possible to improve fuel economy.

Then, in the torque converter 1 according to the present embodiment, the outer coupling protrusions 25a and 26a of the outer damper 22 that constitute the damper mechanism 20 are coupled to the drive plate flange 12 of the drive plate 10 at the first coupling portion 71 so as to be integrally rotatable and axially movable, while the inner coupling protrusions 27a and 28a of the inner damper 23 that constitute the damper mechanism 20 are fixedly coupled to the radially inner portion of the front cover 30 via the fastening plate 29, serving as the highly rigid portion, at the second coupling portion 72 so as to be integrally rotatable. By so doing, it is possible to ensure sufficient rigidity by the fastening plate 29 at the second coupling portion 72, which is the coupled portion between the radially inner side inner coupling protrusions 27a and 28a and the radially inner portion of the front cover 30 and which tends to have large deformation (displacement) when the damper mechanism 20 receives an axial load. This can suppress deformation of the inner coupling protrusions 27a and 28a. Then, the damper mechanism 20 is axially movable at the first coupling portion 71, which is the coupled portion between the radially outer side outer coupling protrusions 25a and 26a of the damper mechanism 20 and the drive plate flange 12 of the drive plate 10. Thus, the damper mechanism 20 as a whole deforms so that the damper mechanism 20 is substantially moved parallel to the axial direction.

Thus, for example, when an axial load is applied to the damper mechanism 20 as the fluid transmission mechanism 40 side expands because of the hydraulic pressure in the fluid transmission mechanism space A, the damper mechanism 20 as a whole deforms so that the damper mechanism 20 is substantially moved parallel to the axial direction. Thus, it is possible to reduce deformation that deteriorates damper performance, such as deformation that the damper mechanism 20 as a whole bends and twists, and it is possible to reduce friction in the damper mechanism 20 due to the deformation. Therefore, it is possible to further improve damper performance, such as prevention of muffled sound in the damper mechanism 20 by that much. That is, for example, vibration reduction capability may be further improved without increasing the length in the axial direction, so it is possible further suppress occurrence of muffled sound, or the like. In addition, it is possible to extend the rotational speed range in which the lock-up clutch mechanism 50 may be engaged, so the lock-up clutch mechanism 50 may be engaged in a relatively low rotational speed range. Thus, it is possible to improve fuel economy. As a result, the vibration reduction capability may be further improved while suppressing an increase in size of the apparatus.

Particularly, as described above, when the outer damper 22 is arranged at the radially outer side of the damper mechanism 20 and the inner damper 23 is arranged at the radially inner side of the damper mechanism 20, and the driving force transmitted to the drive plate 10 is serially transmitted from the outer coupling protrusions 25a and 26a to the inner coupling protrusions 27a and 28a via the outer damper springs 21a and the inner damper springs 21b in the radial direction, this tends to easily cause deformation such that the intermediate portion between the outer damper 22 and the inner damper 23 bends and twists. However, in the torque converter 1 according to the present embodiment, as described above, the damper mechanism 20 as a whole deforms to move substantially parallel to the axial direction. Therefore, it is possible to reliably ensure appropriate damper performance, so reliability may be improved.

Incidentally, in the above torque converter 1, so-called slip control may be executed to further reduce vibrations. The slip control in the torque converter 1 is executed so that the hydraulic controller controls supply of hydraulic oil so as to maintain a predetermined balance between the hydraulic pressure in the fluid transmission mechanism space A that functions as the piston hydraulic chamber 54 and the hydraulic pressure in the clutch space B that functions as the hydraulic fluid channel 53. That is, in the slip control, for example, the hydraulic controller supplies hydraulic oil to the fluid transmission mechanism space A that functions as the piston hydraulic chamber 54, flows the hydraulic oil from the fluid transmission mechanism space A to the clutch space B to drain the hydraulic oil from the clutch space B, which functions as the hydraulic fluid channel 53, to the outside of the torque converter 1 and maintains the hydraulic pressure in the fluid transmission mechanism space A and the hydraulic pressure in the clutch space B at a predetermined balance. As the hydraulic pressure in the fluid transmission mechanism space A and the hydraulic pressure in the clutch space B are maintained at a predetermined balance, the front cover inner wall surface 31d and the friction material 55 that constitute the frictional engagement surfaces 52 of the lock-up clutch mechanism 50 are in a slipped state (half engaged state). Thus, a power transmission state that is intermediate between release and engagement is established at the contact surface between the front cover inner wall surface 31d and the friction material 55. As a result, as the slip control is executed to place the front cover inner wall surface 31d and the friction material 55 in a slipped state, it is possible to further reduce vibrations, or the like, that cannot be completely removed by, for example, the damper mechanism 20 in the lock-up clutch mechanism 50.

Then, in the torque converter 1 according to the present embodiment, when hydraulic oil flows from the fluid transmission mechanism space A to the clutch space B in the slip control, the clutch space B that functions as the hydraulic fluid channel 53 is formed so that hydraulic fluid downstream of the frictional engagement surfaces 52 flows in one way toward the engine side in the axial direction. Thus, it is possible to prevent formation of a portion at which flow of hydraulic oil is unstable, such as a portion at which flow of hydraulic oil downstream of the frictional engagement surfaces 52 in the hydraulic fluid channel 53 (clutch space B) is folded back to axially turn around or a portion at which flow of hydraulic oil stagnates. This stabilizes flow of hydraulic oil. As a result, for example, it is possible to suppress occurrence of bubbles or eddy in the hydraulic oil due to cavitation, so an oil film state is uniform on the frictional engagement surfaces 52. In addition, a pressure difference is stable between the upstream side and downstream side of the frictional engagement surfaces 52, so it is possible to stabilize the friction coefficient of the frictional engagement surfaces 52. Thus, controllability of slip control may be improved, and, therefore, the slip control may be accurately executed. Thus, vibrations may be further reduced, occurrence of muffled sound, or the like, may be further suppressed, and fuel economy may be further improved.

Note that in the torque converter 1 according to the present embodiment, when hydraulic oil flows from the fluid transmission mechanism space A to the clutch space B in the slip control, the clutch space B that functions as the hydraulic fluid channel 53 is formed so that the channel cross-sectional area of the hydraulic fluid channel 53 downstream of the frictional engagement surfaces 52 gradually increases in a stepped manner toward the downstream side. Thus, it is possible to prevent formation of a portion at which flow of hydraulic oil is unstable because of a steep expansion in volume of the channel downstream of the frictional engagement surfaces 52. Hence, controllability of slip control may be further improved, and the slip control may be further accurately executed.

The torque converter 1 according to the above described embodiment of the invention includes the damper mechanism 20. The damper mechanism 20 has the plurality of damper springs 21 provided between the drive plate 10, to which driving force is transmitted from the engine, and the front cover 30 that transmits the driving force to the fluid transmission mechanism 40, the outer coupling protrusions 25a and 26a that are coupled to the radially outer portion of the drive plate 10 so as to be integrally rotatable, and the inner coupling protrusions 27a and 28a that are coupled to the radially inner portion of the front cover 30 so as to be integrally rotatable. The damper mechanism 20 transmits the driving force, transmitted to the drive plate 10, from the outer coupling protrusions 25a and 26a to the inner coupling protrusions 27a and 28a via the plurality of damper springs 21 and then to the front cover 30. In the damper mechanism 20, the inner coupling protrusions 27a and 28a are fixedly coupled via the fastening plate 29, and the outer coupling protrusions 25a and 26a are axially movably coupled along the rotation axis X.

Thus, sufficient rigidity is ensured by the fastening plate 29 at the second coupling portion 72 between the radially inner side inner coupling protrusions 27a and 28a of the damper mechanism 20 and the radially inner portion of the front cover 30, while the damper mechanism 20 is axially movable at the first coupling portion 71 between the radially outer side outer coupling protrusions 25a and 26a and the drive plate flange 12 of the drive plate 10. Therefore, the damper mechanism 20 as a whole deforms to move substantially parallel to the axial direction. Hence, it is possible to reduce deformation that deteriorates damper performance, and it is possible to improve vibration reduction capability while suppressing an increase in size. As a result, it is possible to suppress occurrence of vibrations, such as muffled sound. In addition, it is possible to extend the rotational speed range in which the lock-up clutch mechanism 50 may be engaged, so the lock-up clutch mechanism 50 may be engaged in a relatively low rotational speed range. Thus, it is possible to improve fuel economy. That is, it is possible to achieve a reduction in size, an increase in damper performance and improvement in fuel economy in the pre-damper-type torque converter 1.

Furthermore, the torque converter 1 according to the above described embodiment of the invention includes the drive plate 10, the damper mechanism 20, the front cover 30, the first coupling portion 71 and the second coupling portion 72. The drive plate 10 receives driving force from the engine. The damper mechanism 20 includes the outer damper 22, the inner damper 23 and the center support plate 24. The outer damper 22 includes the plurality of outer damper springs 21a and has the radially outer side outer coupling protrusions 25a and 26a coupled to the radially outer portion of the drive plate 10. The inner damper 23 is provided on the radially inner side of the plurality of outer damper springs 21a, and includes the plurality of inner damper springs 21b. The center support plate 24 couples the outer damper springs 21a to the inner damper springs 21b. The front cover 30 has the radially inner portion coupled to the radially inner side inner coupling protrusions 27a and 28a of the inner damper 23, and transmits driving force to the fluid transmission mechanism 40. The first coupling portion 71 couples the radially outer portion of the drive plate 10 to the outer coupling protrusions 25a and 26a of the outer damper 22 so as to be integrally rotatable and axially movable along the rotation axis X. The second coupling portion 72 fixedly couples the radially inner portion of the front cover 30 to the inner coupling protrusions 27a and 28a of the inner damper 23 via the fastening plate 29 so as to be integrally rotatable.

In other words, the torque converter 1 according to the above described embodiment of the invention includes the damper mechanism 20, the first coupling portion 71 and the second coupling portion 72. The damper mechanism 20 transmits driving force, transmitted to the outer coupling protrusions 25a and 26a of the outer damper 22 provided on the radially outer side, to the plurality of outer damper springs 21a of the outer damper 22, transmits the driving force, transmitted to the plurality of outer damper springs 21a, to the plurality of inner damper springs 21b of the inner damper 23 provided on the radially inner side of the outer damper springs 21a via the center support plate 24, and then transmits the driving force, transmitted to the plurality of inner damper springs 21b, to the inner coupling protrusions 27a and 28a of the inner damper 23. The first coupling portion 71 couples the radially outer portion of the drive plate 10, to which driving force is transmitted from the engine, to the outer coupling protrusions 25a and 26a of the outer damper 22 so as to be able to transmit driving force and to be axially movable along the rotation axis X. The second coupling portion 72 fixedly couples the radially inner portion of the front cover 30, which transmits the driving force to the fluid transmission mechanism 40, to the inner coupling protrusions 27a and 28a of the inner damper 23 via the fastening plate 29 so as to be able to transmit driving force.

Thus, the outer damper 22 is arranged at the radially outer side and the inner damper 23 is arranged at the radially inner side in the damper mechanism 20, and driving force transmitted to the drive plate 10 is radially transmitted serially from the outer coupling protrusions 25a and 26a to the inner coupling protrusions 27a and 28a via the outer damper springs 21a, the center support plate 24 and the inner damper springs 21b in the stated order. Thus, it is possible to further improve vibration reduction capability, it is possible to further suppress occurrence of muffled sound, or the like, and it is possible to further improve fuel economy. Then, the rigidity of the damper mechanism 20 is sufficiently ensured by the fastening plate 29 at the second coupling portion 72 between the inner coupling protrusions 27a and 28a and the radially inner portion of the front cover 30, while the damper mechanism 20 is axially movable at the first coupling portion 71 between the radially outer side outer coupling protrusions 25a and 26a and the drive plate flange 12 of the drive plate 10. Thus, the damper mechanism 20 as a whole deforms to move substantially parallel to the axial direction, so it is possible to reduce deformation that deteriorates damper performance. As a result, the damper mechanism 20 radially transmits driving force from the outer coupling protrusions 25a and 26a to the inner coupling protrusions 27a and 28a via the outer damper springs 21a and the inner damper springs 21b serially in the stated order. Thus, the size of the apparatus is further reduced and vibration reduction capability is further improved, and then friction in the damper mechanism 20 due to deformation may be reduced. Hence, it is possible to further improve damper performance, such as prevention of muffled sound, in the damper mechanism 20.

Furthermore, with the torque converter 1 according to the above described embodiment of the invention, the damper mechanism 20 includes the center support plate 24, the outer rear support plate 25, the outer front support plate 26, the inner rear support plate 27 and the inner front support plate 28. The center support plate 24 supports the outer damper springs 21a and the inner damper springs 21b so as to be able to transmit driving force. The outer rear support plate 25 and the outer front support plate 26 support the outer damper springs 21a at axially lateral sides of the center support plate 24 so as to be able to transmit driving force, and the outer coupling protrusions 25a and 26a are provided at the radially outer ends of the outer rear support plate 25 and outer front support plate 26. The inner rear support plate 27 and the inner front support plate 28 support the inner damper springs 21b at axially lateral sides of the center support plate 24 so as to be able to transmit driving force, and the inner coupling protrusions 27a and 28a are provided at the radially inner ends of the inner rear support plate 27 and the inner front support plate 28.

Thus, the damper mechanism 20 is able to radially transmit the driving force, transmitted to the outer coupling protrusions 25a of the outer rear support plate 25 and the outer coupling protrusions 26a of the outer front support plate 26, to the inner coupling protrusions 27a of the inner rear support plate 27 and the inner coupling protrusions 28a of the inner front support plate 28 via the outer damper springs 21a, the center support plate 24 and the inner damper springs 21b serially.

Furthermore, the torque converter 1 according to the above described embodiment of the invention includes the lock-up clutch mechanism 50. The lock-up clutch mechanism 50 includes the drive plate 10, the damper mechanism 20, the fluid transmission mechanism 40, the lock-up piston 51, the frictional engagement surfaces 52 and hydraulic fluid channel 53 (clutch space B). Driving force is transmitted from the engine to the drive plate 10. The damper mechanism 20 transmits the driving force, transmitted to the drive plate 10, to the front cover 30 via the plurality of damper springs 21. The fluid transmission mechanism 40 is able to transmit the driving force, transmitted to the front cover 30, to the output shaft 60 via hydraulic fluid (hydraulic oil). The lock-up piston 51 is provided on the fluid transmission mechanism 40 side of the front cover 30 so as to be axially movable with respect to the front cover 30. At the frictional engagement surfaces 52, the radially outer end of the lock-up piston 51 is frictionally engageable with the front cover 30. The hydraulic fluid channel 53 is formed between the lock-up piston 51 and the front cover 30 in the axial direction so as to be communicable with the inside of the fluid transmission mechanism 40 (fluid transmission mechanism space A) at a side adjacent to the frictional engagement surfaces 52. The lock-up clutch mechanism 50 flows hydraulic oil from the inside of the fluid transmission mechanism 40 to the hydraulic fluid channel 53 to approach the lock-up piston 51 to the front cover 30 and frictionally engage the lock-up piston 51 with the front cover 30 via the frictional engagement surfaces 52, thus making it possible to transmit driving force, transmitted to the front cover 30, to the output shaft 60 via the lock-up piston 51. The hydraulic fluid channel 53 (clutch space B) is formed so that, when hydraulic oil flows from the inside of the fluid transmission mechanism 40, hydraulic oil downstream of the frictional engagement surfaces 52 in the axial direction flows in one way that distances from the fluid transmission mechanism 40 (toward the engine side).

Thus, when the hydraulic oil flows from the fluid transmission mechanism space A to the clutch space B in slip control, the clutch space B that functions as the hydraulic fluid channel 53 is formed so that the hydraulic oil downstream of the frictional engagement surfaces 52 flows in one way toward the engine side in the axial direction. Therefore, it is possible to stabilize flow of hydraulic oil downstream of the frictional engagement surfaces 52 in the hydraulic fluid channel 53 (clutch space B), and controllability of slip control may be improved, and the slip control may be accurately executed. Hence, vibrations may be further reduced while suppressing an increase in size, occurrence of muffled sound, or the like, may be further suppressed, and fuel economy may be further improved. Then, with the highly accurate slip control, it is possible to suppress a slip amount (rotational speed) for reducing vibrations. This can also improve fuel economy. In addition, a slip amount (rotational speed) required for reducing muffled sound or vibrations may be suppressed, so it is possible to improve the service life of the frictional engagement surfaces 52.

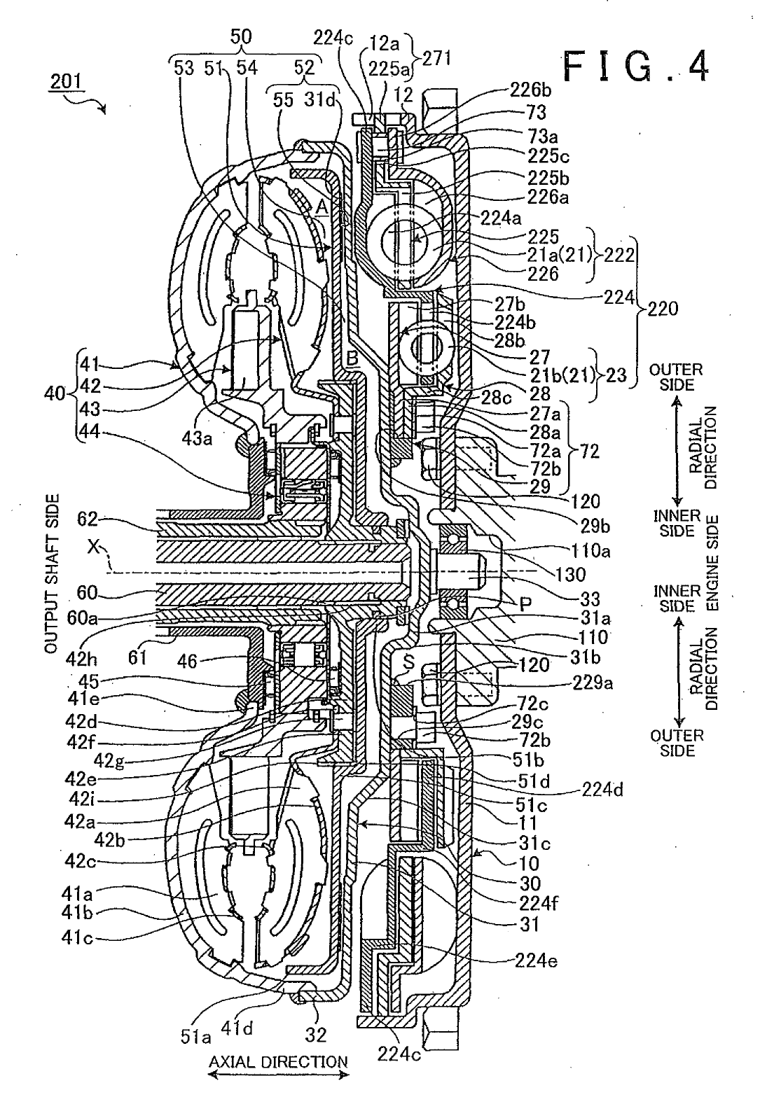

FIG. 4 is a cross-sectional view of a relevant portion of a torque converter according to a second embodiment of the invention. The driving force transmission apparatus according to the second embodiment has a substantially similar configuration to that of the driving force transmission apparatus according to the first embodiment; however, the configuration of the transmitting member differs from that of the driving force transmission apparatus according to the first embodiment. Other than that, the overlap description of the configuration, functions and advantageous effects that are the same as those of the above embodiment is omitted as much as possible, and like reference numerals denote substantially similar components to those of the above embodiment.

A torque converter 201, which serves as the driving force transmission apparatus according to the second embodiment, includes a damper mechanism 220 as a damper device, as shown in FIG. 4.

The damper mechanism 220 includes a plurality of damper springs 21, outer coupling protrusions 225a, and inner coupling protrusions 27a and 28a. The plurality of damper springs 21 serve as a plurality of elastic bodies. The outer coupling protrusions 225a serve as an outer coupling portion. The inner coupling protrusions 27a and 28a serve as an inner coupling portion. The damper mechanism 220 transmits the driving force, transmitted to the drive plate 10, from the outer coupling protrusions 225a to the inner coupling protrusions 27a and 28a via the plurality of damper springs 21 and then to the front cover 30.

More specifically, the damper mechanism 220 includes an outer damper 222, an inner damper 23, and an outer rear inner center support plate 224. The outer rear inner center support plate 224 serves as a transmitting member. The outer damper 222 is arranged at a radially outer side and is provided with the outer coupling protrusions 225a. On the other hand, the inner damper 23 is arranged at a radially inner side and is provided with the inner coupling protrusions 27a and 28a. The outer damper 222 is coupled to the inner damper 23 by the outer rear inner center support plate 224. In addition, the outer coupling protrusions 225a are provided at the radially outer end of the outer damper 222, while the inner coupling protrusions 27a and 28a are provided at the radially inner end of the inner damper 23. That is, the damper mechanism 220 includes the outer coupling protrusions 225a at the radially outer end thereof and includes the inner coupling protrusions 27a and 28a at the radially inner end thereof.

Then, in the damper mechanism 220, the outer coupling protrusions 225a are coupled to the radially outer portion of the drive plate 10 at a first coupling portion 271 so as to be integrally rotatable and axially movable, and the inner coupling protrusions 27a and 28a are fixedly coupled to the radially inner portion of the front cover 30 via a fastening plate 29, which serves as a highly rigid portion, at a second coupling portion 72 so as to be integrally rotatable.

The plurality of damper springs 21 include outer damper springs 21a and inner damper springs 21b. The outer damper springs 21a serve as a plurality of outer elastic bodies and constitute part of the outer damper 222. The inner damper springs 21b serve as a plurality of inner elastic bodies and constitute part of the inner damper 23.

The outer damper springs 21a and the inner damper springs 21b both are supported by the outer rear inner center support plate 224, that is, coupled via the outer rear inner center support plate 224. Here, the damper mechanism 220 transmits the driving force, transmitted to the drive plate 10, from the outer coupling protrusions 225a of the outer damper 222 to the plurality of outer damper springs 21a, transmits the driving force, transmitted to the plurality of outer damper springs 21a, to the plurality of inner damper springs 21b via the outer rear inner center support plate 224, and transmits the driving force, transmitted to the plurality of inner damper springs 21b, to the inner coupling protrusions 27a and 28a of the inner damper 23 and then to the front cover 30.

The outer damper 222 includes an outer center support plate 225, an outer front support plate 226 and the above described plurality of outer damper springs 21a. The outer center support plate 225 serves as an outer center support member.

The inner damper 23 has an inner rear support plate 27, an inner front support plate 28 and the above described plurality of inner damper springs 21b. The inner rear support plate 27 and the inner front support plate 28 serve as an inner lateral support member.

The outer center support plate 225 is formed in an annular plate-like shape that is coaxial with the rotation axis X, and is axially arranged between the drive plate 10 and the front cover 30. The outer center support plate 225 is arranged at a radially outer portion in a space between the drive plate 10 and the front cover 30. The outer center support plate 225 has the above described outer coupling protrusions 225a and outer center support portions 225b. Each outer center support portion 225b is a slit that is formed in a circular arc shape in the outer center support plate 225. The outer damper springs 21a are inserted in the outer center support portions 225b. The outer center support portions 225b support the outer damper springs 21a. The plurality of outer center support portions 225b are formed at equiangular positions in the circumferential direction with respect to the outer center support plate 225.

Each outer center support portion 225b has a length in the circumferential direction so that the outer damper spring 21a may be supported in an urged state. Thus, as each outer damper spring 21a is supported by a corresponding one of the outer center support portions 225b, both circumferential ends of each outer center support portion 225b are respectively in contact with both ends of a corresponding one of the outer damper springs 21a. That is, each outer damper spring 21a is in contact with both circumferential ends of a corresponding one of the outer center support portions 225b, and is supported between both circumferential ends in an urged state. The outer center support plate 225 is able to transmit driving force to and from the outer damper springs 21a at the contact portions of the circumferential ends at which the outer center support portions 225b are in contact with the outer damper springs 21a.

Then, the outer front support plate 226 of the outer damper 22 supports part of the plurality of outer damper springs 21a at an axially lateral side, here, the engine side, of the outer center support plate 225.

The outer front support plate 226 is formed in an annular plate-like shape that is coaxial with the rotation axis X, and is axially arranged on the drive plate 10 side (engine side) of the outer center support plate 225, that is, between the outer center support plate 225 and the drive plate 10. The outer front support plate 226 has outer front support portions 226a.

The outer front support portions 226a accommodate and support part of the outer damper springs 21a of which the center portions in the axial direction are supported by the outer center support plate 225.

The outer front support portions 226a are provided on an output shaft-side wall surface of the outer front support plate 226, that is, a wall surface facing the outer center support plate 225. The outer front support portions 226a are formed so that the wall surface of the outer front support plate 226 facing the outer center support plate 225 is recessed toward the engine side (side opposite to the outer center support plate 225 side). The outer front support portions 226a are formed in a circular arc shape in the circumferential direction of the outer front support plate 226. The plurality of outer front support portions 226a are formed at equiangular positions in the circumferential direction of the outer front support plate 226.

Here, as described above, the outer rear inner center support plate 224 supports the plurality of outer damper springs 21a and the plurality of inner damper springs 21b so as to be able to transmit driving force. That is, the outer rear inner center support plate 224 according to the present embodiment functions as a member that supports the outer damper springs 21a of the outer damper 222 and also functions as a member that supports the inner damper springs 21b of the inner damper 23. The outer rear inner center support plate 224 is formed in an annular plate-like shape that is coaxial with the rotation axis X. The outer rear inner center support plate 224 has outer rear support portions 224a and inner center support portions 224b.

The outer rear inner center support plate 224 has a step 224e and a step 224f that are formed to extend toward the drive plate 10 side, that is, the engine side, in a stepped manner from a radially outer end 224c of the outer rear inner center support plate 224 toward a radially inner end 224d thereof. The step 224e is formed near the radially outer end 224c of the outer rear inner center support plate 224 and is formed in an annular shape that is coaxial with the rotation axis X. The step 224f is formed near the radially intermediate portion between the step 224e and the radially inner end 224d and is formed in an annular shape that is coaxial with the rotation axis X. The outer rear inner center support plate 224 has the outer rear support portions 224a that are provided radially between the step 224e and the step 224f. The outer rear inner center support plate 224 also has the inner center support portions 224b that are provided between the step 224f and the radially inner end 224d. That is, the outer rear support portions 224a are provided at a radially outer side of the outer rear inner center support plate 224, while the inner center support portions 224b are provided at a radially inner side of the outer rear inner center support plate 224.

The outer rear inner center support plate 224 supports part of the plurality of outer damper springs 21a by the outer rear support portions 224a at an axially lateral side, that is, the output shaft side, of the outer center support plate 225 in the outer damper 222 so as to be able to transmit driving force. In addition, the outer rear inner center support plate 224 supports center portions of the plurality of inner damper springs 21b in the axial direction by the inner center support portions 224b in the inner damper 23.

That is, in the outer damper 222, the outer front support plate 226, the outer center support plate 225, the plurality of outer damper springs 21a and the outer rear inner center support plate 224 are axially arranged from the engine side toward the output shaft side in the stated order. The plurality of outer damper springs 21a and the outer center support plate 225 are arranged in the axial space between the outer rear inner center support plate 224 and the outer front support plate 226. The outer rear inner center support plate 224 and the outer front support plate 226 hold the outer center support plate 225 and the plurality of outer damper springs 21a in between to support them. The outer rear inner center support plate 224 and the outer front support plate 226 hold both axially lateral sides of the outer center support plate 225 to rotatably support the outer center support plate 225.

The outer rear support portions 224a accommodate and support part of the outer damper springs 21a of which the center portions in the axial direction are supported by the outer center support plate 225. The outer rear support portions 224a are provided on an engine-side wall surface (wall surface adjacent to the outer front support plate 226) of the outer rear inner center support plate 224, that is, on a wall surface facing the outer center support plate 225. The outer rear support portions 224a are formed so that, at a portion between the step 224e and step 224f of the outer rear inner center support plate 224, the wall surface of the outer rear inner center support plate 224 facing the outer center support plate 225 is recessed toward the output shaft side (side opposite to the outer center support plate 225 side). The outer rear support portions 224a are formed in a circular arc shape in the circumferential direction of the outer rear inner center support plate 224. The plurality of outer rear support portions 224a are formed at equiangular positions in the circumferential direction with respect to the outer rear inner center support plate 224.

Then, each outer rear support portion 224a is formed at a position that axially faces a corresponding one of the outer center support portions 225b of the outer center support plate 225. Similarly, each outer front support portion 226b are formed at a position that axially faces a corresponding one of the outer center support portions 225b of the outer center support plate 225.

Thus, in the outer damper 222, each outer center support portion 225b of the outer center support plate 225 supports a center portion (center portion in the axial direction) of a corresponding one of the outer damper springs 21a, and each outer rear support portion 224a of the outer rear inner center support plate 224 accommodates and supports part of a corresponding one of the outer damper springs 21a supported by the outer center support portion 225b, which is closer to the output shaft than the outer center support portion 225b, while each outer front support portion 226b of the outer front support plate 226 accommodates and supports part of a corresponding one of the outer damper springs 21a, which is closer to the engine than the outer center support portion 225b.

Then, both circumferential ends of each outer rear support portion 224a and both circumferential ends of each outer front support portion 226a face both ends of a corresponding one of the outer damper springs 21a in the circumferential direction and are contactable with both ends of the outer damper springs 21a in a state where each outer damper spring 21a is supported by a corresponding one of the outer center support portions 225b. As a result, the outer rear inner center support plate 224 and the outer front support plate 226 are able to transmit driving force to and from the outer damper springs 21a at the contact portions of the circumferential ends at which the outer rear support portions 224a and the outer front support portions 226a are in contact with the outer damper springs 21a.

That is, each outer damper spring 21a is supported by the outer center support portion 225b of the outer center support plate 225, the outer rear support portion 224a of the outer rear inner center support plate 224 and the outer front support portion 226a of the outer front support plate 226. Then, driving force is transmittable between the outer center support plate 225 and the outer rear inner center support plate 224 and between the outer center support plate 225 and the outer front support plate 226.

Here, in the outer damper 222, the radially outer end 224c of the outer rear inner center support plate 224 and the radially outer end 226b of the outer front support plate 226 are integrated by, for example, rivets 73 with the outer center support plate 225 interposed therebetween. In addition, sleeves 73a that function as a spacer are provided between the outer rear inner center support plate 224 and the outer front support plate 226 that are integrated by the rivets 73. In addition, the outer center support plate 225 has slide portions 225c through which the rivets 73 and the sleeves 73a extend. The outer rear inner center support plate 224 and the outer front support plate 226 are assembled on axially both sides of the outer center support plate 225 by the rivets 73 and the sleeves 73a so as to be rotatable with respect to the outer center support plate 225.

Then, the outer center support plate 225 has the above described outer coupling protrusions 225a at the radially outer end (that is, end adjacent to the outer peripheral surface). The outer coupling protrusions 225a constitute the first coupling portion 271 together with coupling cutouts 12a of the drive plate 10. The outer coupling protrusions 225a are formed to extend from the radially outer end of the outer center support plate 225 toward the radially outer side so as to radially face the coupling cutouts 12a of the drive plate 10 in a state where the outer center support plate 225 is inserted in the drive plate 10. The plurality of outer coupling protrusions 225a are formed at equiangular positions in the circumferential direction with respect to the outer center support plate 225.

The outer coupling protrusions 225a that constitute the first coupling portion 271 are inserted in and engaged with the coupling cutouts 12a in a state where the outer center support plate 225 is inserted inside the drive plate 10. Thus, the outer center support plate 225 is restricted from rotating relative to the drive plate 10 and is allowed to move relative to the drive plate 10 in the axial direction. That is, the outer center support plate 225 is coupled to the drive plate 10 at the first coupling portion 271, formed of the outer coupling protrusions 225a and the coupling cutouts 12a, so that the outer center support plate 225 is integrally rotatable with the drive plate 10 and is axially movable with respect to the drive plate 10. In addition, the outer center support plate 225 is coupled to the drive plate 10 so as to be able to transmit driving force. Thus, the driving force transmitted from the engine to the drive plate 10 is transmitted to the outer coupling protrusions 225a of the outer damper 222 of the damper mechanism 220 at the first coupling portion 271.

On the other hand, the inner rear support plate 27 and inner front support plate 28 of the inner damper 23 support part of the plurality of inner damper springs 21b at axially lateral sides, here, both lateral sides, of the outer rear inner center support plate 224 via the inner rear support portions 27b and the inner front support portions 28b so as to be able to transmit driving force.

That is, in the inner damper 23, the inner front support plate 28, the outer rear inner center support plate 224, the plurality of inner damper springs 21b and the inner rear support plate 27 are axially arranged from the engine side toward the output shaft side in the stated order. The outer rear inner center support plate 224 together with the plurality of inner damper springs 21b is arranged in an axial space between the inner rear support plate 27 and the inner front support plate 28. The inner rear support plate 27 and the inner front support plate 28 hold the outer rear inner center support plate 224 and the plurality of inner damper springs 21b in between to support them. The inner rear support plate 27 and the inner front support plate 28 hold both axially lateral sides of the outer rear inner center support plate 224 in between to support the outer rear inner center support plate 224 so that the outer rear inner center support plate 224 is rotatable relative to the inner rear support plate 27 and the inner front support plate 28.

Then, the inner damper springs 21b are inserted in the inner center support portions 224b of the outer rear inner center support plate 224, and the inner center support portions 224b support the inner damper springs 21b. The inner center support portions 224b are formed of slits that are formed in a circular arc shape between the step 224f and radially inner end 224d of the outer rear inner center support plate 224. The plurality of inner center support portions 224b are formed at equiangular positions in the circumferential direction with respect to the outer rear inner center support plate 224.

Each inner center support portion 224b has a circumferential length so that a corresponding one of the inner damper springs 21b may be supported in an urged state. Thus, as each inner damper spring 21b is supported by a corresponding one of the inner center support portions 224b, both circumferential ends of each inner center support portion 224b are respectively in contact with both ends of a corresponding one of the inner damper springs 21b. That is, each inner damper spring 21b is in contact with both circumferential ends of a corresponding one of the inner center support portions 224b, and is supported between both circumferential ends in an urged state. The outer rear inner center support plate 224 is able to transmit driving force to and from the inner damper springs 21b at the contact portions of the circumferential ends at which the inner center support portions 224b are in contact with the inner damper springs 21b.

Then, each inner rear support portion 27b is formed at a position that axially faces a corresponding one of the inner center support portions 224b of the outer rear inner center support plate 224. Similarly, each inner front support portion 28b is formed at a position that axially faces a corresponding one of the inner center support portions 224b of the outer rear inner center support plate 224.

Thus, in the inner damper 23, each inner center support portion 224b of the outer rear inner center support plate 224 supports a center portion (center portion in the axial direction) of a corresponding one of the inner damper springs 21b, and each inner rear support portion 27b of the inner rear support plate 27 accommodates and supports part of a corresponding one of the inner damper springs 21b supported by the inner center support portion 224b, which is closer to the output shaft than the inner center support portion 224b, while each inner front support portion 28b of the inner front support plate 28 accommodates and supports part of a corresponding one of the inner damper springs 21b, which is closer to the engine than the inner center support portion 224b.

Then, both circumferential ends of each inner rear support portion 27b and both circumferential ends of each inner front support portion 28b face both ends of a corresponding one of the inner damper springs 21b in the circumferential direction and are contactable with both ends of the inner damper spring 21b in a state where each inner damper spring 21b is supported by a corresponding one of the inner center support portions 224b. As a result, the inner rear support plate 27 and the inner front support plate 28 are able to transmit driving force to and from the inner damper springs 21b at the contact portions of the circumferential ends at which the inner rear support portions 27b and the inner front support portions 28b are in contact with the inner damper springs 21b.

That is, each inner damper spring 21b is supported by the inner center support portion 224b of the outer rear inner center support plate 224, the inner rear support portion 27b of the inner rear support plate 27 and the inner front support portion 28b of the inner front support plate 28. Then, driving force is transmittable between the outer rear inner center support plate 224 and the inner rear support plate 27 and between the outer rear inner center support plate 224 and the inner front support plate 28.

Then, the inner rear support plate 27 has the inner coupling protrusions 27a at the radially inner end (that is, end adjacent to the inner peripheral surface), while the inner front support plate 28 has the inner coupling protrusions 28a at the radially inner end (that is, end adjacent to the inner peripheral surface). The inner coupling protrusions 27a and 28a are fixed to the radially inner portion of the front cover 30 via the fastening plate 29, which serves as the highly rigid portion, so as to be integrally rotatable, that is, the inner coupling protrusions 27a and 28a are coupled to the radially inner portion of the front cover 30 so that the inner coupling protrusions 27a and 28a are axially immovable relative to the front cover 30. That is, the inner coupling protrusions 27a and 28a constitute the second coupling portion 72 together with the fastening plate 29. Note that the radially inner end 229a (that is, inner peripheral surface side) of the fastening plate 29 according to the present embodiment radially faces the step 31b but is not in contact with the step 31b. That is, according to the present embodiment the inner diameter of the fastening plate 29 is slightly larger than the inner diameter of the fastening plate 29 according to the first embodiment (see FIG. 1).

The thus configured damper mechanism 220 transmits the driving force, transmitted from the engine to the drive plate 10, from the radially outer portion of the drive plate 10 to the outer coupling protrusions 225a of the outer damper 222 at the first coupling portion 271, thus transmitting the driving force to the outer center support plate 225. Then, the damper mechanism 220 transmits the driving force, transmitted to the outer center support plate 225 of the outer damper 222, from the circumferential ends of the outer center support portions 225b to the outer damper springs 21a via one circumferential ends of the outer damper springs 21a of the outer damper 222. The damper mechanism 220 transmits the driving force, transmitted to the outer damper springs 21a, from the other circumferential ends of the outer damper springs 21a to the outer rear inner center support plate 224 and the outer front support plate 226 via the circumferential ends of the outer rear support portions 224a and outer front support portions 226a.

Then, the damper mechanism 220 transmits the driving force, transmitted to the outer rear inner center support plate 224 and the outer front support plate 226 via the outer damper springs 21a of the outer damper 222, from the circumferential ends of the inner center support portions 224b of the outer rear inner center support plate 224 to the inner damper springs 21b via one circumferential ends of the inner damper springs 21b of the inner damper 23. The damper mechanism 220 transmits the driving force, transmitted to the inner damper springs 21b, from the other circumferential ends of the inner damper springs 21b to the inner rear support plate 27 and inner front support plate 28 of the inner damper 23 via the circumferential ends of the inner rear support portions 27b and inner front support portions 28b. Then, the damper mechanism 220 transmits the driving force, transmitted to the inner rear support plate 27 and the inner front support plate 28, at the second coupling portion 72 from the inner coupling protrusions 27a and 28a to the fastening plate 29 and then to the radially inner portion of the front cover 30.

With the torque converter 201 according to the above described embodiment of the invention, sufficient rigidity is ensured by the fastening plate 29 at the second coupling portion 72 between the radially inner side inner coupling protrusions 27a and 28a of the damper mechanism 220 and the radially inner portion of the front cover 30, while the damper mechanism 220 is axially movable at the first coupling portion 271 between the radially outer side outer coupling protrusions 225a and the drive plate flange 12 of the drive plate 10. Therefore, the damper mechanism 220 as a whole deforms to move substantially parallel to the axial direction. Hence, it is possible to reduce deformation that deteriorates damper performance, and it is possible to improve vibration reduction capability while suppressing an increase in size.

Furthermore, with the torque converter 201 according to the above described embodiment of the invention, the outer damper 222 is arranged at the radially outer side and the inner damper 23 is arranged at the radially inner side in the damper mechanism 220, and driving force transmitted to the drive plate 10 is radially transmitted serially from the outer coupling protrusions 225a to the inner coupling protrusions 27a and 28a via the outer damper springs 21a, the outer rear inner center support plate 224 and the inner damper springs 21b in the stated order. Thus, it is possible to further improve vibration reduction capability. In addition, the damper mechanism 220 as a whole deforms to move substantially parallel to the axial direction, so it is possible to reduce deformation that deteriorates damper performance. As a result, the damper mechanism 220 radially transmits driving force from the outer coupling protrusions 225a to the inner coupling protrusions 27a and 28a via the outer damper springs 21a and the inner damper springs 21b serially in the stated order. Thus, the size of the apparatus is further reduced and vibration reduction capability is further improved, and then friction in the damper mechanism 220 due to deformation may be reduced. Hence, it is possible to further improve damper performance, such as prevention of muffled sound, in the damper mechanism 220.

Furthermore, with the torque converter 201 according to the above described embodiment of the invention, the damper mechanism 220 includes the outer center support plate 225, the outer rear inner center support plate 224, the inner rear support plate 27 and the inner front support plate 28. The outer center support plate 225 supports the outer damper springs 21a so as to be able to transmit driving force, and the outer coupling protrusions 225a are provided at the radially outer end of the outer center support plate 225. The outer rear inner center support plate 224 supports the outer damper springs 21a at the axially lateral side of the outer center support plate 225 so as to be able to transmit driving force, and supports the inner damper springs 21b so as to be able to transmit driving force. The inner rear support plate 27 and the inner front support plate 28 support the inner damper springs 21b at the axially lateral sides of the outer rear inner center support plate 224 so as to be able to transmit driving force, and respectively have the inner coupling protrusions 27a and 28a at the radially inner ends thereof.

Thus, the damper mechanism 220 is able to radially transmit the driving force, transmitted to the outer coupling protrusions 225a of the outer center support plate 225, to the inner coupling protrusions 27a of the inner rear support plate 27 and the inner coupling protrusions 28a of the inner front support plate 28 via the outer damper springs 21a, the outer rear inner center support plate 224 and the inner damper springs 21b serially.

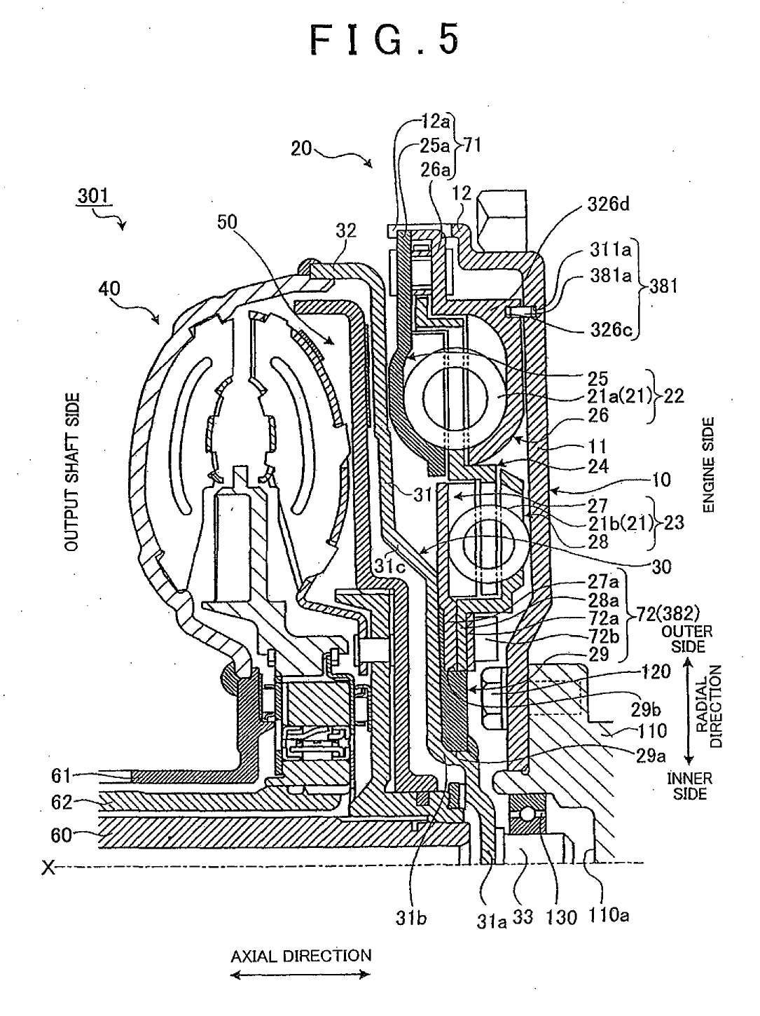

FIG. 5 is a cross-sectional view of a relevant portion of a torque converter according to a third embodiment of the invention. The driving force transmission apparatus according to the third embodiment has a substantially similar configuration to that of the driving force transmission apparatus according to the first embodiment; however, the configuration of the driving force transmission apparatus according to the third embodiment differs from that of the driving force transmission apparatus according to the first embodiment in that an outer damper positioning portion is provided. Other than that, the overlap description of the configuration, functions and advantageous effects that are the same as those of the above embodiments is omitted as much as possible, and like reference numerals denote substantially similar components to those of the above embodiments. Note that, in FIG. 5, only one side of the torque converter is shown with respect to the rotation axis X as a central axis, and the other side is omitted.

A torque converter 301, which serves as the driving force transmission apparatus according to the third embodiment, includes an outer damper positioning portion 381 and an inner damper positioning portion 382.

The outer damper positioning portion 381 is provided for the drive plate 10, and radially positions the outer damper 22 of the damper mechanism 20. The outer damper positioning portion 381 includes drive plate side insertion holes 311a, outer damper side insertion holes 326c and knock-pins 381a.

Each drive plate side insertion hole 311a is provided for the drive plate body 11 of the drive plate 10. Each drive plate side insertion hole 311a is provided near the radially outer end, that is, near the drive plate flange 12, of an output shaft-side wall surface, that is, a wall surface facing the outer front support plate 26, of the drive plate body 11. Each drive plate side insertion hole 311a is formed as a cylindrical column-shaped hole in a wall surface facing the outer front support plate 26 of the drive plate body 11. The central axis of each drive plate side insertion hole 311a is formed parallel to the rotation axis X. The plurality of drive plate side insertion holes 311a are formed at equiangular positions in the circumferential direction with respect to the drive plate body 11.

Each outer damper side insertion hole 326c is provided for the outer front support plate 26 of the outer damper 22. Each outer damper side insertion hole 326c is provided for an extended portion 326d near the radially outer end, that is, near the outer coupling protrusion 26a, of an engine-side wall surface, that is, a wall surface facing the drive plate body 11, of the outer front support plate 26. The extended portion 326d is formed near the outer coupling protrusions 26a of the outer front support plate 26 so that the wall surface facing the drive plate body 11 extends toward the drive plate body 11. Each outer damper side insertion hole 326c is formed as a cylindrical column-shaped hole in a wall surface, facing the drive plate body 11, of the extended portion 326d of the outer front support plate 26. The central axis of each outer damper side insertion hole 326c is formed parallel to the rotation axis X. The plurality of outer damper side insertion holes 326c are formed at equiangular positions in the circumferential direction with respect to the outer front support plate 26. In addition, each outer damper side insertion hole 326c is formed at a position that axially faces a corresponding one of the drive plate side insertion holes 311a.

The single knock-pin 381a is provided for each pair of outer damper side insertion hole 326c and drive plate side insertion hole 311a. Each knock-pin 381a is formed in a cylindrical column shape, and one end thereof is inserted in a corresponding one of the drive plate side insertion holes 311a. Then, the outer front support plate 26 of the outer damper 22 is formed so that the other end of each knock-pin 381a is inserted in a corresponding one of the outer damper side insertion holes 326c.

Thus, the outer damper positioning portion 381 is able to restrict relative movement of the outer damper 22 of the damper mechanism 20 with respect to the drive plate body 11 in the radial direction, and also able to allow relative movement in the axial direction in such a manner that the knock-pins 381a are inserted in the drive plate side insertion holes 311a of the drive plate body 11 and the outer damper side insertion holes 326c of the outer front support plate 26. That is, the outer damper positioning portion 381 allows relative movement of the outer damper 22 of the damper mechanism 20 in the axial direction while making it possible to fix the relative positional relationship in the radial direction between the outer damper 22 of the damper mechanism 20 and the drive plate body 11.

Then, as described above, the drive plate body 11 is fixed to the crankshaft 110 by the coupling member 120, and the drive plate 10 is integrally rotatable with the crankshaft 110 about the rotation axis X. That is, relative movement of the drive plate 10 in the radial direction with respect to the crankshaft 110 is restricted, and relative positional relationship in the radial direction between the drive plate 10 and the crankshaft 110 is fixed.

As a result, the outer damper 22 of the damper mechanism 20 is radially positioned via the drive plate 10 and the outer damper positioning portion 381 with respect to the crankshaft 110, that is, relative movement in the radial direction with respect to the crankshaft 110 is restricted.

The inner damper positioning portion 382 is provided for the front cover 30, and positions the inner damper 23 of the damper mechanism 20 in the radial direction. In the present embodiment, the second coupling portion 72 also serves as the inner damper positioning portion 382.

As described above, the second coupling portion 72 that also serves as the inner damper positioning portion 382 is provided at the radially inner portion of the front cover 30, and fixedly couples the inner coupling protrusions 27a and 28a of the inner damper 23 to the radially inner portion of the front cover 30 via the fastening plate 29.

Then, the front cover boss 33 is inserted in the fitting portion 110a of the crankshaft 110, and the front cover 30 is rotatably supported by a bearing 130 with respect to the fitting portion 110a about the rotation axis X, that is, coaxially with the crankshaft 110. That is, relative movement of the front cover 30 in the radial direction with respect to the crankshaft 110 is restricted, and relative positional relationship in the radial direction between the front cover 30 and the crankshaft 110 is fixed.

As a result, the inner damper 23 of the damper mechanism 20 is radially positioned via the bearing 130, the front cover 30 and the second coupling portion 72, which also serves as the inner damper positioning portion 382, with respect to the crankshaft 110, that is, relative movement in the radial direction with respect to the crankshaft 110 is restricted.

Then, the damper mechanism 20 is provided with the center support plate 24 so as to couple the outer damper springs 21a of the outer damper 22 to the inner damper springs 21b of the inner damper 23. The outer damper springs 21a are radially positioned by the outer damper positioning portion 381. The inner damper springs 21b are radially positioned by the inner damper positioning portion 382.

Thus, the damper mechanism 20 is able to accurately center the outer damper 22 and the inner damper 23, that is, accurately align the rotation center of the outer damper 22 and the rotation center of the inner damper 23 with the rotation axis X. As a result, it is possible to prevent the rotation center of the outer damper 22 and the rotation center of the inner damper 23 from decentering from the rotation axis X. In addition, it is possible to prevent occurrence of vibrations during rotation due to decentering. Therefore, damper performance of the damper mechanism 20 may be stabilized.

In addition, in the damper mechanism 20, the outer damper 22 and the inner damper 23 are radially positioned by the outer damper positioning portions 381 and the inner damper positioning portions 382. Thus, when an axial load is applied to the damper mechanism 20 because of expansion, or the like, of the fluid transmission mechanism 40 side due to the hydraulic pressure in the fluid transmission mechanism space A, it is possible to further reliably reduce deformation that deteriorates damper performance, such as deformation such that the intermediate portion between the outer damper 22 and the inner damper 23 bends and twists.

With the torque converter 301 according to the above described embodiment of the invention, sufficient rigidity is ensured by the fastening plate 29 at the second coupling portion 72 between the radially inner side inner coupling protrusions 27a and 28a of the damper mechanism 20 and the radially inner portion of the front cover 30, while the damper mechanism 20 is axially movable at the first coupling portion 71 between the radially outer side outer coupling protrusions 25a and 26a and the drive plate flange 12 of the drive plate 10. Therefore, the damper mechanism 20 as a whole deforms to move substantially parallel to the axial direction. Hence, it is possible to reduce deformation that deteriorates damper performance, and it is possible to improve vibration reduction capability while suppressing an increase in size.

Furthermore, with the torque converter 301 according to the above described embodiment of the invention, the outer damper 22 is arranged at the radially outer side and the inner damper 23 is arranged at the radially inner side in the damper mechanism 20, and driving force transmitted to the drive plate 10 is radially transmitted serially from the outer coupling protrusions 25a and 26a to the inner coupling protrusions 27a and 28a via the outer damper springs 21a, the center support plate 24 and the inner damper springs 21b in the stated order. Thus, it is possible to further improve vibration reduction capability. In addition, the damper mechanism 20 as a whole deforms to move substantially parallel to the axial direction, so it is possible to reduce deformation that deteriorates damper performance. As a result, the damper mechanism 20 radially transmits driving force from the outer coupling protrusions 25a and 26a to the inner coupling protrusions 27a and 28a via the outer damper springs 21a and the inner damper springs 21b serially in the stated order. Thus, the size of the apparatus is further reduced and vibration reduction capability is further improved, and then friction in the damper mechanism 20 due to deformation may be reduced. Hence, it is possible to further improve damper performance, such as prevention of muffled sound, in the damper mechanism 20.

Furthermore, with the torque converter 301 according to the above described embodiment of the invention, the drive plate 10 is fixed to the crankshaft 110 that outputs driving force transmitted from the engine, and is provided with the outer damper positioning portion 381 that radially positions the outer damper 22. The front cover 30 is rotatably supported by the crankshaft 110 via the bearing 130 so as to be coaxial with the crankshaft 110, and is provided with the second coupling portion 72, which also serves as the inner damper positioning portion 382 that radially positions the inner damper 23. Thus, the outer damper 22 and the inner damper 23 are radially positioned by the outer damper positioning portion 381 and the inner damper positioning portion 382, so it is possible to accurately center the outer damper 22 and the inner damper 23, and it is possible to stabilize the damper performance of the damper mechanism 20. Hence, it is possible to further effectively suppress occurrence of muffled sound, or the like. In addition, it is possible to further reliably reduce deformation that deteriorates damper performance, and it is possible to further reliably ensure appropriate damper performance, so reliability may be improved.

Note that in the above description, the outer damper positioning portion according to the aspect of the invention is formed of the drive plate side insertion holes 311a, the outer damper side insertion holes 326c and the knock-pins 381a; however, the aspect of the invention is not limited to this configuration.

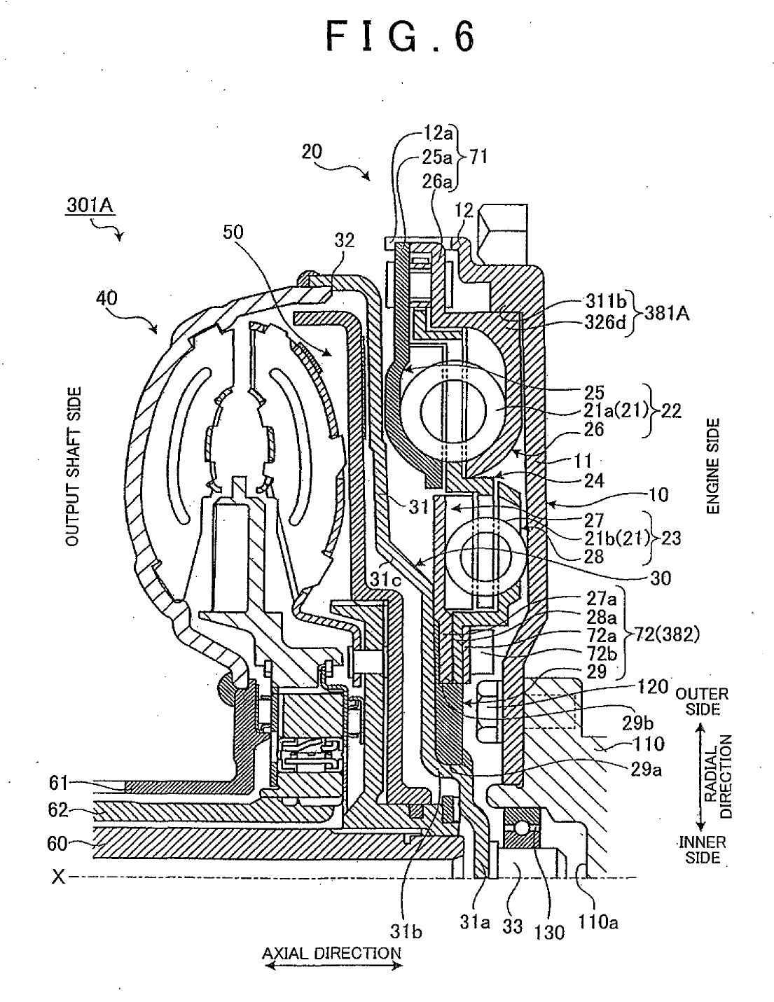

FIG. 6 is a cross-sectional view of a relevant portion of a torque converter according to a first modified example of the third embodiment.

As shown in FIG. 6, a torque converter 301A, which serves as the driving force transmission apparatus according to the first modified example of the third embodiment, includes an outer damper positioning portion 381A instead of the outer damper positioning portion 381 according to the third embodiment (see FIG. 5).

The outer damper positioning portion 381A includes a drive plate side inner lower portion 311b and an extended portion 326d.

As described above, the extended portion 326d is formed near the outer coupling protrusions 26a of the outer front support plate 26 so that the wall surface facing the drive plate body 11 extends toward the drive plate body 11 side.

The drive plate side inner lower portion 311b is provided at an inner corner portion at which the drive plate body 11 of the drive plate 10 intersects with the drive plate flange 12 of the drive plate 10. The drive plate side inner lower portion 311b is formed so that the wall surface of the drive plate body 11 facing the outer front support plate 26 extends toward the outer front support plate 26 at the inner corner portion at which the drive plate body 11 intersects with the drive plate flange 12. In other words, the drive plate side inner lower portion 311b is formed so that the inner peripheral surface of the drive plate flange 12 extends toward the radially inner side at the inner corner portion at which the drive plate body 11 intersects with the drive plate flange 12. The drive plate side inner lower portion 311b is formed in a cylindrical shape that is coaxial with the rotation axis X.

The outer damper positioning portion 381A is able to restrict relative movement of the outer damper 22 of the damper mechanism 20 with respect to the drive plate body 11 in the radial direction, and is also able to allow relative movement in the axial direction in such a manner that the extended portion 326d is inserted inside the drive plate side inner lower portion 311b, and the outer peripheral surface of the extended portion 326d contacts the inner peripheral surface of the drive plate side inner lower portion 311b. That is, the outer damper positioning portion 381A allows relative movement of the outer damper 22 of the damper mechanism 20 in the axial direction while making it possible to fix the relative positional relationship in the radial direction between the outer damper 22 of the damper mechanism 20 and the drive plate body 11. Thus, even when the outer damper positioning portion 381A is formed of the drive plate side inner lower portion 311b and the extended portion 326d, similar advantageous effects to those of the torque converter 301 according to the above described third embodiment (see FIG. 5) may be obtained.

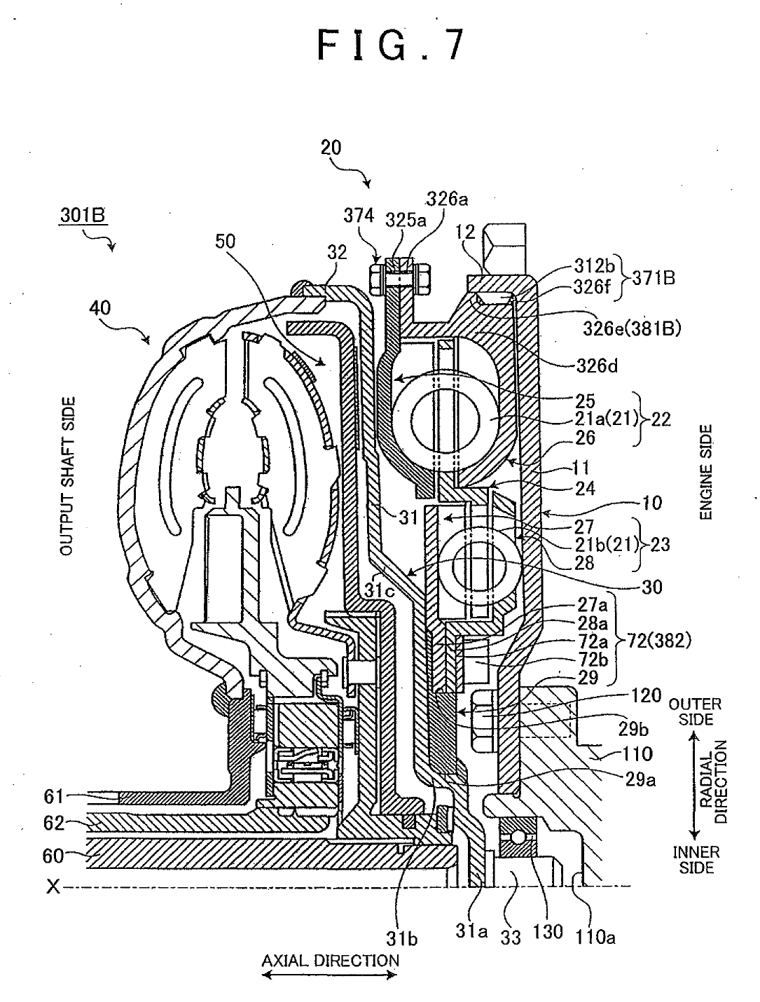

FIG. 7 is a cross-sectional view of a relevant portion of a torque converter according to a second modified example of the third embodiment.

As shown in FIG. 7, a torque converter 301B, which serves as the driving force transmission apparatus according to the second modified example of the third embodiment, includes an outer damper positioning portion 381B instead of the outer damper positioning portion 381 (see FIG. 5) or the outer damper positioning portion 381A as shown in FIG. 7.

The outer damper positioning portion 381B according to the present modified example of the third embodiment includes an outer damper side inner lower portion 326e. The outer damper side inner lower portion 326e is provided for the extended portion 326d.

The extended portion 326d is formed near the radially outer end 326a of the outer front support plate 26 so that the wall surface facing the drive plate body 11 extends toward the drive plate body 11. The outer damper side inner lower portion 326e is formed on a surface that radially faces the drive plate flange 12 in the extended portion 326d of the outer front support plate 26, that is, the outer peripheral surface of the extended portion 326d. The outer damper side inner lower portion 326e is formed so that the wall surface, facing the drive plate flange 12, of the extended portion 326d of the outer front support plate 26 radially extends toward the drive plate flange 12. The outer damper side inner lower portion 326e is formed in an annular shape that is coaxial with the rotation axis X.

The outer damper positioning portion 381B is able to restrict relative movement of the outer damper 22 of the damper mechanism 20 with respect to the drive plate body 11 in the radial direction, and is also able to allow relative movement in the axial direction in such a manner that the outer damper side inner lower portion 326e is inserted inside the drive plate flange 12, and the outer peripheral surface of the outer damper side inner lower portion 326e contacts the inner peripheral surface of the drive plate flange 12. That is, the outer damper positioning portion 381B allows relative movement of the outer damper 22 of the damper mechanism 20 in the axial direction while making it possible to fix the relative positional relationship in the radial direction between the outer damper 22 of the damper mechanism 20 and the drive plate body 11. Thus, even when the outer damper positioning portion 381B is formed of the outer damper side inner lower portion 326e, similar advantageous effects to those of the torque converter 301 according to the above described third embodiment (see FIG. 5) may be obtained.

Note that the configuration of a first coupling portion 371B of the torque converter 301B according to the second modified example of the third embodiment also differs from the configuration of the first coupling portion 71 (see FIG. 5) of the torque converter 301 (see FIG. 5) according to the third embodiment.

The first coupling portion 371B of the torque converter 301B includes a drive plate side spline 312b and an outer damper side spline 326f that serves as an outer coupling portion instead of the coupling cutouts 12a (see FIG. 5) and the outer coupling protrusions 25a and 26a (see FIG. 5).

The drive plate side spline 312b is formed as grooves in the axial direction on the inner peripheral surface of the drive plate flange 12. The drive plate side spline 312b has the plurality of axial grooves formed at predetermined intervals in the circumferential direction on the inner peripheral surface of the drive plate flange 12.

The outer damper side spline 326f, which serves as an outer coupling portion, is provided on a wall surface, facing the drive plate flange 12, of the extended portion 326d of the outer front support plate 26, that is, on the outer peripheral surface of the extended portion 326d. The outer damper side spline 326f is provided on the outer peripheral surface of the extended portion 326d at a location closer to the engine than the outer damper side inner lower portion 326e. The outer damper side spline 326f is formed as grooves in the axial direction on the outer peripheral surface of the extended portion 326d. The outer damper side spline 326f has the plurality of axial grooves formed at predetermined intervals in the circumferential direction on the outer peripheral surface of the extended portion 326d.

Thus, in the torque converter 301B, the drive plate side spline 312b is spline-fitted to the outer damper side spline 326f, so the drive plate side spline 312b of the drive plate flange 12, which is the radially outer portion of the drive plate 10, is coupled to the outer damper side spline 326f of the outer damper 22 at the first coupling portion 371B so as to be integrally rotatable and axially movable.

In addition, the torque converter 301B according to the second modified example of the third embodiment includes no rivet 73 (see FIG. 1), sleeve 73a (see FIG. 1), no slide portion 24e (see FIG. 1), or the like, but the radially outer end 325a of the outer rear support plate 25 is fastened to the radially outer end 326a of the outer front support plate 26 by a coupling device, such as bolts 374, instead, thus integrating the outer rear support plate 25 with the outer front support plate 26.

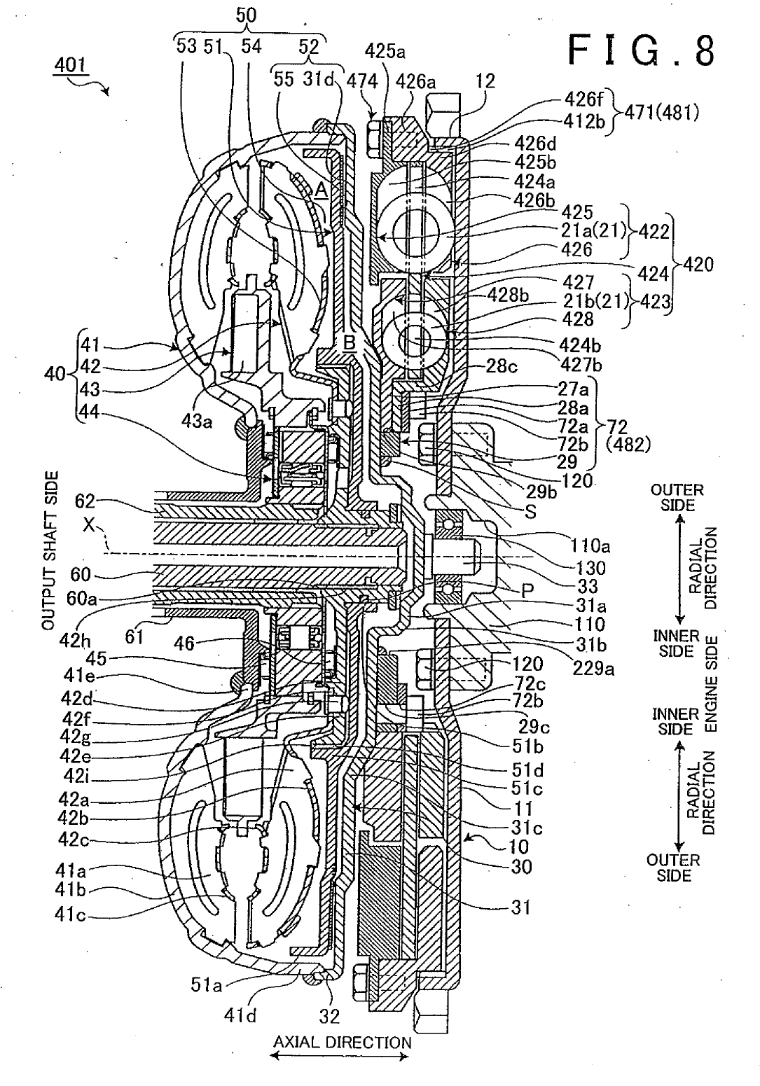

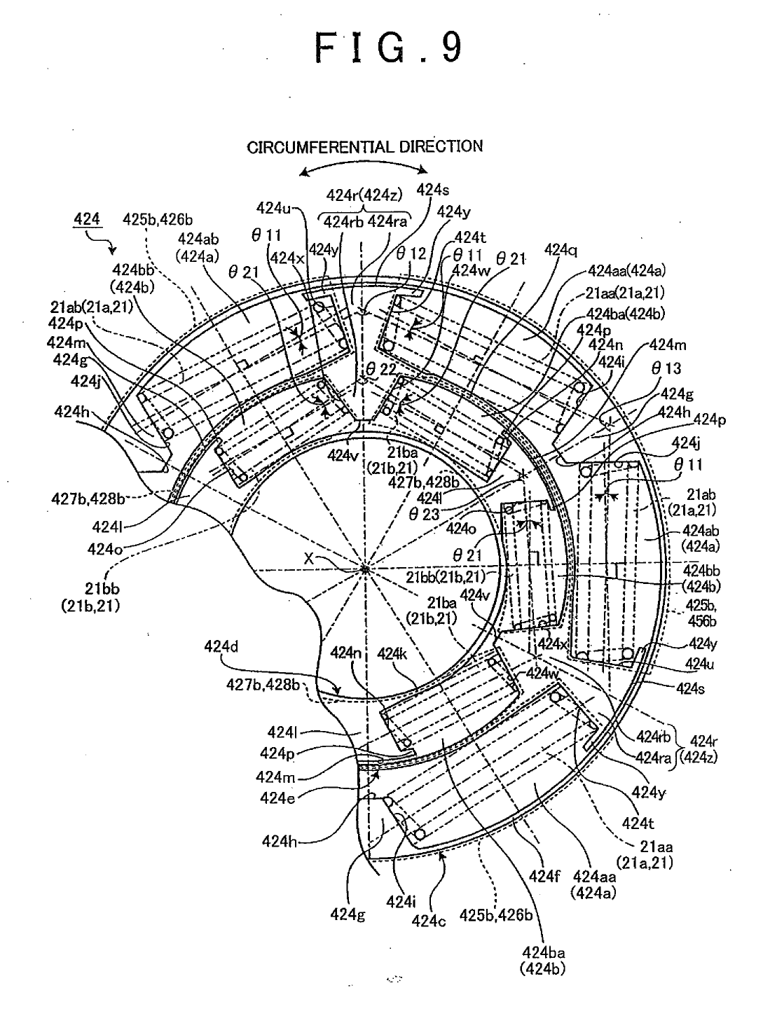

FIG. 8 is a cross-sectional view of a relevant portion of a torque converter according to a fourth embodiment of the invention. FIG. 9 is a partial plan view of a center support plate assembly of the torque converter according to the fourth embodiment of the invention. The driving force transmission apparatus according to the fourth embodiment has a substantially similar configuration to that of the driving force transmission apparatus according to the first embodiment; however, the configuration of the transmitting member differs from that of the driving force transmission apparatus according to the first embodiment. Other than that, the overlap description of the configuration, functions and advantageous effects that are the same as those of the above embodiments is omitted as much as possible, and like reference numerals denote substantially similar components to those of the above embodiments.

A torque converter 401, which serves as the driving force transmission apparatus according to the fourth embodiment, includes a damper mechanism 420 as a damper device, as shown in FIG. 8.

The damper mechanism 420 includes an outer damper 422, an inner damper 423, and a center support plate assembly 424. The center support plate assembly 424 serves as a transmitting member. The outer damper 422 is arranged at a radially outer side and is provided with the outer damper side spline 426f as an outer coupling portion. On the other hand, the inner damper 423 is arranged at a radially inner side and is provided with the inner coupling protrusions 27a and 28a as an inner coupling portion. The outer damper 422 is coupled to the inner damper 423 by the center support plate assembly 424.

The outer damper 422 includes an outer rear support plate 425, an outer front support plate 426, and the plurality of outer damper springs 21a. The outer rear support plate 425 and the outer front support plate 426 serve as an outer lateral support member. The outer damper springs 21a serve as the above described plurality of outer elastic bodies. The outer rear support plate 425 and the outer front support plate 426 are provided at axially lateral sides of the center support plate assembly 424. Here, the outer rear support plate 425 is provided at a front cover 30 side (output shaft side), and the outer front support plate 426 is provided at a drive plate 10 side (engine side).

As in the case of the torque converter 301B (see FIG. 7) according to the second modified example of the third embodiment, the outer rear support plate 425 and the outer front support plate 426 are integrated in such a manner that the radially outer end 425a of the outer rear support plate 425 is fastened to the radially outer end 426a of the outer front support plate 426 by a coupling device, such as bolts 474.

The outer rear support plate 425 has outer rear support portions 425b. The outer front support plate 426 has outer front support portions 426b.

The outer rear support portions 425b accommodate and support part of the outer damper springs 21a, here, part of the outer damper springs 21a adjacent to the output shaft, of which the center portions in the axial direction are supported by the center support plate assembly 424 so as to be able to transmit driving force. The outer front support portions 426b accommodate and support part of the outer damper springs 21a, here, part of the outer damper springs 21a adjacent to the engine, of which the center portions in the axial direction are supported by the center support plate assembly 424 so as to be able to transmit driving force.

Then, the outer front support plate 426 is provided with an outer damper side spline 426f, which serves as the above described outer coupling portion, at the extended portion 426d. The extended portion 426d is formed near the radially outer end 426a of the outer front support plate 426 so that the wall surface facing the drive plate body 11 extends toward the drive plate body 11. The outer damper side spline 426f together with the drive plate side spline 412b constitutes a first coupling portion 471.

The outer damper side spline 426f is provided on a wall surface, facing the drive plate flange 12, of the extended portion 426d of the outer front support plate 426, that is, on the outer peripheral surface of the extended portion 426d. The outer damper side spline 426f is formed as grooves in the axial direction on the outer peripheral surface of the extended portion 426d. The outer damper side spline 426f has the plurality of axial grooves formed at predetermined intervals in the circumferential direction on the outer peripheral surface of the extended portion 426d.

The drive plate side spline 412b is formed as grooves in the axial direction on the inner peripheral surface of the drive plate flange 12. The drive plate side spline 412b has the plurality of axial grooves formed at predetermined intervals in the circumferential direction on the inner peripheral surface of the drive plate flange 12.

Thus, in the torque converter 401, the drive plate side spline 412b is spline-fitted to the outer damper side spline 426f, so the drive plate side spline 412b of the drive plate flange 12, which is the radially outer portion of the drive plate 10, is coupled to the outer damper side spline 426f of the outer damper 22 at the first coupling portion 471 so as to be integrally rotatable and axially movable. In addition, the first coupling portion 471 also functions as an outer damper positioning portion 481 that radially positions the outer damper 422 of the damper mechanism 420 with respect to the crankshaft 110. The drive plate side spline 412b and the outer damper side spline 426f are respectively formed over the entire perimeter of the inner peripheral surface of the drive plate flange 12 and the entire perimeter of the outer peripheral surface of the extended portion 426d. Note that the first coupling portion 471 is not limited to spline fitting. For example, it is also applicable that coupling recesses provided on the inner peripheral surface of the drive plate flange 12 are engaged with coupling protrusions provided on the outer peripheral surface of the extended portion 426d to couple the radially outer portion of the drive plate 10 to the radially outer portion of the outer damper 422 so as to be integrally rotatable and axially movable. In this case, the plurality of coupling recesses provided on the inner peripheral surface of the drive plate flange 12 and the plurality of coupling protrusions provided on the outer peripheral surface of the extended portion 426d are provided in the circumferential direction.

The inner damper 423 includes an inner rear support plate 427, an inner front support plate 428 and the inner damper springs 21b. The inner rear support plate 427 and the inner front support plate 428 serve as an inner lateral support member. The inner damper springs 21b serve as the above described plurality of inner elastic bodies. The inner rear support plate 427 and the inner front support plate 428 are provided at axially lateral sides of the center support plate assembly 424. Here, the inner rear support plate 427 is provided at a front cover 30 side (output shaft side), and the inner front support plate 428 is provided at a drive plate 10 side (engine side).

The inner rear support plate 427 has inner rear support portions 427b. The inner front support plate 428 has inner front support portions 428b.

The inner rear support portions 427b accommodate and support part of the inner damper springs 21b, here, part of the inner damper springs 21b adjacent to the output shaft, of which the center portions in the axial direction are supported by the center support plate assembly 424 so as to be able to transmit driving force. The inner front support portions 428b accommodate and support part of the inner damper springs 21b, here, part of the inner damper springs 21b adjacent to the engine, of which the center portions in the axial direction are supported by the center support plate assembly 424 so as to be able to transmit driving force.

Then, the inner rear support plate 427 has the inner coupling protrusions 27a at the radially inner end (that is, end adjacent to the inner peripheral surface), while the inner front support plate 428 has the inner coupling protrusions 28a at the radially inner end (that is, end adjacent to the inner peripheral surface). The inner coupling protrusions 27a and 28a are fixed to the radially inner portion of the front cover 30 via the fastening plate 29, which serves as the highly rigid portion, so as to be integrally rotatable, that is, the inner coupling protrusions 27a and 28a are coupled to the radially inner portion of the front cover 30 so that the inner coupling protrusions 27a and 28a are axially immovable relative to the front cover 30. The inner coupling protrusions 27a and 28a constitute the second coupling portion 72 together with the fastening plate 29. In addition, the second coupling portion 72 also functions as an inner damper positioning portion 482 that radially positions the inner damper 423 of the damper mechanism 420 with respect to the crankshaft 110.

The center support plate assembly 424 supports the plurality of outer damper springs 21a and the plurality of inner damper springs 21b so as to be able to transmit driving force. The center support plate assembly 424 according to the present embodiment functions as a member that supports the outer damper springs 21a of the outer damper 422 and also functions as a member that supports the inner damper springs 21b of the inner damper 423. The center support plate assembly 424 is formed in an annular plate-like shape that is coaxial with the rotation axis X. The center support plate assembly 424 has outer center support portions 424a and inner center support portions 424b. Here, the center support plate assembly 424 has no step 24c (see FIG. 1), no step 24d (see FIG. 1), or the like, as described in the first embodiment. The center support plate assembly 424 is formed in a flat plate-like shape as a whole.

Here, as shown in FIG. 9, the center support plate assembly 424 according to the present embodiment includes an outer ring 424c, an inner ring 424d and a center ring 424e. The outer ring 424c, the inner ring 424d and the center ring 424e each are separately formed in an annular plate-like shape that is coaxial with the rotation axis X. The outer ring 424c, the center ring 424e and the inner ring 424d are arranged in the stated order from the radially outer side toward the radially inner side.

The center support plate assembly 424 according to the present embodiment serially couples the outer damper springs 21a to the inner damper springs 21b with respect to the transmission path of driving force in the damper mechanism 420. In addition, the center support plate assembly 424 serially couples the plurality of outer damper springs 21a, here, two outer damper springs 21a, and serially couples the plurality of inner damper springs 21b, here, two inner damper springs 21b. That is, the center support plate assembly 424 according to the present embodiment further serially couples the two outer damper springs 21a, serially coupled with respect to the transmission path of driving force, to the two inner damper springs 21a serially coupled with respect to the transmission path of driving force, that is, serially couples a set of four damper springs 21 in total, formed of two outer damper springs 21a and two inner damper springs 21b, with respect to the transmission path of driving force.

Specifically, the outer ring 424c couples the two outer damper springs 21a so as to be able to transmit driving force to each other. Here, in the following description, unless otherwise specified, one of the two outer damper springs 21a coupled by the outer ring 424c is referred to as “first outer damper spring 21aa” and the other one is referred to as “second outer damper spring 21ab”. Here, the outer ring 424c is provided with three sets of a pair of the first outer damper spring 21aa and second outer damper spring 21ab that are coupled so as to be able to transmit driving force to each other, that is, six (four of them are shown in the drawing) outer damper springs 21a are provided in total.

The outer ring 424c has an outer ring-shaped portion 424f and outer spring coupling portions 424g. The outer spring coupling portions 424g serve as outer elastic body coupling portions. The outer ring 424c couples the first outer damper springs 21aa to the second outer damper springs 21ab via the outer spring coupling portions 424g so as to be able to transmit driving force to each other, that is, serially couples the first outer damper springs 21aa to the second outer damper springs 21ab with respect to the transmission path of driving force in the damper mechanism 420.

The outer ring-shaped portion 424f is formed in an annular plate-like shape that is coaxial with the rotation axis X. The outer spring coupling portions 424g are formed so that part of the inner peripheral end of the outer ring-shaped portion 424f extends toward the radially inner side. The outer spring coupling portions 424g extend toward the rotation axis X. Each outer spring coupling portion 424g is formed so as to gradually narrow the width toward a distal end 424h at the radially inner side. Each first outer damper spring 21aa is arranged on a first circumferential end 424i side of the outer spring coupling portion 424g, which is one end in the circumferential direction, while each second outer damper spring 21ab is arranged on a second circumferential end 424j side of the outer spring coupling portion 424g, which is the other end in the circumferential direction. Three outer spring coupling portions 424g (three of them are shown in the drawing) are formed at equiangular positions in the circumferential direction with respect to the outer ring-shaped portion 424f.

The inner ring 424d couples two inner damper springs 21b so as to be able to transmit driving force to each other. Here, in the following description, unless otherwise specified, one of the two inner damper springs 21b coupled by the inner ring 424d is referred to as “first inner damper spring 21ba” and the other one is referred to as “second inner damper spring 21bb”. Here, the inner ring 424d is provided with three sets of a pair of the first inner damper spring 21ba and second inner damper spring 21bb that are coupled so as to be able to transmit driving force to each other, that is, six (four of them are shown in the drawing) inner damper springs 21b are provided in total.

The inner ring 424d has an inner ring-shaped portion 424k and inner spring coupling portions 424l. The inner spring coupling portions 424l serve as inner elastic body coupling portions. The inner ring 424d couples the first inner damper springs 21ba to the second inner damper springs 21bb via the inner spring coupling portions 424l so as to be able to transmit driving force to each other, that is, serially couples the first inner damper springs 21ba to the second inner damper springs 21bb with respect to the transmission path of driving force in the damper mechanism 420.

The inner ring-shaped portion 424k is formed in an annular plate-like shape that is coaxial with the rotation axis X. The diameter of the inner ring-shaped portion 424k is smaller than that of the outer ring-shaped portion 424f. The inner spring coupling portions 424l are formed so that part of the outer peripheral end of the inner ring-shaped portion 424k extends toward the radially outer side. The inner spring coupling portions 424l extend toward a side opposite to the rotation axis X. Each inner spring coupling portion 424l is formed so as to gradually widen the width toward a distal end 424m at the radially outer side. Each first inner damper spring 21ba is arranged on a first circumferential end 424n side of the inner spring coupling portion 424l, which is one end in the circumferential direction, while each second inner damper spring 21bb is arranged on a second circumferential end 424o side of the inner spring coupling portion 424l, which is the other end in the circumferential direction.

Furthermore, each inner spring coupling portion 424l is provided with inner lip portions 424p at the radially outer end, that is, both circumferential sides of a distal end 424m. Each inner lip portion 424p is a protrusion that is formed from the distal end 424m of the inner spring coupling portion 424l in the circumferential direction, and receives radial force component applied from the first inner damper spring 21ba or the second inner damper spring 21bb. Three inner spring coupling portions 424l (three of them are shown in the drawing) are formed at equiangular positions in the circumferential direction with respect to the inner ring-shaped portion 424k.

The center ring 424e is radially provided between the outer ring 424c and the inner ring 424d so that the center ring 424e is rotatable with respect to the outer ring 424c and the inner ring 424d. The center ring 424e couples the outer damper springs 21a to the inner damper springs 21b so as to be able to transmit driving force to each other.

The center ring 424e has a center ring-shaped portion 424q and driving force transmitting portions 424r. The center ring 424e couples the outer damper springs 21a to the inner damper springs 21b via the driving force transmitting portions 424r so as to be able to transmit driving force, that is, serially couples the inner damper springs 21b via the driving force transmitting portions 424r with respect to the transmission path of driving force in the damper mechanism 420.

The center ring-shaped portion 424q is formed in an annular plate-like shape that is coaxial with the rotation axis X. The diameter of the center ring-shaped portion 424q is smaller than that of the outer ring-shaped portion 424f and is larger than that of the inner ring-shaped portion 424k. Each driving force transmitting portion 424r is formed so that part of the outer peripheral end and part of the inner peripheral end of the center ring-shaped portion 424q respectively extend in the radial direction. That is, each driving force transmitting portion 424r has an outer transmitting portion 424ra and an inner transmitting portion 424rb.

Each outer transmitting portion 424ra is formed so that part of the outer peripheral end of the center ring-shaped portion 424q extends toward the radially outer side. Each outer transmitting portion 424ra extends toward a side opposite to the rotation axis X. Each outer transmitting portion 424ra is formed so as to gradually widen the width toward a distal end 424s at the radially outer side.

Each inner transmitting portion 424rb is formed so that part of the inner peripheral end of the center ring-shaped portion 424q, here, a portion at which the outer transmitting portion 424ra is provided, extends toward the radially inner side. Each inner transmitting portion 424rb extends toward the rotation axis X. Each inner transmitting portion 424rb is formed so as to gradually narrow the width toward a distal end 424v of the radially inner side.

The outer transmitting portion 424ra and the inner transmitting portion 424rb that constitute each driving force transmitting portion 424r are provided so that the center positions in the circumferential direction substantially coincide with each other. That is, each driving force transmitting portion 424r is formed in a shape such that the outer transmitting portion 424ra and the inner transmitting portion 424rb radially extend as one as a whole.

Three driving force transmitting portions 424r (two of them are shown in the drawing) are formed at equiangular positions in the circumferential direction with respect to the center ring-shaped portion 424q. Each driving force transmitting portion 424r is provided so that the single outer transmitting portion 424ra is located between the two outer spring coupling portions 424g that are adjacent in the circumferential direction of the outer ring 424c, and the single inner transmitting portion 424rb is located between the two inner spring coupling portions 424l that are adjacent in the circumferential direction of the inner ring 424d.

Note that each outer transmitting portion 424ra provides a predetermined clearance between the distal end 424s and the inner peripheral end of the outer ring-shaped portion 424f. In addition, each outer spring coupling portion 424g provides a predetermined clearance between the distal end 424h and the outer peripheral end of the center ring-shaped portion 424q. Furthermore, each inner transmitting portion 424rb provides a predetermined clearance between the distal end 424v and the outer peripheral end of the inner ring-shaped portion 424k. In addition, each inner spring coupling portion 424l provides a clearance between the distal end 424m and the inner peripheral end of the center ring-shaped portion 424q. By so doing, when the center ring 424e and the outer ring 424c or the inner ring 424d rotate relative to each other, it is possible to suppress occurrence of friction in accordance with rotation between the center ring 424e and the outer ring 424c or the inner ring 424d, thus making it possible to achieve smooth rotation.

Then, the first outer damper spring 21 aa is arranged on a first circumferential end 424t side of the each outer transmitting portion 424ra, which is one end in the circumferential direction, while the second outer damper spring 21ab is arranged on a second circumferential end 424u side, which is the other end in the circumferential direction. Here, each first circumferential end 424t is a circumferential end that faces the one first circumferential end 424i of the outer spring coupling portion 424g in the circumferential direction. In addition, each second circumferential end 424u is a circumferential end that faces the other second circumferential end 424j of the outer spring coupling portion 424g in the circumferential direction.

Furthermore, the first inner damper spring 21ba is arranged on a first circumferential end 424w side of the inner transmitting portion 424rb, which is one end in the circumferential direction, while the second inner damper spring 21bb is arranged on a second circumferential end 424x side of the inner transmitting portion 424rb, which is the other end in the circumferential direction. Here, each first circumferential end 424w is a circumferential end that faces one first circumferential end 424n of the inner spring coupling portion 424l in the circumferential direction. In addition, each second circumferential end 424x is a circumferential end that faces the other second circumferential end 424o of the inner spring coupling portion 424l in the circumferential direction.

Then, in the center support plate assembly 424, the outer ring-shaped portion 424f of the outer ring 424c, the center ring-shaped portion 424q of the center ring 424e, the outer spring coupling portions 424g and the outer transmitting portions 424ra of the driving force transmitting portions 424r form the outer center support portions 424a that accommodate and support the outer damper springs 21a.

More specifically, in the center support plate assembly 424, the inner peripheral end of the outer ring-shaped portion 424f, the outer peripheral end of the center ring-shaped portion 424q, the first circumferential ends 424i of the outer spring coupling portions 424g, and the first circumferential ends 424t of the outer transmitting portions 424ra form the first outer center support portions 424aa of the outer center support portions 424a that support the first outer damper springs 21aa. On the other hand, in the center support plate assembly 424, the inner peripheral end of the outer ring-shaped portion 424f, the outer peripheral end of the center ring-shaped portion 424q, the second circumferential ends 424j of the outer spring coupling portions 424g and the second circumferential ends 424u of the outer transmitting portions 424ra form the second outer center support portions 424ab of the outer center support portions 424a that support the second outer damper springs 21ab.

That is, the center support plate assembly 424 supports the first outer damper springs 21aa and the second outer damper springs 21ab, which are serially coupled by the outer spring coupling portions 424g, between the first circumferential ends 424t of the outer transmitting portions 424ra of the driving force transmitting portions 424r and the second circumferential ends 424u of the outer transmitting portions 424ra of the other driving force transmitting portions 424r that are adjacent in the circumferential direction.

Each first outer center support portion 424aa and each second outer center support portion 424ab are formed in a circular arc slit. Each first outer center support portion 424aa and each second outer center support portion 424ab respectively accommodate and support a corresponding one of the first outer damper springs 21aa and a corresponding one of the second outer damper springs 21ab. Each first outer center support portion 424aa at least has a circumferential length so that the first outer damper spring 21aa may be supported in an urged state. Each second outer center support portion 424ab at least has a circumferential length so that the second outer damper spring 21ab may be supported in an urged state. Thus, as each first outer damper spring 21aa and each second outer damper spring 21ab are respectively supported by a corresponding one of the first outer center support portions 424aa and a corresponding one of the second outer center support portions 424ab, the first circumferential ends 424i and 424t of each first outer center support portion 424aa are respectively in contact with both ends of a corresponding one of the first outer damper springs 21aa, and the second circumferential ends 424j and 424u of each second outer center support portion 424ab are respectively in contact with both ends of a corresponding one of the second outer damper springs 21ab. That is, each first outer damper spring 21aa is in contact with the first circumferential ends 424i and 424t of a corresponding one of the first outer center support portions 424aa, and is supported in an urged state between both ends thereof. Each second outer damper spring 21ab is in contact with the second circumferential ends 424j and 424u of a corresponding one of the second outer center support portions 424ab, and is supported in an urged state between both ends thereof.

As a result, the outer ring 424c of the center support plate assembly 424 is able to transmit driving force between the first outer damper springs 21aa and the second outer damper springs 21ab at a contact portion at which the first circumferential end 424i of each first outer center support portion 424aa (in other words, the first circumferential end 424i of each outer spring coupling portion 424g) is in contact with a corresponding one of the first outer damper springs 21aa and at a contact portion at which the second circumferential end 424j of each second outer center support portion 424ab (in other words, the second circumferential end 424j of each outer spring coupling portion 424g) is in contact with a corresponding one of the second outer damper springs 21ab. In addition, the center ring 424e of the center support plate assembly 424 is able to transmit driving force between the first outer damper springs 21aa and the second outer damper springs 21ab at a contact portion at which the first circumferential end 424t of each first outer center support portion 424aa (in other words, the first circumferential end 424t of the outer transmitting portion 424ra in each driving force transmitting portion 424r) is in contact with a corresponding one of the first outer damper springs 21aa and at a contact portion at which the second circumferential end 424u of each second outer center support portion 424ab (in other words, the second circumferential end 424u of the outer transmitting portion 424ra in the other driving force transmitting portion 424r adjacent in the circumferential direction) is in contact with a corresponding one of the second outer damper springs 21ab.

In addition, the circumferential length of each first outer center support portion 424aa and the circumferential length of each second outer center support portion 424ab vary as the outer transmitting portion 424ra and the outer spring coupling portion 424g of a corresponding one of the driving force transmitting portions 424r approach to or distance from each other in accordance with relative rotation between the center ring 424e and the outer ring 424c. At this time, each first outer damper spring 21aa is supported between the first circumferential ends 424i and 424t and elastically deforms, and each second outer damper spring 21ab is supported between the second circumferential ends 424j and 424u and elastically deforms.

Note that each outer transmitting portion 424ra has outer lip portions 424y at the radially outer end, that is, both circumferential sides of the distal end 424s. Each outer lip portion 424y is a protrusion that is formed from the distal end 424s of the outer transmitting portion 424ra in the circumferential direction, and receives radial force component applied from the first outer damper spring 21aa or the second outer damper spring 21ab.

Then, each outer rear support portion 425b of the outer rear support plate 425 and each outer front support portion 426b of the outer front support plate 426 both are formed in size at locations so as to axially face a corresponding one of the first outer center support portions 424aa and a corresponding one of the second outer center support portions 424ab of the center support plate assembly 424. Thus, each outer rear support portion 425b and each outer front support portion 426b collectively accommodate and support part of the pair of first outer damper spring 21aa and second outer damper spring 21ab of which the center portions in the axial direction are supported by the first outer center support portion 424aa and the second outer center support portion 424ab.

In a state where each pair of first outer damper spring 21aa and second outer damper spring 21ab is supported by a corresponding one of the first outer center support portions 424aa and a corresponding one of the second outer center support portions 424ab, one circumferential end of each outer rear support portion 425b and one circumferential end of each outer front support portion 426b circumferentially face and are contactable with one end of a corresponding one of the first outer damper springs 21aa, while the other circumferential ends thereof circumferentially face and are contactable with the other end of a corresponding one of the second outer damper springs 21ab. As a result, the outer rear support plate 425 and the outer front support plate 426 are able to transmit driving force to and from the first outer damper springs 21aa and the second outer damper springs 21ab at the contact portions of the circumferential ends at which the outer rear support portions 425b and the outer front support portions 426b are in contact with the first outer damper springs 21aa and the second outer damper springs 21ab.

Note that each first outer damper spring 21aa is provided so that the center line in the longitudinal direction of the spring (spring longitudinal center line) is inclined at a predetermined angle θ11 with respect to an imaginary line perpendicular to a straight line that passes through the center point at the rotation axis X and the center point of the first outer damper spring 21aa in the longitudinal direction. Each first outer damper spring 21aa is provided so that the first circumferential end 424t side of the spring longitudinal center line is inclined at the predetermined angle θ11 toward the radially inner side with respect to the imaginary line. In other words, each first outer center support portion 424aa is formed so as to be able to support a corresponding one of the first outer damper springs 21aa so that the first circumferential end 424t side of the spring longitudinal center line is inclined at the predetermined angle θ11 toward the radially inner side with respect to the imaginary line.

In addition, each second outer damper spring 21ab is provided so that the spring longitudinal center line is inclined at the predetermined angle θ11 with respect to an imaginary line perpendicular to a straight line that passes through the center point at the rotation axis X and the center point of the second outer damper spring 21ab in the longitudinal direction. Each second outer damper spring 21ab is provided so that the second circumferential end 424u side of the spring longitudinal center line is inclined at the predetermined angle θ11 toward the radially inner side with respect to the imaginary line. In other words, each second outer center support portion 424ab is formed so as to be able to support a corresponding one of the second outer damper springs 21ab so that the second circumferential end 424u side of the spring longitudinal center line is inclined toward the radially inner side with respect to the imaginary line.

That is, the outer ring 424c couples the first outer damper springs 21aa to the second outer damper springs 21ab so that the angle θ12 made at the radially inner side by intersection of the spring longitudinal center lines of the first outer damper spring 21aa and second outer damper spring 21ab that are adjacent in the circumferential direction via the outer transmitting portion 424ra of the driving force transmitting portion 424r is larger than the angle θ13 made at the radially inner side by intersection of the spring longitudinal center lines of the first outer damper spring 21aa and second outer damper spring 21ab that are adjacent in the circumferential direction via the outer spring coupling portion 424g. As a result, the radial length of each outer lip portion 424y is appropriately ensured, and then radial force component applied from the first outer damper springs 21aa and the second outer damper springs 21ab to the outer lip portions 424y may be reduced. Thus, it is possible to relatively shorten the radial length of each outer lip portion 424y by that much. By so doing, it is possible to reduce the size and weight of the center ring 424e. Thus, vibration reduction capability may be further improved, occurrence of muffled sound, or the like, may be further suppressed, and fuel economy may be further improved.

Similarly, in the center support plate assembly 424, the inner ring-shaped portion 424k of the inner ring 424d, the center ring-shaped portion 424q of the center ring 424e, the inner spring coupling portions 424l and the inner transmitting portions 424rb of the driving force transmitting portions 424r form the inner center support portions 424b that accommodate and support the inner damper springs 21b.

More specifically, in the center support plate assembly 424, the outer peripheral end of the inner ring-shaped portion 424k, the inner peripheral end of the center ring-shaped portion 424q, the first circumferential ends 424n of the inner spring coupling portions 424l, and the first circumferential ends 424w of the inner transmitting portions 424rb form first inner center support portions 424ba of the inner center support portions 424b that support the first inner damper springs 21ba. On the other hand, in the center support plate assembly 424, the outer peripheral end of the inner ring-shaped portion 424k, the inner peripheral end of the center ring-shaped portion 424q, the second circumferential ends 424o of the inner spring coupling portions 424l and the second circumferential ends 424x of the inner transmitting portions 424rb form second inner center support portions 424bb of the inner center support portions 424b that support the second inner damper springs 21bb.

That is, the center support plate assembly 424 supports the first inner damper springs 21ba and the second inner damper springs 21bb, which are serially coupled by the inner spring coupling portions 424l, between the first circumferential ends 424w of the inner transmitting portions 424rb of the driving force transmitting portions 424r and the second circumferential ends 424x of the inner transmitting portions 424rb in the other driving force transmitting portions 424r adjacent in the circumferential direction.

Each first inner center support portion 424ba and each second inner center support portion 424bb are formed in a circular arc slit. Each first inner center support portion 424ba and each second inner center support portion 424bb respectively accommodate and support a corresponding one of the first inner damper springs 21ba and a corresponding one of the second inner damper springs 21bb. Each first inner center support portion 424ba at least has a circumferential length so that the first inner damper spring 21ba may be supported in an urged state. Each second inner center support portion 424bb at least has a circumferential length so that the second inner damper spring 21bb may be supported in an urged state. Thus, as each first inner damper spring 21ba and each second inner damper spring 21bb are respectively supported by a corresponding one of the first inner center support portions 424ba and a corresponding one of the second inner center support portions 424bb, the first circumferential ends 424n and 424w of each first inner center support portion 424ba are respectively in contact with both ends of a corresponding one of the first inner damper springs 21ba, and the second circumferential ends 424o and 424x of each second inner center support portion 424bb are respectively in contact with both ends of a corresponding one of the second inner damper springs 21bb. That is, each first inner damper spring 21ba is in contact with the first circumferential ends 424n and 424w of a corresponding one of the first inner center support portions 424ba, and is supported in an urged state between both ends thereof. Each second inner damper spring 21bb is in contact with the second circumferential ends 424o and 424x of a corresponding one of the second inner center support portions 424bb, and is supported in an urged state between both ends thereof.

As a result, the inner ring 424d of the center support plate assembly 424 is able to transmit driving force between the first inner damper springs 21ba and the second inner damper springs 21bb at a contact portion at which the first circumferential end 424n of each first inner center support portion 424ba (in other words, the first circumferential end 424n of the inner spring coupling portion 424l) is in contact with a corresponding one of the first inner damper springs 21ba and at a contact portion at which the second circumferential end 424o of each second inner center support portion 424bb (in other words, the second circumferential end 424o of the inner spring coupling portion 424l) is in contact with a corresponding one of the second inner damper springs 21bb. In addition, the center ring 424e of the center support plate assembly 424 is able to transmit driving force at a contact portion at which the first circumferential end 424w of each first inner center support portion 424ba (in other words, the first circumferential end 424w of the inner transmitting portion 424rb in each driving force transmitting portion 424r) is in contact with a corresponding one of the first inner damper springs 21ba and at a contact portion at which the second circumferential end 424x of each second inner center support portion 424bb (in other words, the second circumferential end 424x of the inner transmitting portion 424rb in the other driving force transmitting portion 424r adjacent in the circumferential direction) is in contact with a corresponding one of the second inner damper springs 21bb.

In addition, the circumferential length of each first inner center support portion 424ba and the circumferential length of each second inner center support portion 424bb vary as the inner transmitting portion 424rb and the inner spring coupling portion 424l of a corresponding one of the driving force transmitting portions 424r approach to or distance from each other in accordance with relative rotation between the center ring 424e and the inner ring 424d. At this time, each first inner damper spring 21ba is supported between the first circumferential ends 424n and 424w and elastically deforms, and each second inner damper spring 21bb is supported between the second circumferential ends 424o and 424x and elastically deforms.

Then, each inner rear support portion 427b of the inner rear support plate 427 and each inner front support portion 428b of the inner front support plate 428 are formed in size at locations so as to axially face a corresponding one of the first inner center support portions 424ba and a corresponding one of the second inner center support portions 424bb of the center support plate assembly 424. Thus, each inner rear support portion 427b and each inner front support portion 428b collectively accommodate and support part of the pair of first inner damper spring 21ba and second inner damper spring 21bb of which the center portions in the axial direction are supported by the first inner center support portion 424ba and the second inner center support portion 424bb.

In a state where each pair of first inner damper spring 21ba and second inner damper spring 21bb is supported by a corresponding one of the first inner center support portions 424ba and a corresponding one of the second inner center support portions 424bb, one circumferential end of each inner rear support portion 427b and one circumferential end of each inner front support portion 428b circumferentially face and are contactable with one end of a corresponding one of the first inner damper springs 21ba, while the other circumferential ends thereof circumferentially face and are contactable with the other end of a corresponding one of the second inner damper springs 21bb. As a result, the inner rear support plate 427 and the inner front support plate 428 are able to transmit driving force to and from the first inner damper springs 21ba and the second inner damper springs 21bb at the contact portions of the circumferential ends at which the inner rear support portions 427b and the inner front support portions 428b are in contact with the first inner damper springs 21ba and the second inner damper springs 21bb.

Note that each first inner damper spring 21ba is provided so that the spring longitudinal center line is inclined at a predetermined angle θ21 with respect to an imaginary line perpendicular to a straight line that passes through the center point at the rotation axis X and the center point of the first inner damper spring 21ba in the longitudinal direction. Each first inner damper spring 21ba is provided so that the first circumferential end 424n side of the spring longitudinal center line is inclined at the predetermined angle θ21 toward the radially inner side with respect to the imaginary line. In other words, each first inner center support portion 424ba is formed so as to be able to support a corresponding one of the first inner damper springs 21ba so that the first circumferential end 424n side of the spring longitudinal center line is inclined at the predetermined angle θ21 toward the radially inner side with respect to the imaginary line.

In addition, each second inner damper spring 21bb is provided so that the spring longitudinal center line is inclined at the predetermined angle θ21 with respect to an imaginary line perpendicular to a straight line that passes through the center point at the rotation axis X and the center point of the second inner damper spring 21bb in the longitudinal direction. Each second inner damper spring 21bb is provided so that the second circumferential end 424o side of the spring longitudinal center line is inclined at the predetermined angle θ21 toward the radially inner side with respect to the imaginary line. In other words, each second inner center support portion 424bb is formed so as to be able to support a corresponding one of the second inner damper springs 21bb so that the second circumferential end 424o side of the spring longitudinal center line is inclined at the predetermined angle θ21 toward the radially inner side with respect to the imaginary line.

That is, the inner ring 424d couples the first inner damper springs 21ba to the second inner damper springs 21bb so that the angle θ23 made at the radially inner side by intersection of the spring longitudinal center lines of the first inner damper spring 21ba and second inner damper spring 21bb that are adjacent in the circumferential direction via the inner spring coupling portion 424 is larger than the angle θ22 made at the radially inner side by intersection of the spring longitudinal center lines of the first inner damper spring 21ba and second inner damper spring 21bb that are adjacent in the circumferential direction via the inner transmitting portion 424rb of the driving force transmitting portion 424r. As a result, the radial length of each inner lip portion 424p is appropriately ensured, and then radial force component applied from the first inner damper springs 21ba and the second inner damper springs 21bb to the inner lip portions 424p may be reduced. Thus, it is possible to relatively shorten the radial length of each inner lip portion 424p by that much. By so doing, it is possible to reduce the size and weight of the inner ring 424d. Thus, vibration reduction capability may be further improved, occurrence of muffled sound, or the like, may be further suppressed, and fuel economy may be further improved.

As shown in FIG. 8 and FIG. 9, the thus configured damper mechanism 420 transmits driving force, transmitted from the engine to the drive plate 10, from the drive plate side spline 412b of the drive plate flange 12, which is the radially outer portion of the drive plate 10, to the outer damper side spline 426f of the outer damper 422 at the first coupling portion 471, and then to the outer rear support plate 425 and the outer front support plate 426. Then, the damper mechanism 420 transmits the driving force, transmitted to the outer rear support plate 425 and outer front support plate 426 of the outer damper 422, from the circumferential ends of the outer rear support portions 425b and outer front support portions 426b to the outer damper springs 421a via one circumferential ends of the outer damper springs 21a of the outer damper 422.

Note that the following description will be made in a case where driving force is transmitted from the circumferential ends of each outer rear support portion 425b and each outer front support portion 426b to a corresponding one of the first outer damper springs 21aa via the circumferential end of the first outer damper spring 21aa adjacent to the first circumferential end 424t.

The damper mechanism 420 transmits the driving force, transmitted from the first circumferential end 424t side to each first outer damper spring 21aa, from the other circumferential end of each first outer damper spring 21aa to a corresponding one of the outer spring coupling portions 424g of the outer ring 424c via the first circumferential end 424i. The damper mechanism 420 transmits the driving force, transmitted to each outer spring coupling portion 424g, from the second circumferential end 424j to a corresponding one of the second outer damper springs 21ab via one circumferential end of the second outer damper spring 21ab.

The damper mechanism 420 transmits the driving force, transmitted to each second outer damper spring 21ab, from the other circumferential end of the second outer damper spring 21ab to the outer transmitting portion 424ra at a corresponding one of the driving force transmitting portions 424r of the center ring 424e via the second circumferential end 424u.

The damper mechanism 420 transmits the driving force, transmitted to the outer transmitting portion 424ra of each driving force transmitting portion 424r, from the first circumferential end 424w of the inner transmitting portion 424rb at each driving force transmitting portion 424r to a corresponding one of the first inner damper springs 21ba via one circumferential end of each first inner damper spring 21ba.

The damper mechanism 420 transmits the driving force, transmitted to each first inner damper spring 21ba, from the other circumferential end of each first inner damper spring 21ba to a corresponding one of the inner spring coupling portions 424l of the inner ring 424d via the first circumferential end 424n. The damper mechanism 420 transmits the driving force, transmitted to each inner spring coupling portion 424l, from the second circumferential end 424o to a corresponding one of the second inner damper springs 21bb via one circumferential end of the second inner damper spring 21bb.

Then, the damper mechanism 420 transmits the driving force, transmitted to each second inner damper spring 21bb, from the circumferential end of each second inner damper spring 21bb adjacent to the second circumferential end 424x to the inner rear support plate 427 and inner front support plate 428 of the inner damper 423 via the circumferential ends of each inner rear support portion 427b and each inner front support portion 428b. Then, the damper mechanism 420 transmits the driving force, transmitted to the inner rear support plate 427 and the inner front support plate 428, from the inner coupling protrusions 27a and 28a to the fastening plate 29 at the second coupling portion 72 and then to the radially inner portion of the front cover 30. Thus, the driving force transmitted from the engine to the drive plate 10 is transmitted by the damper mechanism 420 via the first outer damper springs 21aa and second outer damper springs 21ab of the outer damper 422 and the first inner damper springs 21ba and second inner damper springs 21bb of the inner damper 423 in the stated order, and the front cover 30 rotates in the same direction as the drive plate 10.

During then, each first outer damper spring 21aa is supported between the circumferential ends of a corresponding one of the outer rear support portions 425b and corresponding one of the outer front support portions 426b and a corresponding one of the first circumferential ends 424i, and elastically deforms. Each second outer damper spring 21ab is supported between the second circumferential end 424j and 424u, and elastically deforms. Each first inner damper spring 21ba is supported between the first circumferential end 424w and 424n, and elastically deforms. Each second inner damper spring 21bb is supported between the second circumferential end 424o and the circumferential ends of a corresponding one of the inner rear support portions 427b and corresponding one of the inner front support portions 428b, and elastically deforms.

Note that, when the driving force is transmitted from the circumferential ends of each outer rear support portion 425b and each outer front support portion 426b to a corresponding one of the second outer damper springs 21ab via the circumferential end of the second outer damper spring 21ab adjacent to the second circumferential end 424u, the driving force, transmitted from the engine to the drive plate 10, is transmitted by the damper mechanism 420 via each second outer damper spring 21ab and each first outer damper spring 21aa of the outer damper 422 and each second inner damper spring 21bb and each first inner damper spring 21ba of the inner damper 423 sequentially, and then the front cover 30 rotates in the same direction as the drive plate 10.

During then, each second outer damper spring 21ab is supported between the circumferential ends of a corresponding one of the outer rear support portions 425b and corresponding one of the outer front support portions 426b and a corresponding one of the second circumferential ends 424j, and elastically deforms. Each first outer damper spring 21aa is supported between the first circumferential ends 424i and 424t, and elastically deforms. Each second inner damper spring 21bb is supported between the second circumferential ends 424x and 424o, and elastically deforms. Each first inner damper spring 21ba is supported between the first circumferential end 424n and the circumferential ends of a corresponding one of the inner rear support portions 427b and corresponding one of the inner front support portions 428b, and elastically deforms.

Thus, in the torque converter 401 according to the present embodiment, when driving force is transmitted from the radially outer portion of the drive plate 10 to the radially inner portion of the front cover 30, the driving force transmitted to the drive plate 10 is transmitted to the front cover 30 via the first outer damper springs 21aa and second outer damper springs 21ab of the outer damper 422 and the first inner damper springs 21ba and second inner damper springs 21bb of the inner damper 423 serially with respect to the transmission path of the driving force. Thus, it is possible to increase the energy that can be stored in the outer damper springs 21a and inner damper springs 21b of the damper mechanism 420, and it is possible to further improve vibration reduction characteristic, such as prevention of muffled sound in the damper mechanism 20, that is, damper performance.

Here, in the center ring 424e, the driving force transmitting portions 42r that transmit driving force between the second outer damper springs 21ab and the first inner damper springs 21ba or between the first outer damper springs 21aa and the second inner damper springs 21bb also function as application point adjacent portions 424z.

That is, as described above, the driving force transmitting portions 424r that function as the application point adjacent portions 424z are provided so that the center position of the outer transmitting portion 424ra substantially coincides with the center position of the inner transmitting portion 424rb in the circumferential direction, and the outer transmitting portion 424ra and the inner transmitting portion 424rb radially extend as one as a whole.

Then, when the center support plate assembly 424 transmits driving force between the second outer damper springs 21ab and the first inner damper springs 21ba, each second outer damper spring 21ab contacts the second circumferential end 424u of a corresponding one of the driving force transmitting portions 424r, and each first inner damper spring 21ba contacts the first circumferential end 424w of a corresponding one of the driving force transmitting portions 424r. In addition, when the center support plate assembly 424 transmits driving force between the first outer damper springs 21aa and the second inner damper springs 21bb, each first outer damper spring 21aa contacts the first circumferential end 424t of a corresponding one of the driving force transmitting portions 424r, and each second inner damper spring 21bb contacts the second circumferential end 424x of a corresponding one of the driving force transmitting portions 424r.

That is, when the center support plate assembly 424 transmits driving force between the second outer damper springs 21ab and the first inner damper springs 21ba or between the first outer damper springs 21aa and the second inner damper springs 21bb, the application point to which force is applied from the first outer damper spring 21aa or the second outer damper spring 21ab is located adjacent to the application point to which force is applied from the first inner damper spring 21ba or the second inner damper spring 21bb in the circumferential direction at each driving force transmitting portion 424r that radially extends and that functions as the application point adjacent portion 424z. That is, the outer transmitting portion 424ra and the inner transmitting portion 424rb are arranged so that the center positions in the circumferential direction substantially coincide with each other and overlap in the radial direction. Thus, the application point to which force is applied from the first outer damper spring 21aa or the second outer damper spring 21ab is located adjacent to the application point to which force is applied from the first inner damper spring 21ba or the second inner damper spring 21bb in the circumferential direction at each driving force transmitting portion 424r that functions as the application point adjacent portion 424z.

As a result, the application point to which force is applied from the first outer damper spring 21aa or the second outer damper spring 21ab is located adjacent to the application point to which force is applied from the first inner damper spring 21ba or the second inner damper spring 21bb in the circumferential direction as much as possible at each driving force transmitting portion 424r that functions as the application point adjacent portion 424z. Thus, it is possible to shorten the circumferential length of each driving force transmitting portion 424r of the center ring 424e, at which driving force is transmitted, as much as possible. Then, in the center ring 424e, the center ring-shaped portion 424q that does not transmit driving force may be formed so that the radial thickness may be reduced to a thickness that can ensure the strength that withstands centrifugal force. That is, the circumferential length of each driving force transmitting portion 424r may be reduced as much as possible, so the radial thickness of each driving force transmitting portion 424r of the center ring 424e, at which driving force is transmitted, is relatively increased to ensure sufficient strength, and then it is possible to widen the area of the center ring-shaped portion 424q of which the radial thickness may be reduced. As a result, the rigidity of each driving force transmitting portion 424r of the center ring 424e, which transmits driving force, is sufficiently ensured, and then it is possible to reduce the weight of the center ring 424e.

With the torque converter 401 according to the above described embodiment of the invention, sufficient rigidity is ensured by the fastening plate 29 at the second coupling portion 72 between the radially inner side inner coupling protrusions 27a and 28a of the damper mechanism 420 and the radially inner portion of the front cover 30, while the damper mechanism 420 is axially movable at the first coupling portion 71 between the radially outer side outer damper side spline 426f and the drive plate side spline 412b of the drive plate flange 12 of the drive plate 10. Therefore, the damper mechanism 420 as a whole deforms to move substantially parallel to the axial direction. Hence, it is possible to reduce deformation that deteriorates damper performance, and it is possible to improve vibration reduction capability while suppressing an increase in size.

Furthermore, with the torque converter 401 according to the above described embodiment of the invention, the outer damper 422 is arranged at the radially outer side and the inner damper 423 is arranged at the radially inner side in the damper mechanism 420, and driving force transmitted to the drive plate 10 is radially transmitted serially from the outer damper side spline 426f to the inner coupling protrusions 27a and 28a via the outer damper springs 21a, the center support plate assembly 424 and the inner damper springs 21b in the stated order. Thus, it is possible to further improve vibration reduction capability. In addition, the damper mechanism 420 as a whole deforms to move substantially parallel to the axial direction, so it is possible to reduce deformation that deteriorates damper performance. As a result, the damper mechanism 420 radially transmits driving force from the outer damper side spline 426f to the inner coupling protrusions 27a and 28a via the outer damper springs 21a and the inner damper springs 21b serially in the stated order. Thus, the size of the apparatus is further reduced and vibration reduction capability is further improved, and then friction in the damper mechanism 420 due to deformation may be reduced. Hence, it is possible to further improve damper performance, such as prevention of muffled sound, in the damper mechanism 420.

Furthermore, with the torque converter 401 according to the above described embodiment of the invention, the center support plate assembly 424 has the driving force transmitting portions 424r that function as the application point adjacent portions 424z formed in the radial direction, and, when driving force is transmitted, each outer damper spring 21a contacts one circumferential end of a corresponding one of the driving force transmitting portions 424r, and each inner damper spring 21b contacts the other circumferential end of a corresponding one of the driving force transmitting portions 424r. Thus, in each driving force transmitting portion 424r that functions as the application point adjacent portion 424z, the application point to which force is applied from the outer damper spring 21a may be located adjacent to the application point to which force is applied from the inner damper spring 21b in the circumferential direction as much as possible. Hence, it is possible to reduce the circumferential length of each driving force transmitting portion 424r as much as possible. As a result, the rigidity of each driving force transmitting portion 424r of the center support plate assembly 424, which transmits driving force, is sufficiently ensured, and then the area of the other portion that does not transmit driving force may be widened to reduce the weight of the center support plate assembly 424. Thus, vibration reduction capability may be further improved, occurrence of muffled sound, or the like, may be further suppressed, and fuel economy may be further improved.

Furthermore, with the torque converter 401 according to the above described embodiment of the invention, the center support plate assembly 424 includes the outer ring 424c, the inner ring 424d and the center ring 424e. The outer ring 424c couples at least two outer damper springs 21a to each other via the outer spring coupling portion 424g so as to be able to transmit driving force. The inner ring 424d is provided on the radially inner side of the outer ring 424c, and couples at least two inner damper springs 21b to each other via the inner spring coupling portion 424l so as to be able to transmit driving force. The center ring 424e is radially provided between the outer ring 424c and the inner ring 424d so as to be rotatable relative to the outer ring 424c and the inner ring 424d, and couples the outer damper springs 21a to the inner damper springs 21b so as to be able to transmit driving force therebetween via the driving force transmitting portions 424r.

Thus, the center support plate assembly 424 serially couples at least two outer damper springs 21a, serially coupled by the outer ring 424c via the outer spring coupling portion 424g, to at least two inner damper springs 21b, serially coupled by the inner ring 424d via the inner spring coupling portion 424l, by the center ring 424e via the driving force transmitting portion 424r with respect to the transmission path of driving force in the damper mechanism 420. Hence, the center support plate assembly 424 is able to serially couple at least two outer damper springs 21a and two inner damper springs 21b, that is, a set of four damper springs 21 in total, with respect to the transmission path of driving force. As a result, because the vibration reduction capability may be further improved, it is possible to further suppress occurrence of muffled sound, or the like. In addition, it is possible to extend the rotational speed range in which the lock-up clutch mechanism 50 may be engaged, so the lock-up clutch mechanism 50 may be engaged in a relatively low rotational speed range. Thus, it is possible to further improve fuel economy.

Furthermore, with the torque converter 401 according to the above described embodiment of the invention, the center ring 424e has the outer lip portions 424y, which receive radial force component applied from the outer damper springs 21a, at the distal ends 424s that are the radially outer ends of the driving force transmitting portions 424r, the outer ring 424c couples the outer damper springs 21a so that the angle θ12 made at the radially inner side by intersection of the spring longitudinal center lines of the outer damper springs 21a that are adjacent in the circumferential direction via the driving force transmitting portion 424r is larger than the angle θ13 made at the radially inner side by intersection of the spring longitudinal center lines of the outer damper springs 21a that are adjacent in the circumferential direction via the outer spring coupling portion 424g, and the inner ring 424d has the inner lip portions 424p, which receive radial force component applied from the inner damper springs 21b, at the distal ends 424m that are the radially outer ends of the inner spring coupling portions 424l and couples the inner damper springs 21b so that the angle θ23 made at the radially inner side by intersection of the spring longitudinal center lines of the inner damper springs 21b that are adjacent in the circumferential direction via the inner spring coupling portion 424l is larger than the angle θ22 made at the radially inner side by intersection of the spring longitudinal center lines of the inner damper springs 21b that are adjacent in the circumferential direction via the driving force transmitting portion 424r.

Thus, the radial length of each outer lip portion 424y and the radial length of each inner lip portion 424p are appropriately ensured, and then radial force components applied from the outer damper springs 21a and the inner damper springs 21b to the outer lip portions 424y and the inner lip portions 424p may be reduced. Hence, it is possible to relatively shorten the radial length of each outer lip portion 424y and the radial length of each inner lip portion 424p by that much. By so doing, it is possible to reduce the size and weight of the center support plate assembly 424. Thus, vibration reduction capability may be further improved, occurrence of muffled sound, or the like, may be further suppressed, and fuel economy may be further improved.

Note that the driving force transmission apparatus according to the aspect of the invention is not limited to the above described embodiments; it may be modified into various forms within the scope of the appended claims. The driving force transmission apparatus according to the aspect of the invention may be formed of a combination of a plurality of the above described embodiments. For example, the application point adjacent portion according to the aspect of the invention may be provided for the transmitting member according to any one of the first through third embodiments.

In the above description, in the damper device, the inner coupling portions are fixedly coupled via the highly rigid portion, and the outer coupling portions are coupled axially movably along the rotation axis. Instead, it is also applicable that the outer coupling portions are fixedly coupled via the highly rigid portion, and the inner coupling portions are coupled axially movably along the rotation axis.

In the above description, the damper device is configured so that the outer elastic bodies of the outer damper and the inner elastic bodies of the inner damper are serially arranged with respect to the transmission path of driving force; however, the configuration is not limited to it. It is also applicable that the outer elastic bodies of the outer damper and the inner elastic bodies of the inner damper are arranged parallel to the transmission path of driving force.

In the above description, as described above, each driving force transmitting portion 424r is provided so that the center position of the outer transmitting portion 424ra substantially coincides with the center position of the inner transmitting portion 424rb in the circumferential direction, and the outer transmitting portion 424ra and the inner transmitting portion 424rb radially extend as one as a whole; however, the configuration is not limited to this. Each driving force transmitting portion 424r may be, for example, formed so that the center position of the outer transmitting portion 424ra with respect to the circumferential direction is deviated from the center position of the inner transmitting portion 424rb with respect to the circumferential direction. In this case, in the center ring-shaped portion 424q, the radial thickness of a portion at which driving force is transmitted between the outer transmitting portion 424ra and the inner transmitting portion 424rb is increased.

In the above description, in the lock-up device, the frictional engagement surfaces are formed of the friction material 55 provided for the lock-up piston 51 as the engagement member and the front cover inner wall surface 31d of the front cover 30 as the second member. Instead, it is also applicable that the friction material 55 is provided on the front cover inner wall surface 31d, and then the frictional engagement surfaces are formed of a wall surface of the lock-up piston 51 that axially faces the friction material 55 and the friction material 55.

As described above, the driving force transmission apparatus according to the aspect of the invention is able to improve vibration reduction capability, and is suitably applied to various driving force transmission apparatus provided with a damper device.

1. A driving force transmission apparatus comprising:
a damper device that includes
a plurality of elastic bodies that are provided between a first member, to which driving force is transmitted from a driving source, and a second member that transmits the driving force to a fluid transmission device;
an outer coupling portion that is integrally rotatably coupled to a radially outer portion of the first member; and
an inner coupling portion that is integrally rotatably coupled to a radially inner portion of the second member, wherein
the damper device transmits the driving force, transmitted to the first member, from the outer coupling portion to the inner coupling portion via the plurality of elastic bodies and then to the second member, and
one of the outer coupling portion and the inner coupling portion of the damper device is fixedly coupled via a highly rigid portion, and the other one of the outer coupling portion and the inner coupling portion is coupled axially movably along a rotation axis.

2. The driving force transmission apparatus according to claim 1, wherein
the inner coupling portion of the damper device is fixedly coupled via the highly rigid portion, and the outer coupling portion of the damper device is coupled axially movably along the rotation axis.

3. The driving force transmission apparatus according to claim 1, wherein
the plurality of elastic bodies include a plurality of outer elastic bodies and a plurality of inner elastic bodies that are provided on a radially inner side of the plurality of outer elastic bodies and that are coupled to the outer elastic bodies via a transmitting member, wherein the plurality of outer elastic bodies constitute an outer damper and the plurality of inner elastic bodies constitute an inner damper, and
the damper device transmits the driving force, transmitted to the first member, from the outer coupling portion of the outer damper to the plurality of outer elastic bodies, transmits the driving force, transmitted to the plurality of outer elastic bodies, to the plurality of inner elastic bodies via the transmitting member and transmits the driving force, transmitted to the plurality of inner elastic bodies, to the inner coupling portion of the inner damper and then to the second member.

4. A driving force transmission apparatus comprising:
a first member to which driving force is transmitted from a driving source;
a damper device that includes an outer damper that has a plurality of outer elastic bodies and a radially outer side outer coupling portion coupled to a radially outer portion of the first member, an inner damper that has a plurality of inner elastic bodies provided on a radially inner side of the plurality of outer elastic bodies, and a transmitting member that couples the outer elastic bodies to the inner elastic bodies;
a second member that has a radially inner portion coupled to an inner coupling portion provided at a radially inner side of the inner damper and that transmits the driving force to a fluid transmission device;
a first coupling portion that couples the radially outer portion of the first member to the outer coupling portion of the outer damper so that the radially outer portion of the first member and the outer coupling portion of the outer damper are integrally rotatable and axially movable with respect to each other along a rotation axis; and
a second coupling portion that fixedly couples the radially inner portion of the second member to the inner coupling portion of the inner damper via a highly rigid portion so that the radially inner portion of the second member and the inner coupling portion of the inner damper are integrally rotatable.

5. A driving force transmission apparatus comprising:
a damper device that transmits driving force, transmitted to an outer coupling portion of an outer damper provided at a radially outer side, to a plurality of outer elastic bodies of the outer damper, that transmits the driving force, transmitted to the plurality of outer elastic bodies, to a plurality of inner elastic bodies of an inner damper provided on a radially inner side of the outer elastic bodies via a transmitting member and that transmits the driving force, transmitted to the plurality of inner elastic bodies, to an inner coupling portion of the inner damper;
a first coupling portion that couples a radially outer portion of a first member, to which the driving force is transmitted from a driving source, to the outer coupling portion of the outer damper so that the radially outer portion of the first member and the outer coupling portion of the outer damper are able to transmit the driving force therebetween and are axially movable with respect to each other along a rotation axis; and
a second coupling portion that fixedly couples a radially inner portion of a second member, which transmits the driving force to a fluid transmission device, to the inner coupling portion of the inner damper via a highly rigid portion so that the radially inner portion of the second member and the inner coupling portion of the inner damper are able to transmit the driving force therebetween.

6. The driving force transmission apparatus according to claim 5, wherein
the transmitting member has an application point adjacent portion that is formed in a radial direction, and, when the transmitting member transmits the driving force, each of the outer elastic bodies contacts one circumferential end of the application point adjacent portion and each of the inner elastic bodies contacts the other circumferential end of the application point adjacent portion.

7. The driving force transmission apparatus according to claim 5, wherein
the damper device includes
an outer center support member that supports the outer elastic bodies so as to be able to transmit driving force and that has the outer coupling portion at a radially outer end thereof;
the transmitting member that supports the outer elastic bodies on an axially lateral side of the outer center support member so as to be able to transmit driving force and that supports the inner elastic bodies so as to be able to transmit driving force; and
an inner lateral support member that supports the inner elastic bodies on an axially lateral side of the transmitting member so as to be able to transmit driving force and that has the inner coupling portion at a radially inner end thereof.

8. The driving force transmission apparatus according to claim 5, wherein
the damper device includes
the transmitting member that supports the outer elastic bodies and the inner elastic bodies so as to be able to transmit driving force;
an outer lateral support member that supports the outer elastic bodies on an axially lateral side of the transmitting member so as to be able to transmit driving force and that has the outer coupling portion at a radially outer end thereof; and
an inner lateral support member that supports the inner elastic bodies on an axially lateral side of the transmitting member so as to be able to transmit driving force and that has the inner coupling portion at a radially inner end thereof.

9. The driving force transmission apparatus according to claim 8, wherein
the transmitting member includes
an outer ring that couples at least two outer elastic bodies via an outer elastic body coupling portion so that the at least two outer elastic bodies are able to transmit driving force to each other;
an inner ring that is provided on a radially inner side of the outer ring and that couples at least two inner elastic bodies via an inner elastic body coupling portion so that the at least two inner elastic bodies are able to transmit driving force to each other; and
a center ring that is radially provided between the outer ring and the inner ring so as to be rotatable with respect to the outer ring and the inner ring and that couples the outer elastic bodies to the inner elastic bodies via a driving force transmitting portion so that the outer elastic bodies and the inner elastic bodies are able to transmit driving force to each other.

10. The driving force transmission apparatus according to claim 9, wherein
the center ring has an outer lip portion, which receives radial force component applied from a corresponding one of the outer elastic bodies, at a radially outer end of the driving force transmitting portion,
the outer ring couples the outer elastic bodies so that an angle made at a radially inner side by intersection of center lines of the outer elastic bodies that are adjacent in a circumferential direction via the driving force transmitting portion is larger than an angle made at a radially inner side by intersection of center lines of the outer elastic bodies that are adjacent in the circumferential direction via the outer elastic body coupling portion, and
the inner ring has an inner lip portion, which receives radial force component applied from a corresponding one of the inner elastic bodies, at a radially outer end of the inner elastic body coupling portion, and couples the inner elastic bodies so that an angle made at a radially inner side by intersection of center lines of the inner elastic bodies that are adjacent in the circumferential direction via the inner elastic body coupling portion is larger than an angle made at a radially inner side by intersection of center lines of the inner elastic bodies that are adjacent in the circumferential direction via the driving force transmitting portion.

11. The driving force transmission apparatus according to claim 5, wherein
the first member is provided with an outer damper positioning portion fixed to a driving source output shaft that outputs the driving force from the driving source and that radially positions the outer damper, and
the second member is provided with an inner damper positioning portion that is rotatably supported by the driving source output shaft via a bearing so as to be coaxial with the driving source output shaft and that radially positions the inner damper.

12. The driving force transmission apparatus according to claim 3, wherein
the transmitting member has an application point adjacent portion that is formed in a radial direction, and, when the transmitting member transmits the driving force, each of the outer elastic bodies contacts one circumferential end of the application point adjacent portion and each of the inner elastic bodies contacts the other circumferential end of the application point adjacent portion.

13. The driving force transmission apparatus according to claim 3, wherein
the damper device includes
an outer center support member that supports the outer elastic bodies so as to be able to transmit driving force and that has the outer coupling portion at a radially outer end thereof;
the transmitting member that supports the outer elastic bodies on an axially lateral side of the outer center support member so as to be able to transmit driving force and that supports the inner elastic bodies so as to be able to transmit driving force; and
an inner lateral support member that supports the inner elastic bodies on an axially lateral side of the transmitting member so as to be able to transmit driving force and that has the inner coupling portion at a radially inner end thereof.

14. The driving force transmission apparatus according to claim 3, wherein
the damper device includes
the transmitting member that supports the outer elastic bodies and the inner elastic bodies so as to be able to transmit driving force;
an outer lateral support member that supports the outer elastic bodies on an axially lateral side of the transmitting member so as to be able to transmit driving force and that has the outer coupling portion at a radially outer end thereof; and
an inner lateral support member that supports the inner elastic bodies on an axially lateral side of the transmitting member so as to be able to transmit driving force and that has the inner coupling portion at a radially inner end thereof.

15. The driving force transmission apparatus according to claim 14, wherein
the transmitting member includes
an outer ring that couples at least two outer elastic bodies via an outer elastic body coupling portion so that the at least two outer elastic bodies are able to transmit driving force to each other;
an inner ring that is provided on a radially inner side of the outer ring and that couples at least two inner elastic bodies via an inner elastic body coupling portion so that the at least two inner elastic bodies are able to transmit driving force to each other; and
a center ring that is radially provided between the outer ring and the inner ring so as to be rotatable with respect to the outer ring and the inner ring and that couples the outer elastic bodies to the inner elastic bodies via a driving force transmitting portion so that the outer elastic bodies and the inner elastic bodies are able to transmit driving force to each other.

16. The driving force transmission apparatus according to claim 15, wherein
the center ring has an outer lip portion, which receives radial force component applied from a corresponding one of the outer elastic bodies, at a radially outer end of the driving force transmitting portion,
the outer ring couples the outer elastic bodies so that an angle made at a radially inner side by intersection of center lines of the outer elastic bodies that are adjacent in a circumferential direction via the driving force transmitting portion is larger than an angle made at a radially inner side by intersection of center lines of the outer elastic bodies that are adjacent in the circumferential direction via the outer elastic body coupling portion, and
the inner ring has an inner lip portion, which receives radial force component applied from a corresponding one of the inner elastic bodies, at a radially outer end of the inner elastic body coupling portion, and couples the inner elastic bodies so that an angle made at a radially inner side by intersection of center lines of the inner elastic bodies that are adjacent in the circumferential direction via the inner elastic body coupling portion is larger than an angle made at a radially inner side by intersection of center lines of the inner elastic bodies that are adjacent in the circumferential direction via the driving force transmitting portion.

17. The driving force transmission apparatus according to claim 3, wherein
the first member is provided with an outer damper positioning portion fixed to a driving source output shaft that outputs the driving force from the driving source and that radially positions the outer damper, and
the second member is provided with an inner damper positioning portion that is rotatably supported by the driving source output shaft via a bearing so as to be coaxial with the driving source output shaft and that radially positions the inner damper.

18. The driving force transmission apparatus according to claim 4, wherein
the transmitting member has an application point adjacent portion that is formed in a radial direction, and, when the transmitting member transmits the driving force, each of the outer elastic bodies contacts one circumferential end of the application point adjacent portion and each of the inner elastic bodies contacts the other circumferential end of the application point adjacent portion.

19. The driving force transmission apparatus according to claim 4, wherein
the damper device includes
an outer center support member that supports the outer elastic bodies so as to be able to transmit driving force and that has the outer coupling portion at a radially outer end thereof;
the transmitting member that supports the outer elastic bodies on an axially lateral side of the outer center support member so as to be able to transmit driving force and that supports the inner elastic bodies so as to be able to transmit driving force; and
an inner lateral support member that supports the inner elastic bodies on an axially lateral side of the transmitting member so as to be able to transmit driving force and that has the inner coupling portion at a radially inner end thereof.

20. The driving force transmission apparatus according to claim 4, wherein
the damper device includes
the transmitting member that supports the outer elastic bodies and the inner elastic bodies so as to be able to transmit driving force;
an outer lateral support member that supports the outer elastic bodies on an axially lateral side of the transmitting member so as to be able to transmit driving force and that has the outer coupling portion at a radially outer end thereof; and
an inner lateral support member that supports the inner elastic bodies on an axially lateral side of the transmitting member so as to be able to transmit driving force and that has the inner coupling portion at a radially inner end thereof.

21. The driving force transmission apparatus according to claim 20, wherein
the transmitting member includes
an outer ring that couples at least two outer elastic bodies via an outer elastic body coupling portion so that the at least two outer elastic bodies are able to transmit driving force to each other;
an inner ring that is provided on a radially inner side of the outer ring and that couples at least two inner elastic bodies via an inner elastic body coupling portion so that the at least two inner elastic bodies are able to transmit driving force to each other; and
a center ring that is radially provided between the outer ring and the inner ring so as to be rotatable with respect to the outer ring and the inner ring and that couples the outer elastic bodies to the inner elastic bodies via a driving force transmitting portion so that the outer elastic bodies and the inner elastic bodies are able to transmit driving force to each other.

22. The driving force transmission apparatus according to claim 21, wherein
the center ring has an outer lip portion, which receives radial force component applied from a corresponding one of the outer elastic bodies, at a radially outer end of the driving force transmitting portion,
the outer ring couples the outer elastic bodies so that an angle made at a radially inner side by intersection of center lines of the outer elastic bodies that are adjacent in a circumferential direction via the driving force transmitting portion is larger than an angle made at a radially inner side by intersection of center lines of the outer elastic bodies that are adjacent in the circumferential direction via the outer elastic body coupling portion, and
the inner ring has an inner lip portion, which receives radial force component applied from a corresponding one of the inner elastic bodies, at a radially outer end of the inner elastic body coupling portion, and couples the inner elastic bodies so that an angle made at a radially inner side by intersection of center lines of the inner elastic bodies that are adjacent in the circumferential direction via the inner elastic body coupling portion is larger than an angle made at a radially inner side by intersection of center lines of the inner elastic bodies that are adjacent in the circumferential direction via the driving force transmitting portion.

23. The driving force transmission apparatus according to claim 4, wherein
the first member is provided with an outer damper positioning portion fixed to a driving source output shaft that outputs the driving force from the driving source and that radially positions the outer damper, and
the second member is provided with an inner damper positioning portion that is rotatably supported by the driving source output shaft via a bearing so as to be coaxial with the driving source output shaft and that radially positions the inner damper.
